(19) United States
(12) Patent Application Publication
(10) Pub. No.: US 2026/0307380 A1
(43) Pub. Date: Oct. 8, 2026

(54) BARRIER-COATED FIBROUS CELLULOSE SUBSTRATE AND LAMINATED PACKAGING MATERIAL

(71) Applicant: TETRA LAVAL HOLDINGS & FINANCE S.A., Pully (CH)

(72) Inventors: Nils TOFT, Lund (SE); Katarina JONASSON, Lund (SE); Patrik PALMQUIST, Lund (SE); Jakob HALLQUIST, Lund (SE); Anna MÖLLER, Lund (SE)

(73) Assignee: TETRA LAVAL HOLDINGS & FINANCE S.A., Pully (CH)

(21) Appl. No.: 19/482,474

(22) PCT Filed: Apr. 25, 2024
(86) PCT No.: PCT/EP2024/061404

§ 371 Date: Nov. 7, 2025

(30) Foreign Application Priority Data
May 8, 2023 (EP) 23172145.7
Dec. 21, 2023 (EP) 23219297.1

(51) Int. Cl. B32B 29/00; B32B 7/12; B32B 29/06; B32B 37/24; B32B 38/00; B32B 38/16

(52) U.S. Cl. CPC B32B 29/005; B32B 7/12; B32B 29/06; B32B 37/24; B32B 38/164; B32B 2037/243; B32B 2037/246; B32B 2038/0064; B32B 2038/166; B32B 2250/02; B32B 2255/12; B32B 2255/205; B32B 2255/26; B32B 2255/28; B32B 2307/31; B32B 2307/538; B32B 2307/718; B32B 2307/72; B32B 2307/7246; B32B 2307/7265; B32B 2553/00

(57) ABSTRACT

The present invention relates to a barrier-coated cellulose-based fibrous substrate and to a method of manufacturing such barrier-coated cellulose-based fibrous substrates, by dispersion coating of a first gas barrier coating and optionally subsequent vapour deposition coating of a barrier deposition coating, and further relates to heat sealable laminated packaging materials comprising the barrier-coated cellulose-based fibrous substrate and to packaging containers made therefrom.

### TECHNICAL FIELD

The present invention relates to a barrier-coated fibrous cellulose substrate, for use as oxygen barrier in a laminated packaging material for oxygen-sensitive products, and to a method of manufacturing the barrier-coated fibrous cellulose substrate. The invention further relates to a heat sealable laminated packaging material including the barrier-coated fibrous cellulose substrate, as well as to a packaging container manufactured from the laminate packaging material.

### BACKGROUND OF THE INVENTION

Packaging containers of the single use, disposable type for oxygen-sensitive and liquid or viscous foods are often produced from a packaging laminate based on paperboard or carton. One such commonly occurring packaging container is marketed under the trademark Tetra Brik Aseptic® and is principally employed for aseptic packaging of liquid foods such as milk, fruit juices etc, sold for long term ambient storage. The packaging material in this known packaging container is typically a laminate comprising a bulk or core layer, of paper, paperboard or other cellulose-based material, and outer, liquid-tight layers of thermoplastics. In order to render the packaging container gas-tight, in particular oxygen gas-tight, for example for the purpose of aseptic packaging and packaging of milk or fruit juice, the laminate in these packaging containers normally comprises at least one additional layer, most commonly an aluminium foil.

On the inside of the laminate, i.e. the side intended to face the filled food contents of a container produced from the laminate, there is an innermost layer, applied onto the aluminium foil, which innermost, inside layer may be composed of one or several part layers, comprising heat sealable thermoplastic polymers, such as adhesive polymers and/or polyolefins. Also on the outside of the bulk layer, there is an outermost heat sealable polymer layer.

The packaging containers are generally produced by means of modern, high-speed packaging machines of the type that form, fill and seal packages from a web or from prefabricated blanks of packaging material. Packaging containers may thus be produced by continuously reforming a web of the laminated packaging material into a tube by both of the longitudinal edges of the web being united to each other in an overlap joint by welding together the inner- and outermost heat sealable thermoplastic polymer layers. The tube is continuously filled with the intended liquid food product and is thereafter divided into individual packages by repeated transversal seals of the tube at a predetermined distance from each other below the level of the contents in the tube. The packages are separated from the tube by incisions along the transversal seals and are given the desired geometric configuration, normally parallelepipedal, by fold formation along prepared crease lines in the packaging material.

The main advantage of this continuous tube-forming, filling and sealing packaging method concept is that the web may be sterilised continuously just before tube-forming, thus providing for the possibility of an aseptic packaging method, i.e. a method wherein the liquid content to be filled as well as the packaging material itself are efficiently reduced from bacteria and the filled packaging container is produced under clean conditions such that the filled package may be stored for a long time even at ambient temperature, without the risk of growth of micro-organisms in the filled product. Another important advantage of the Tetra Brik®-type packaging method is, as stated above, the possibility of continuous high-speed packaging, which has considerable impact on cost efficiency.

Packaging containers for sensitive liquid food, for example milk or juice, can also be produced from sheet-like blanks or prefabricated blanks of the laminated packaging material of the invention. From a tubular blank of the packaging laminate that is folded flat, packages are produced by first of all building the blank up to form an open tubular container capsule, of which one open end is closed off by means of folding and heat-sealing of integral end panels. The thus closed container capsule is filled with the food product in question, e.g. juice, through its open end, which is thereafter closed off by means of further folding and heat-sealing of corresponding integral end panels. An example of a packaging container produced from sheet-like and tubular blanks is the conventional so-called gable-top package. There are also packages of this type which have a moulded top and/or screw cap made of plastic.

A layer of an aluminium foil in the packaging laminate provides gas barrier properties quite superior to most other gas barrier materials. The conventional aluminium-foil based packaging laminate for liquid food aseptic packaging is still the most cost-efficient packaging material, at its level of performance, available on the market today.

Any other material to compete with the foil-based materials must be cost-efficient regarding raw materials, have comparable food preserving properties and have a comparably low complexity in the converting of materials into a finished packaging laminate.

Among the efforts of developing non-aluminium-foil materials for liquid food carton packaging, there is also a general incentive towards developing pre-manufactured films or sheets having high and multiple barrier functionalities, which may replace the aluminium-foil barrier material in the conventional laminated packaging material, or which may combine several separate barrier layers in the laminated material and adapt it to conventional processes for lamination and manufacturing.

Preferred types of such alternative, more environmentally sustainable barrier material are barrier-coated paper substrates made by aqueous dispersion coating or vapour deposition coating onto thin paper carrier substrates. There are various aqueous dispersion coating processes and vapour deposition coating processes and material recipes for such coatings, and there is a need for cost-efficient barrier materials of this “non-foil” type, i.e. non-aluminium-foil materials, having improved barrier properties for use in packaging laminates for liquid food packaging, in particular towards gases, such as oxygen gas, but also e.g. towards slow migration of water vapour barrier.

An earlier patent publication WO2011/003565A1 discloses a non-aluminium-foil packaging material comprising a barrier-coated and metallised Kraft paper substrate for the purpose of induction heat sealing.

The earlier patent publication WO2017/089508A1 discloses that improved barrier properties may be obtained from a metallised paper in a similar packaging laminate, by selecting a paper substrate providing optimal properties. Such a metallised paper substrate provided not only improved barrier properties, but also indicated better stability of the metallised layer for induction heat sealing purposes.

The patent publication EP4008548A1 discloses that a base coating may improve the quality of a subsequent gas barrier dispersion coating and a metallisation coating on similar paper substrates.

The further patent publication WO2022219056A1 discloses further barrier-coated cellulose based substrates having higher densities for the purpose of similar laminated packaging materials and packaging containers.

There remains, however, a need for further improved gas-barrier coated paper substrates over those of the prior art. It is important that laminated packaging materials containing such barrier-coated substrates function well for heat sealing under severe circumstances and extreme climate conditions. There is also an increased need for improved properties regarding recyclability and environmental sustainability of the materials used for gas-barrier coated paper substrates and laminated packaging materials containing them.

### DESCRIPTION OF THE INVENTION

It is, accordingly, an object of the present invention to provide improved barrier-coated cellulose-based fibrous substrates, for laminating into heat sealable packaging materials.

It is also an object of the invention to provide barrier-coated cellulose-based fibrous substrates providing good gas barrier properties as well as good repulpability and recyclability, to fulfil the needs of future sustainable laminated packaging materials while also functioning well for heat sealing under severe circumstances and extreme climate conditions.

It is a further general object of the invention to provide barrier-coated cellulose-based fibrous substrates for improved heat sealable laminated packaging materials for oxygen-sensitive products, such as non-foil laminated packaging materials for liquid, semi-liquid or wet food products, which materials accordingly do not contain aluminium foil but still have good gas barrier and other barrier properties, thus being suitable for long-term, aseptic, heat sealable packaging at reasonable cost.

These objects are thus attainable according to the present invention by the barrier-coated cellulose-based fibrous substrate, the method of manufacturing the barrier-coated cellulose-based fibrous substrate, and a laminated packaging material and packaging containers comprising the barrier-coated cellulose-based substrate, as defined in the appended claims.

According to a first aspect of the invention, there is provided a barrier-coated cellulose-based fibrous substrate, for use as oxygen barrier in a heat sealable laminated packaging material for oxygen-sensitive food products, such as liquid food products, comprising a fibrous cellulose substrate having a grammage from 30 to 80 g/m², and a density from 700 to below 900 kg/m³, a first gas barrier coating, applied on a first side of the fibrous cellulose substrate by means of dispersion or solution coating of an aqueous oxygen barrier composition followed by drying by evaporation, wherein the barrier-coated fibrous cellulose substrate further has a steam-resistant base coating, comprising from 25 to 96 weight-% of inorganic particles and from 4 to 75 wt-% of a polymer binder, per dry weight, positioned beneath the first gas barrier coating and applied by means of aqueous dispersion coating onto and directly adjacent and contacting the first side of the fibrous cellulose substrate, the thus barrier-coated fibrous cellulose substrate providing gas barrier properties in the heat sealable laminated packaging material.

The fibrous cellulose substrate is made essentially of cellulose fibres laid together to form a fibrous sheet or paper, meaning that in between the fibres there will be cavitied, pockets or porosities filled by air. The relatively low density of the fibrous substrate ensures a sufficient level of such unfilled space between the fibres, i.e. porosity, in the interior of the substrate. The meaning of the term fibrous in relation to this invention is thus that the substrate is porous and not densified by seeking to compress the fibres beyond the conventional level of a cellulose paper, or by filling the pores or spaces with low-molecular substances, including low-molecular cellulose, such as micro- or nanocelluloses. The fibrous cellulose substrate may have a density from 700 to 850 kg/m³, more preferably from 700 to 830 kg/m³, most preferably from 700 to 800 kg/m³. Such a relatively low density is achieved by not pressing the cellulose fibres together too much in the substrate and by using cellulose fibres, as distinguished from micro- or nanocellulose fibril or crystal variants, to ensure consistent porosity between the fibres in the interior of the substrate. The fibrous cellulose substrate is normally a paper.

The fibrous cellulose substrate may be made essentially from Kraft pulp fibres, thus being a so-called Kraft paper.

The cellulose-based fibrous substrates suitable for the invention is not limited to a certain type of paper or cellulose, however, and includes cellulose-based substrates, based on any type of native fibrous cellulose. The invention is neither applicable, however, to substrates from plastics or homogeneous polymers, such as films made from regenerated cellulose, nor non-porous films or cellulose sheets. The cellulose-based fibrous substrates does not comprise low molecular celluloses such as microfibrillar cellulose, MFC, nanofibrillar cellulose, NFC, or nanocrystalline celluloses, NCC, within its fibrous structure. The inclusion of such low-molecular cellulose would fill the voids and pores in the fibrous cellulose, to densify the structure, rather than preserving its porosity. For the same reason, it is believed that the content of so-called fines, i.e. cellulose fibres with fibrillar cellulose still attached, is rather low, as it may have a similar, densifying effect.

The steam-resistant base coating may comprise from 30 to 96 weight-%, such as from 40 to 96 weight-%, such as from 50 to 96 weight-%, such as from 55 to 96 weight-%, such as from 60 to 96 weight-%, such as from 65 to 96 weight-%, such as from 70 to 96 weight-%, of the inorganic particles and from 4 to 70 weight-%, such as from 4 to 60 weight-%, such as from 4 to 50 weight-% such as from 4 to 45 weight-%, such as from 4 to 40 weight-%, such as from 4 to 35 weight-%, such as from 4 to 30 weight-%, of a polymer binder and further additives, based on dry weight. The steam-resistant coating may thus be a so-called clay-coat or pigment coating, and has the purpose to provide a smooth, dense and flexible surface applied onto the fibrous cellulose substrate, which acts both to resist steam expansion of moisture entrapped in the air pockets of the fibrous cellulose substrate and to provide an optimal surface for coating with further gas barrier layers, and to altogether provide good oxygen barrier in a packaging container, i.e. also after fold-forming and heat sealing a laminated packaging material comprising the barrier-coated cellulose-based fibrous substrate into a packaging container.

The inorganic particles or filler material may comprise various inorganic particles, such as clay minerals, silica particles, talcum and calcium carbonate. The thus dispersion-coated and dried layer of such a base coating may act as a barrier to migrating small molecules, such as water vapour, but may also act more efficiently as a load-bearing barrier to resist sudden expansion of water vapour, i.e. steam blisters bursting towards the layer of the steam-resistant base coating from the adjacent substrate layer of fibrous cellulose.

In an embodiment, the inorganic particles comprise laminar silicate particles, which may contribute further to barrier properties in the material, by the creation of overlapping mineral flakes or lamellae, thus preventing migration of small molecules through the material. Such laminar inorganic particles may be selected from clays, such as kaolin clay or bentonite clays, silicates and talcum particles.

The polymer binder of the steam-resistant coating may be an aqueous emulsion binder, such as selected from the group consisting of aqueous emulsions of acrylic or methacrylic homo- or co-polymers, such as styrene-acrylate latex, vinyl acrylic copolymer latex or vinyl acetate acrylate copolymer latex, and of styrene-butadiene copolymers, such as styrene-butadiene latex, and of biobased emulsion binders, such as modified starch latex, and of vinyl alcohol polymers, such as polyvinyl alcohol, PVOH, or ethylene vinyl alcohol, EVOH, and of other modified starches or starch derivatives.

The steam-resistant base coating may be applied by means of aqueous dispersion coating at an amount of from 5 to 25 g/m², such as from 7 to 22 g/m², such as from 7 to 20 g/m², such as from 7 to 19 g/m², such as from 10 to 20 g/m², such as from 10 to 19 g/m², dry weight.

After the dispersion coating and drying of the aqueous steam-resistant barrier coating, the coated surface of the base coated fibrous cellulose substrate is smoothened and compacted, such as by soft calendering, to obtain the optimal surface properties, i.e. smoothness and low porosity, to receive further coatings of gas barrier materials.

The free, dried but uncoated surface of the steam-resistant base coating was measured after the soft calendering to have a surface roughness below 150 ml/min Bendtsen, such as below 100 ml/min Bendtsen, such as below 80 ml/min Bendtsen, such as below 50 ml/min Bendtsen. Preferably, the surface roughness is very low and can be measured to exhibit values below 3 μm, such as below 2.5 μm, such as below 2 μm, such as 1.5 μm or lower, such as 1.2 μm or lower, such as 1.0 μm or lower, as measured according to ISO 8791-4 (PPS).

It is further believed that the inherent flexibility of the steam-resistant base coating supports any subsequently applied, less flexible, barrier coatings, to stay coherent as well as adherent upon folding of the barrier-coated fibrous cellulose substrate.

The fibrous cellulose substrate may further have a second steam-resistant base coating on its opposite side, which may be of the same type as the steam-resistant base coating layer pre-coating on the first side of the substrate.

The first gas barrier coating is a dispersion coated layer of an aqueous oxygen gas barrier composition, i.e. applied by means of aqueous dispersion or solution coating.

The aqueous oxygen gas barrier composition may comprise a polymer selected from the group consisting of vinyl alcohol polymers and copolymers, such as from the group consisting of polyvinyl alcohol, PVOH, and ethylene vinyl alcohol, EVOH, starch and starch derivatives, xylan, xylan derivatives, nanofibrillar cellulose/microfibrillar cellulose, NFC/MFC, and blends of two or more thereof.

In a further embodiment, the aqueous oxygen gas barrier composition of the first gas barrier coating comprises a polymer selected from the group consisting of starch and vinyl alcohol polymers and copolymers, such as a polymer selected from the group consisting of polyvinyl alcohol, PVOH, ethylene vinyl alcohol, EVOH and starch.

In a further embodiment, the aqueous oxygen gas barrier composition of the first gas barrier coating comprises a polymer selected from the group consisting of vinyl alcohol polymers and copolymers, such as a polymer selected from the group consisting of polyvinyl alcohol, PVOH, and ethylene vinyl alcohol, EVOH.

The first gas barrier coating may be applied by means of aqueous dispersion or solution coating at a total grammage from 0.5 to 4 g/m², such as from 0.5 to 3 g/m², such as from 0.5 to 2 g/m² dry weight. Lower grammages are insufficient for providing a gas barrier and higher grammages normally make the coatings more brittle and prone to cracking, upon fold-forming of the substrate and the laminated packaging material.

The barrier-coated cellulose-based fibrous substrate may further comprise at least one further gas barrier coating, applied onto the first gas barrier coating, the at least one further gas barrier coating including at least one barrier deposition coating, applied by means of a vapour deposition method, the thus barrier-coated fibrous cellulose substrate providing gas and water vapour barrier properties in the heat sealable laminated packaging material. The at least one further gas barrier coating includes thus at least one barrier deposition coating, applied by means of a vapour deposition method, but may also include a further dispersion coating of an aqueous barrier composition, which may be applied by means of dispersion or solution coating, before or after the barrier deposition coating.

The barrier deposition coating may be a vapour deposition coating of a material selected from metals, metal oxides, inorganic oxides and carbon coatings, such as aluminium metallisation, aluminium oxide, silicon oxide and diamond-like carbon coatings. In an embodiment, the barrier deposition coating is a vapour deposition coating selected from the group consisting of an aluminium metallisation coating and aluminium oxide, AlOx, and preferably it is an aluminium metallisation coating. An aluminium metallization coating, or combined aluminium and aluminium-oxide coating, provides not only oxygen gas and water vapour barrier properties to a heat sealable laminated packaging material, but also barrier properties towards incoming light from outside the package.

In a second aspect of the invention, the barrier-coated cellulose-based fibrous substrate of the first aspect may be used in a heat sealable laminated packaging material, which may further comprise a first outermost protective material layer, such as a liquid tight material layer, and a second innermost heat sealable material layer forms the contact layer towards the product to be packed in a packaging container formed from the laminated packaging material, and is also heat-sealable to itself or other thermoplastic materials.

The laminated packaging material may further comprise an additional layer of paper or paperboard or other cellulose-based material, constituting a bulk layer, i.e. a layer of a major thickness, in the laminate.

For the purpose of heat sealable carton packaging of oxygen-sensitive food products, such as liquid, semi-liquid or wet food products, there is also provided a heat sealable laminated packaging material comprising a bulk layer of paper or paperboard or other cellulose-based material, a first outermost protective material layer, such as a liquid tight material layer, a second innermost liquid tight and heat sealable material layer and the barrier-coated cellulose-based fibrous substrate of the first aspect, arranged on the inner side of the bulk layer between the bulk layer and the second innermost, heat sealable material layer.

In a further embodiment, the heat sealable laminated packaging material has an inside polymer multilayer portion, which corresponds to all polymer layers applied on the inside of the barrier-coated cellulose-based, fibrous substrate, comprising a second innermost liquid tight, heat sealable material layer to be in direct contact with a product to be filled into a packaging container made from the packaging material, and an interjacent load-bearing layer comprising high-density polyethylene, HDPE, medium-density polyethylene, MDPE, or a linear low-density polyethylene, LLDPE having a melt flow ratio, MFR, from 4 to 20 g/10 min (190° C./2.16 kg) and a melting temperature above 115° C., onto the inner side of the barrier-coated cellulose-based substrate, wherein the layers of the inside polymer multilayer portion are applied by means of extrusion coating onto the inner side of the barrier-coated cellulose-based substrate, and the second innermost liquid tight, heat sealable material layer comprises a polyethylene polymer having a low density, such as selected from the group consisting of low density polyethylene, LDPE, linear low density polyethylene, LLDPE, and blends thereof.

Preferably, the second innermost liquid tight, heat sealable material layer has a major melting point peak, Tm, from 88 to 110° C.

The interjacent load-bearing layer may comprise a polymer blend composition including from 30 to 90 weight-% of HDPE or MDPE and from 10 to 70 weight-% of LDPE, preferably from 50 to 80 weight-% HDPE or MDPE and from 20 to 50 weight-% LDPE.

The interjacent load-bearing layer may alternatively comprise a polymer blend including from 50 to 95 weight-% of the LLDPE having a melt flow ratio from 4 to 20 g/10 min (190° C./2.16 kg) and a melting temperature above 115° C. and from 5 to 50 weight-% of an HDPE or MDPE.

In a preferred embodiment, the inside polymer multilayer portion may be applied in at least two consecutive steps as separate layers, by means of melt extrusion coating, with at least partial solidification of the prior, melt-extrusion coated layer before the next melt-extrusion layer is coated onto the prior layer.

The inside polymer multilayer portion may further comprise a tie layer comprising an adhesive polymer adjacent and in contact with the barrier-coated, inner side of the cellulose-based, fibrous substrate.

The load-bearing layer has a surface weight from 8 to 25 g/m², such as from 10 to 25 g/m², such as from 12 to 25 g/m², such as from 15 to 25, such as from 15 to 20 g/m², In a third aspect of the invention, the heat sealable laminated packaging material of the second aspect may be used in a packaging container, which may be intended for packaging of liquid, semi-liquid or wet food. There is thus provided a packaging container, which is manufactured at least partly from the laminated packaging material, or is in its entirety made of the laminated packaging material.

In a fourth aspect of the invention, a method of manufacturing the barrier-coated cellulose-based fibrous substrate of the first aspect is provided. The method comprises a first step of providing the fibrous cellulose substrate having a machine-glazed or machine-finished top side surface, as a moving web in a roll-to-roll system,
a second step of dispersion coating a first dispersion composition for a steam-resistant base coating, onto the moving fibrous cellulose substrate, and subsequently drying the applied base coating by forced evaporation,
a third step of smoothening, such as soft calendering, the surface of the base-coated fibrous cellulose substrate obtained from the second step,
a fourth step of dispersion coating an aqueous second dispersion or solution of a first gas barrier coating composition, onto the moving, smoothened base-coated fibrous cellulose substrate, and subsequently drying the applied first gas barrier coating by forced evaporation,
optionally repeating the fourth step one or more times, and
optionally a fifth step of depositing a further barrier coating by vapour deposition onto the free surface of the first gas barrier coating of the moving gas-barrier coated fibrous cellulose substrate.

In an alternative variant of the method of the invention, an initial method step is instead a step of providing the base-coated and smoothened fibrous cellulose substrate resulting from the first, second and third steps, as a moving web in a roll-to-roll system, which initial step is further followed by a next step being the same as the fourth step and, optionally, a next step being the same as the fifth step, in that order.

The steam-resistant base coating composition may be an aqueous composition comprising from 10 to 20 weight-% of a polymer binder and from 80 to 90 weight-% of inorganic particles, dry weight.

The free, uncoated surface of the steam-resistant base coating on the base-coated fibrous cellulose substrate obtained from the third step, has a high smoothness level, i.e. a surface roughness below 3 μm, such as below 2.5 μm, such as 2 μm or lower, such as 1.5 μm or lower, such as 1.2 μm or lower, such as 1.0 μm or lower, as measured according to ISO 8791-4 (PPS). Such level of smoothness is improving the film formation of subsequently applied gas barrier coatings, thus providing as high gas barrier as possible.

The free, uncoated surface of the steam-resistant base coating on the base-coated fibrous cellulose substrate obtained from the second or third step preferably also has a low porosity, measured as a Gurley air resistance above 1500 s/100 ml, such as above 3000 s/100 ml. The low porosity further improves the film formation of subsequently applied gas barrier coatings, in that no or very low amounts of the oxygen gas barrier composition liquid is absorbed into the fibrous molecules at the surface of the substrate.

In a fifth aspect of the invention, a preferred method of manufacturing the heat sealable laminated packaging material of the second aspect is provided.

The method comprises the steps of
laminating the barrier-coated cellulose-based fibrous substrate to the bulk layer of paper or paperboard or other cellulose-based material,
melt extrusion coating the first outermost protective material layer or coating, to be directed towards the outside of a packaging container formed from the laminated packaging material, onto the outer side of the bulk layer,
extrusion coating an inside polymer multilayer portion, which correponds to all polymer layers applied on the inside of the barrier-coated cellulose-based, fibrous substrate, comprising a second innermost liquid tight, heat sealable material layer to be in direct contact with a product to be filled into a packaging container made from the packaging material, and an interjacent load-bearing layer comprising high-density polyethylene, HDPE, medium-density polyethylene, MDPE, or a linear low-density polyethylene, LLDPE having a melt flow ratio, MFR, from 4 to 20 g/10 min (190° C./2.16 kg) and a melting temperature above 115° C., onto the inner side of the barrier-coated cellulose-based substrate,
the second innermost liquid tight, heat sealable material layer comprising a polyethylene polymer having a low density, such as selected from the group consisting of low density polyethylene, LDPE, linear low density polyethylene, LLDPE, and blends thereof.

Preferably, the second innermost liquid tight, heat sealable material layer has a major melting point peak, Tm, from 88 to 110° C.

The interjacent load-bearing layer may comprise a polymer blend composition including from 30 to 90 weight-% of HDPE or MDPE and from 10 to 70 weight-% of LDPE, preferably from 50 to 80 weight-% HDPE or MDPE and from 20 to 50 weight-% LDPE.

The interjacent load-bearing layer may alternatively comprise a polymer blend including from 50 to 95 weight-% of the LLDPE having a melt flow ratio from 4 to 20 g/10 min (190° C./2.16 kg) and a melting temperature above 115° C. and from 5 to 50 weight-% of an HDPE or MDPE.

In a preferred embodiment, the inside polymer multilayer portion may be applied in at least two consecutive steps as separate layers, by means of melt extrusion coating, with at least partial solidification of the prior, melt-extrusion coated layer before the next melt-extrusion layer is coated onto the prior layer.

The inside polymer multilayer portion may further comprise a tie layer comprising an adhesive polymer adjacent and in contact with the barrier-coated, inner side of the cellulose-based, fibrous substrate.

In a preferred embodiment, the inside polymer multilayer portion consists of, in a sequence from outside to inside, a tie layer comprising an adhesive polymer adjacent and in contact with the barrier-coated, inner side of the cellulose-based, fibrous substrate, the interjacent load-bearing layer comprising high-density polyethylene, HDPE, medium-density polyethylene, MDPE, or a linear low-density polyethylene, LLDPE having a melt flow ratio, MFR, from 4 to 20 g/10 min (190° C./2.16 kg) and a melting temperature above 115° C., and the second innermost liquid tight, heat sealable material layer comprising a polyethylene polymer having a low density, such as selected from the group consisting of low density polyethylene, LDPE, linear low density polyethylene, LLDPE, and blends thereof.

In a further embodiment, the inside polymer multilayer portion may be applied in at least two consecutive steps as separate layers, by means of melt extrusion coating, with at least partial solidification of a prior, melt-extrusion coated layer before a next melt-extrusion layer is coated onto the prior layer.

It has hitherto been assumed that improved gas barrier properties from barrier-coated papers may be achieved by sourcing better cellulose-based substrates, which inherently provide gas barrier properties when further laminated to any polymer layers, and/or by coating thicker layers of the barrier coating materials having the inherent gas barrier properties. It has recently become better understood, however, that the interface portion between the barrier coatings and a fibrous cellulose substrate may play a key role for the optimal performance of subsequently applied coatings, which contribute most with the gas barrier properties.

It has been seen that optimal performance of barrier properties all the way to packaging containers may be achieved by adding a steam-resistant base layer pre-coating, comprising from 25 to 96 weight-% of inorganic particles and from 4 to 75 wt-% of a polymer binder, per dry weight, positioned beneath the first gas barrier coating and applied by means of aqueous dispersion coating onto and directly adjacent and contacting the first side of the fibrous cellulose substrate. By doing so, it has been understood that the barrier qualities of the fibrous cellulose substrate itself do not need to be so high, and that the amount of coated oxygen first gas barrier coating can remain the same or may even be reduced. The resulting gas barrier properties in a packaging laminate will thus be very good, if such a steam-resistant base coating is used, although it does not contribute with significant gas barrier properties itself, i.e. the oxygen gas barrier properties are not inherent to the material(s) of the steam-resistant base coating. The resulting oxygen gas barrier in a fold-formed, filled and heat sealed packaging container, will also be ensured thanks to the base-coating being resistant to sudden expansion of water vapour gas, i.e. steam, thus being resistant to steam bubbles bursting through the base coating, such that upon heat sealing, good and tight seals of the filled containers are ensured, supporting the sealing integrity and the laminated layer integrity of the packaging containers without jeopardizing the integrity of the first and further gas barrier coating layers.

The base coating composition should be selected to provide a flexible foundation as well as to provide an even, dense, compatible base coating surface to receive any further gas barrier coating. The material selected for the steam-resistant base coating does not need to contribute with inherent gas barrier properties, however.

The barrier-coated cellulose-based fibrous substrate obtained by the above described method and coating layer configuration, provides improved gas barrier properties to a laminated packaging material, as well as to packaging containers made therefrom, and may also improve the recyclability and sustainability profile of such packaging materials and packaging containers.

With the term “long-term storage”, used in connection with the present invention, is meant that the packaging container should be able to preserve the qualities of the packed food product, i.e. nutritional value, hygienic safety and taste, at ambient conditions for at least 1 or 2 months, such as at least 3 months, preferably longer, such as 6 months, such as 12 months, or more.

With the term “package integrity”, is generally meant the package tightness, i.e. the resistance to leakage or breakage of a packaging container. The term encompasses the resistance of the package to intrusion of microbes, such as bacteria, dirt, and other substances, that may deteriorate the filled food product and shorten the expected shelf-life of the package.

One main contribution to the integrity of a package from a laminated packaging material is provided by good internal adhesion between adjacent layers of the laminated material. Another contribution comes from the material resistance to defects, such as pinholes, ruptures and the like within each material layer itself, and yet another contribution comes from the strength of the sealing joints, by which the material is sealed together at the formation of a packaging container. Regarding the laminated packaging material itself, the integrity property is thus generally focused on the ability to withstand thermal- and mechanical loads e.g., during folding and sealing, without fracturing. More specifically, good adhesion is needed between the respective laminate layers and its adjacent layers, as well as high quality of the individual material layers. Regarding the sealing of the packages, the integrity is mainly focussed on the quality of the sealing joints, which is ensured by well-functioning and robust sealing operations in the filling machines, which in turn is ensured by adequately adapted heat-sealing properties of the laminated packaging material.

The term “liquid or semi-liquid food” generally refers to food products having a flowing content that optionally may contain pieces of food. Dairy and milk, soy, rice, grains and seed drinks, juice, nectar, still drinks, water, flavoured water, energy drinks, sport drinks, coffee or tea drinks, coconut water, wine, soups, jalapenos, tomatoes, sauce (such as pasta sauce), beans and olive oil are some non-limiting example of food products contemplated.

Further examples of other oxygen-sensitive food products, possible to package and protect with the laminated packaging materials of the present disclosure are e.g. dry and/or fatty foods, such as milk powders and other powdered food. Examples of fatty foods are cheese, butter and spreads. Such packaging may be flow-wrap packaging or form, fill, seal (FFS) packaging, e.g. in bags. It may also be packaging in a jar, tray, lidded spread container, collapsible tube, clam-shell package, sleeve, envelope or wrapper. In these applications, the packaging material typically undergoes folding or a similar type of stress (e.g. creasing, stretching), which make the packaging material based on the barrier-coated cellulose-based fibrous substrate of the present disclosure particularly suitable.

The term “aseptic” in connection with a packaging material and packaging container refers to conditions where microorganisms are eliminated, in-activated or killed. Examples of microorganisms are bacteria and spores. Generally an aseptic process is used when a product is aseptically packed in a packaging container. For the continued asepticity during the shelf-life of the package, the package integrity properties are of course very important. For long-term shelf-life of a filled food product, it may furthermore be important that the package has barrier properties towards gases and vapours, such as towards oxygen gas, in order to keep its original taste and nutritional value, such as for example its vitamin C content.

With the term “bulk layer” is normally meant the thickest layer or the layer containing the most material in a multilayer laminate, i.e. the layer which is contributing most to the mechanical properties and dimensional stability of the laminate and the structural stability of packaging containers folded from the laminate, based on thick paper, paperboard or carton. It may also mean a layer providing a greater thickness distance in a sandwich structure, which further interacts with stabilising facing layers, which have a higher Young's modulus, on each side of the bulk layer, in order to achieve sufficient mechanical properties, such as bending stiffness, for achieving structure stability of formed packaging containers.

With the term “non-foil” packaging material, is meant a laminated packaging material, which does not comprise an aluminium foil of a thickness in the micrometer-scale, such as conventional aluminium foils for liquid carton packaging which are normally from 6 to 9 μm thick. A “non-foil” packaging material may comprise a metallisation layer, however, as the thickness of e.g. an aluminium metallisation layer is in the nano-meter scale. The amount of aluminium material employed in such a metallisation coating is very low, and have, in comparison to aluminium foils, a significantly reduced impact on recycling and exploitation of material resources.

The term “thermomechanical stability” about a material or a material layer means that the material has the ability to maintain mechanical stability and geometry at elevated temperatures, also at shaping or forming the material (such as pressing, folding, heat sealing), such that the metallised layer is well supported by such a material or layer and does not deteriorate. Furthermore, the material will not melt or soften upon heating to pre-determined temperatures.

The term “dispersion coating” herein relates to a coating technique in which an aqueous or substantially aqueous dispersion, suspension, emulsion or solution of a polymer is applied to the surface of a substrate layer, usually in the form of a continuous web, to form a solid, substantially non-porous film after drying. The term “dispersion” covers thus also any suspension, emulsion or solution or mixes thereof, that would be capable of providing such a coating after drying. Polyvinyl alcohols (PVOH, PVAL) are typical polymers suitable for dispersion coating, but may for example at high saponification degrees in practice rather be polymer solutions, or mixes of dispersed and dissolved PVOH. A dispersion-coated barrier layer or coating is formed by a dispersion coating, also called “liquid-film coating”, techniques. An aqueous dispersion may comprise fine polymer-based particles and thus be a “latex”.

The term “latex” as used herein refers to a composition comprising an aqueous suspension or dispersion or emulsion of polymer particles, which can be natural polymers, synthetic polymers, synthetic polymers derived from biomasses or combinations thereof.

The term “polyethylene” refers to a polymer comprising ethylene monomers at from about 90 to 100 mol %. There are various types of polyethylene, as explained below.

Low density polyethylene, LDPE, has a density of 917 to 930 kg/m³. It is typically polymerised from ethylene monomers alone and has a branched polymer chain structure with long chain branches, leading to a more branched and less tightly packed molecular arrangement, and a lower overall density than for medium density polyethylene, MDPE, and high density polyethylene, HDPE.

The term “linear low density polyethylene” (or “LLDPE”) covers all linear low density polyethylenes, including “ZN-LLDPE” polymerised by means of Ziegler-Natta type catalysts as well as “m-LLDPE” polymerised by catalysts of so-called “constrained geometry”, or “single-site” catalysts, such as “metallocene” catalysts, and other linear low density polyethylenes. Both ZN-LLDPE and m-LLDPE are typically produced by copolymerising an ethylene monomer with a C₄-C₈, more preferably a C₆-C₈, alpha-olefin alkylene monomer, the latter in the presence of a metallocene catalyst. 1 to 10 mol %, suitably 8 to 10 mol %, comonomer content is typical. LLDPE has significant numbers of short branches. It differs structurally from conventional low-density polyethylene (LDPE) because of the absence of long chain branching. LLDPE polymers typically have a narrower molecular weight distribution than conventional LDPE (this is true for m-LLDPE especially) and significantly different properties. A higher number of short chain branches will lead to a lower degree of crystallinity, because the crystallisation is suppressed in the polymer and therefore its density becomes lower than for MDPE and HDPE.

When occasionally referring to “mPE” in this application, is meant a polymer blend for a heat sealable innermost layer comprising at least 50 wt % mLLDPE and up to 50 wt % LDPE, preferably comprising about 70 weight-% of mLLDPE and about 30 weight-% of LDPE. (e.g. in connection to the figures).

High density polyethylene, HDPE, and medium density polyethylene, MDPE, suitable for the inside polymer multilayer portion in the laminated packaging material of the invention has a density of 930 to 970 kg/m³. Up to 2 mol % comonomer content is typical in these polymers of linear type polymer molecules. The lack of long chain branching is ensured by an appropriate choice of catalyst (e.g. ZN catalysts) and the reaction conditions.

MDPE may have a medium level of density, typically ranging from 0.926 to 0.940 g/cm³, while HDPE may have a higher density, typically ranging from 0.941 to 0.965 g/cm³.

OTR “on folding” is determined herein by cutting the laminated materials to round standardized area samples having a diameter of 104 mm for testing in a PreSens (from Germany) OTR permeation cell, equipped with the sensor type PSt9. The accumulated concentration of permeated oxygen into nitrogen gas was measured by fluorescence over time and plotted as oxygen transmission rate provided in the unit cm³ per sample and 24 hours, with prior normal conditioning of the samples. Folding of the samples was made in a folding rig, along a machine direction (MD) crease line, outside to outside, to an angle of 165 degrees, for inducing maximal stress, at a determined speed and by mechanized, high-precision repeatable folding, to resemble conditions in a filling machine. Each folding operation stresses the material in exactly the same way, which makes folding experiments and subsequent OTR determinations repeatable and comparable.

All samples were thus measured at 23° C., 50% RH on the test gas side and dry nitrogen on the barrier side. Values were calculated from the slope of an increase in oxygen concentration. The unit for calculated OTR is expressed in cm³/sample and 24 h with 21% Oxygen.

Grammages of paper substrates were determined according to the official test method of ISO 536:2019 by the unit g/m², while thickness and density were determined according to ISO 534:2011, by the units μm (m) and kg/m³, respectively.

Thickness measurements of coated polymer layers on paper and in laminate structures may be measured and estimated by taking sliced section samples of the structure and studying them in a SEM microscope. The slicing may be done using e.g. a cryo microtome.

Surface roughness was measured according to ISO 8791-4.

Gurley porosity was measured according to Tappi T460 om-02.

It has been seen that the combination of a steam-resistant base coating and gas barrier coating(s), as of the present invention, may improve the gas barrier properties of a paper substrate beyond expectations, and that the paper substrate as such does not need to have inherent barrier properties.

To be suitable for a final barrier-coating step by means of a vapour deposition coating process, the fibrous part of a fibrous paper substrate needs to be thin and have a low grammage weight, preferably 60 g/m² or below, such as 50 g/m² or below, preferably 45 g/m² or below, for reasons of efficiency and production economy. On the other hand, fibrous cellulose substrates thinner or with a lower grammage than 30 g/m² may be mechanically too weak and/or less dimension stable, when they are coated with wet dispersions and subsequently dried, thus exhibiting shrinkage or 5 curling problems or even web breaks. It is thus more preferred to use cellulose-based substrates having a grammage of from 30 to 70 g/m², such as from 30 to 65 g/m², such as from 35 to 60 g/m², such as from 35 to 55 g/m².

The fibrous cellulose-based substrate has a relatively low density lower than 900 kg/m³, such as lower than 850 kg/m³, such lower than 800 kg/m³, and thus should have porosity, while the cellulose-based fibrous substrate altogether should have a dense and smooth surface, for best possible interface to a further oxygen gas barrier coating applied to it. This means that the fibrous cellulose substrate may not be too much compressed, such as by high-pressure calendering, hard calendering or super-calendering or the like. Only the surface should be smoothened, which is possible by so-called machine glazing or machine finishing methods directly after the formation, while drying the paper during the paper manufacturing process.

The fibrous cellulose substrate for use according to the invention, may be formed from cellulose fibres comprising at least 50% by dry weight of chemical pulp, such as sulphate or sulphite pulp. Chemical pulp is used to obtain toughness in a paper for high-speed coating and converting processes and for use in final packages.

Sulphate or “Kraft” pulp may be advantageous for improved repulping in recycling, and general dewatering of the fibres.

For the purpose of recycling and good dewatering ability, the fibres of the cellulose-based substrate may have a Canadian Standard Freeness (CSF) higher than 300 ml, such as higher than 350 ml, such as higher than 400 ml, as measured by ISO 5267-2:2001. Correspondingly, the fibres of the cellulose-based substrate may have a Schopper-Riegler value lower than 40 degrees SR, such as lower than 36 degrees SR, such as lower than 32 degrees SR, as measured according to ISO 5267-1:1999.

Softwood pulp may provide strength/toughness properties in the resulting paper and may be comprised in the pulp by at least 50 wt %. In an embodiment, the cellulose-based substrate comprises at least 50 wt %, such as from 60 to 100 wt %, such as from 70 to 100 wt % Kraft cellulose, such as bleached Kraft cellulose.

It has been seen that for some uses, such as for liquid-tight packaging of wet or liquid or viscous flowing products, it may be advantageous to use an as thin as possible cellulose-based fibrous substrate, because then less polymer may be needed in adjacent liquid-tight layers, or heat-sealable material layers. The thickness of the steam-resistant base-coated fibrous cellulose substrate may be from 35 to 70 μm, such as from 35 to 65 μm, such as from 40 to 60 μm, such as from 40 to 50 μm.

In a further embodiment, the steam-resistant base coating may be an aqueous composition comprising an inorganic filler material and a bio-based polymer binder material having inherent ductility properties, selected from the group comprising starch derivatives, polyisoprene, lignin-based polymers, alginates, gums, and soy-based proteins as a latex of one or more such bio-based polymer binder material.

The steam-resistant base coating may be applied by means of suitable dispersion coating techniques, such as blade coating, rod coating, bar coating, smooth roll coating, reverse roll coating, lip coating, air knife coating, curtain flow coating, dip coating and slot die coating methods, and subsequent drying to evaporate the dispersion medium, normally water, by forced convection drying. Preferably, the steam-resistant base coating is applied by blade coating, roll coating or rod coating technology and subsequent drying. The term aqueous dispersion coating includes thus coating of aqueous compositions of binder polymer emulsions, dispersions, suspensions, solutions and latex formulations, further comprising a substantial amount, such as more than 50 weight-% of more of pigments, inorganic particles or other filler material.

The steam-resistant base coating may comprise a polymer binder of an aqueous latex composition, such as a latex selected from the group comprising styrene-butadiene latex (SB-latex), methylstyrene-butadiene latex, styrene acrylate latex (SA-latex), acrylate latex, such as vinyl acrylic copolymers and vinyl acetate acrylate latex, styrene-butadiene-acrylonitrile latex, styrene-acrylate-acrylonitrile latex, styrene-butadiene-acrylate-acrylonitrile latex, styrene-maleic anhydride latex, styrene-acrylate-maleic anhydride latex, mixtures thereof, or bio-based latex made with plant-based polymer materials. Also e.g. styrene-acrylate latex or styrene-butadiene latex may be at least partly derived from biomass to provide similar performance with an improved carbon footprint.

The steam-resistant base coating may in an embodiment comprise a polymer binder based on substantially plant-based material sources, by producing an aqueous latex composition comprising an emulsion of a bio-based polymer binder material, such as selected from the group comprising starch derivatives, including modified starches and crosslinked starches, polyisoprene, lignin-based polymers, alginates and gums, such as guar gum, and soy-based proteins, including latex compositions of the type “Ecosphere” from Ecosynthetix, “Vytex” from Vystar, “NeoLigno” from Stora Enso, “OC-Binder” from Organoclick, “Polygal” surface coatings from Polygal. The bio-latex composition Ecosphere® from Ecosynthetix is for example an aqueous latex of crosslinked starch particles. A latex may be manufactured by aqueous emulsion polymerization. Alternatively, as in the case of manufacturing a latex from a biopolymer, the biopolymer material such as starch may be plasticized under shear force to suitable particle size, and subsequently be crosslinked by the addition of a crosslinking agent. Thereafter, the biopolymer particles may be added to a water dispersion to form an aqueous latex or suspension of the particles.

The steam-resistant base coating may thus comprise an aqueous latex composition comprising a polymer material having inherent ductility properties selected from the group consisting of styrene-butadiene copolymers (SB), styrene acrylate copolymers (SA), other acrylate polymers and acrylate copolymers, such as vinyl acrylic copolymers and vinyl acetate acrylate copolymers, and of aqueous latexes of bio-based polymer materials.

In a further embodiment, the steam-resistant base coating may comprise an aqueous latex composition of a bio-based polymer material having inherent flexible properties selected from the group comprising starch derivatives, including modified starches and crosslinked starches, polyisoprene, lignin-based polymers, alginates, gums, and soy-based proteins.

In yet a further embodiment, the steam-resistant base coating may comprise an aqueous latex composition comprising crosslinked starch particles.

The latex composition may further comprise inorganic filler particles, such as kaolin clay or other laminar clay compounds, silica particles, talcum particles and/or calcium carbonate, at from 40 to 96 weight-% of the dry content, such as from 50 to 96 wt-%, such as from 60 to 96 wt-%, such as from 70 to 96 wt-% of the dry content. The filled coating composition appears to prevent steam bubbles from disrupting or eroding any subsequently and adjacently applied coating layer, however thin it may be. This is an important advantage, since a laminated packaging material comprising the barrier-coated cellulose-based fibrous substrate may be used under high humidity climate conditions, which accordingly loads the papers of cellulose-based fibrous layers within the laminate with a higher moisture content. Typically, the moisture content in the paper at equilibrium under 80% relative humidity (RH), is around 12%, while at higher RH even closer to 15% may be expected.

The filler content may further support the flexibility of the steam-resistant base coating, while also reducing tensions in the pre-coating, such that the pre-coating can follow the fibrous cellulose substrate as it is folded, without generating cracks in the base coating itself or in the first gas barrier coating subsequently applied onto the base coating.

The steam-resistant base coating may further comprise additive compounds, such as thickening agents and crosslinking compounds, at additive amounts. Such additive amounts would be included only at up to 10 weight-% of the steam-resistant base coating, based on dry weight.

In another embodiment, the steam-resistant base coating may comprise from 10 to 20 wt % of the polymer binder material having inherent flexibility properties, from 75 to 85 wt-% of an inorganic filler, from 3 to 5 wt % of a crosslinking compound, such as starch, and from 1 to 2 wt % of a thickening agent, based on dry weight.

The filler material may be an inorganic filler selected from the group comprising clays, such as nano-clays including bentonite clays, kaolin clay, talcum, CaCO₃, and silica particles.

The filler material may be an inorganic laminar compound, such as bentonite clay or kaolin clay. Specifically suitable such laminar clay minerals may be laponite, kaolinite, dickite, nacrite, halloysite, antigorite, chrysotile, pyrophyllite, montmorillonite, hectorite, saponite, sauconite, sodium tetrasilicic mica, sodium taeniolite, commonmica, margarite, vermiculite, phlogopite, xanthophyllite and the like. A specific type of such nano-clay laminar particles are those of montmorillonite, e.g. sodium-exchanged montmorillonite (Na-MMT). Such laminar inorganic particles may be exfoliated to efficiently provide a barrier to migrating low-molecular compounds, and may thus also provide good resistance to sudden bursting of steam in adjacent layers.

The ash content of the steam-resistant base-coated cellulose-based substrate may accordingly be from 15 to 25 wt %, such as from 15 to 23 wt %, as determined by ISO1762:2019. The same range of ash content applies to a resulting gas-barrier coated and base-coated fibrous cellulose-based substrate, i.e. 15-25 wt %.

The polymer of the steam-resistant base coating may be selected to exhibit a glass transition temperature from −30 to +30 degrees Celsius, such as from −30 to +20 degrees Celsius, to provide inherent flexibility to a paper substrate coated with a base coating thereof.

The fibrous cellulose substrate may further have a second steam-resistant base coating on its opposite side, which may be of the same type as the steam-resistant base coating on the first side of the substrate. It is, however, preferred that the fibrous cellulose substrate has a steam-resistant base coating only on its first side.

The steam-resistant base coating should be applied directly onto, adjacent and contacting the surface of the fibrous cellulose substrate. The paper may allow moisture to diffuse outwards through the laminated packaging material, and the steam-resistant base coating material may also allow such water vapour migration, to prevent unfavourable entrapment of moisture near a moisture sensitive barrier coating of e.g. PVOH or EVOH. Any moisture migrating through the material from the inside liquid food product in the package will slowly be further transported via the paper layer and the paperboard bulk layer of the laminated packaging material towards the outside of the packaging container. The fibrous cellulose substrate and the paperboard bulk layer may then “breathe away” the humidity from the oxygen first gas barrier coating and thus keep the moisture content within the gas barrier coating(s) substantially constant over time, after having reached equilibrium.

The steam-resistant base coating needs to be further smoothened after coating forced convection drying onto the fibrous cellulose substrate. A soft calendering operation may make the surface of the steam-resistant base coating smooth, to a surface roughness below 3 μm, such as below 2.5 μm (PPS), as measured by ISO 8791-4. The smoothening operation is not, however, performed at high line load, such as not above 200 kN, such as not above 150 kN, and is thus not a super-calendering operation. Soft calendering is performed by a soft, extensible outer layer on the press roller, while the anvil roller may be a hard steel roller. In a hard calender roller nip, on the other hand, both rollers have a hard, incompressible surface, such as being steel rollers.

The steam-resistant base coating composition is applied onto the substrate by an applicator. The most suitable type of system for dispersion coating of the steam-resistant coating or coating compositions are blade coaters, roll coaters or rod coaters, where a large amount of coating composition is applied to the paper and the surplus is scraped off again.

Common applicators may be jet applicators, roll applicators and short dwell time applicators (SDTA). An advantage of roll applicators is that bad formation of a substrate paper is less critical for the roll applicator and it is therefore well suited when thick coatings are desired. Blades that are used to scrape off excessive amount of coating are made of steel and may be equipped with a ceramic tip that makes them last longer. After the coating is applied it passes through a drier, usually an IR-drier, hot air drier or a cylinder drier.

The PPS roughness of the first, top side surface of the base-coated fibrous cellulose-based substrate is preferably lower than 2.5 μm, such as lower than 2.2 μm, such as lower than 2.0 μm, such as 1.8 μm or below, for a further improved gas barrier coating performance, as determined by the above test method.

The base-coated fibrous cellulose-based substrate further coated with a first gas barrier coating being dispersion coated, may also have a PPS surface roughness lower than 2.5 μm, such as lower than 2.2 μm, such as lower than 2.0 μm, such as 1.8 μm or below, as measured according to TAPPI 555 om-15, being the same as ISO 8791-44.

A lower surface roughness provides for a perfect interface to subsequently applied adjacent layers and coatings, with a reduced number of imperfections such as pinholes, and unevenness in a coating layer. Consequently, the gas barrier coating or any further coating layer may be applied at a higher quality, or at a lower thickness, or both. For a same coating thickness of a gas barrier coating, better oxygen barrier properties are thus obtained in the coating itself.

The flexibility of the steam-resistant base coating seems to reduce the tendency of the material to form cracks in the paper and thereby also reduces the tendency to formation of cracks in the gas barrier coatings, thanks to a re-distribution of stress and strain over a larger surface area, e.g. during folding operations.

The first gas barrier coating, which provides the base-coated cellulose-based fibrous substrate of the invention with its basic gas barrier properties, may be an oxygen gas barrier dispersion coating, applied by means of dispersion or solution coating.

Gas barrier coatings applied by means of coating of an aqueous dispersion or solution of an oxygen gas barrier composition may comprise polymers which have inherent oxygen gas barrier properties, and which are food safe and environmentally sustainable both regarding recyclability and in industrial coating and lamination processes. Such polymers are thus water dispersible and/or dissolvable in water and may be applied by means of an aqueous “dispersion coating” process, or a so called “liquid film coating” process. Non-aqueous or only partly aqueous coating compositions, such as those based on alcohols or mixtures of alcohol and water, could also be suitable for achieving the good results from this invention. They would, however, likely be less suitable from environmental sustainability point of view, than water-based coating compositions.

In an embodiment, the gas barrier dispersion coating comprises a polymer selected from the group consisting of vinyl alcohol polymers and copolymers, such as from the group consisting of polyvinyl alcohol (PVOH) and ethylene vinyl alcohol (EVOH), starch, starch derivatives, xylan, xylan derivatives, nanofibrillar cellulose/microfibrillar cellulose (NFC/MFC), and of blends of two or more thereof.

In a further embodiment, the gas barrier dispersion coating is applied by means of dispersion or solution coating at a total amount of from 0.2 to 6 g/m², such as from 0.5 to 5 g/m², such as from 0.5 to 4 g/m², such as from 0.5 to 3.5 g/m², such as from 1 to 3.5 g/m², such as from 1 to 3 g/m², dry weight.

Processes suitable for coating of low dry-content gas-barrier polymer dispersion/solution compositions are broadly any suitable wet coating methods, such as gravure roll coating, smooth roll coating, reverse roll coating, wire bar coating, blade coating, lip coating, air knife coating, and curtain flow coating methods. The experiments for the present invention were performed by means of smooth roller coating, but it is believed that any of the above or other liquid film coating methods that would contribute to generate a homogeneous layer with smooth and even coated surface would be suitable for providing gas barrier coatings out the invention.

It is highly important that the coating applied is evenly coated, forming a continuous and coherent film on the surface and furthermore being defect-free, i.e. substantially without pinholes, blisters or coating misses. Even if a very small defect, its effect on the barrier properties may be negative, which is not desirable. In non-foil packaging materials, i.e. materials without a thick metal foil that can ensure good barrier properties in general, it is very important to reduce the defects of the very thin and more sustainable material coatings to a minimum. It is advantageous to apply at least two coatings on top of each other, to cover and overlap any defects in the separate, thin coating layers.

In a more specific embodiment, the oxygen barrier dispersion coating compositions are based on the two most common types of polymers and copolymers suitable for dispersion coating, based on vinyl alcohol monomers, i.e. polyvinyl alcohol (PVOH) and ethylene vinyl alcohol (EVOH).

The oxygen gas barrier polymer may preferably be PVOH, because it provides good film formation properties, gas barrier properties, cost efficiency, food compatibility and odour barrier properties.

A PVOH-based oxygen gas barrier composition performs best when the PVOH has a degree of saponification of at least 98%, preferably at least 99%, although also PVOH with lower degrees of saponification will provide oxygen barrier properties.

On the other hand, EVOH may be advantageous by providing some moisture resistance to the barrier material, since the copolymer comprises ethylene monomer units. The amount of ethylene monomer units depends on the choice of EVOH grade, but its presence will be at the expense of some oxygen barrier property, in comparison to pure PVOH. Conventional EVOH polymers, are normally intended for extrusion and are not possible to disperse or dissolve in an aqueous medium in order to produce a thin liquid film coated barrier film of 3.5 g/m² or below. It is believed that EVOH should comprise a rather high amount of vinyl alcohol monomer units to be water-dispersible and that the properties should be as close to those of liquid film coating grades of PVOH as possible. An extruded EVOH layer is thus not an alternative to a liquid film coated EVOH, because it inherently has less similar properties to PVOH than EVOH grades for extrusion coating, and because it cannot be applied at a cost-efficient amount below 5 g/m² as a single layer by extrusion coating or extrusion lamination.

Nano-crystalline cellulose, NCC, is a form of nano-cellulose but is not the same as “microfibrillar cellulose”, “MFC” (CMF) or “nanofibrillar cellulose”, NFC (CNF)”.

MFC/NFC may thus contain longer particles, so-called “fibrils” having a width of 10-1000 nm, and a length of at least 1 μm, such as up to 10 μm, such as up to 100 μm.

Both MFC and NFC have an aspect ratio of 50 or above, while NCC/CNC may be defined to have an aspect ratio below 50, e.g. in accordance with ISO/TS 20477:2017 and the draft TAPPI norm WI3021.

The term “NCC”, is used for shorter particles and “rod-like” particles, having a width of 3-100 nm, and a length from 100 too above 1000 nm, such as from 100 to 3000 nm, such as from 100 to 1000 nm, such as from 100 to 500 nm. The majority of the NCC particles in the composition should have this dimension, may be from 100 to 500 nm length, such as from 100 to 200 nm and with a small width of from 3 to 100 nm.

The oxygen barrier dispersion coating composition may further comprise from about 1 to about 30 weight-%, of an inorganic laminar compound based on dry coating weight, such as exfoliated nanoclay particles, such as bentonite. Thus, the barrier layer may include from about 99 to about 80 weight-% of the polymer based on the dry coating weight. An additive, such as a dispersion stabiliser, defoamer or the like, may also be included in the oxygen gas barrier composition, preferably in an amount of not more than about 1 weight % based on the dry coating. The total dry content of the composition is preferably from 5 to 20 weight-%, such as from 7 to 15 weight-%.

A further possible additive in the barrier pre-coating composition may be a polymer or compound with functional carboxylic acid groups, in order to improve the water vapour and oxygen barrier properties of a PVOH coating. Suitably, such polymer with functional carboxylic acid groups is selected from among ethylene acrylic acid copolymer (EAA) and ethylene methacrylic acid copolymers (EMAA) or mixtures thereof. In one embodiment, such a barrier layer mixture may essentially consist of PVOH, EAA and an inorganic laminar compound. The EAA copolymer may be included in the barrier layer in an amount of about 1-20 weight %, based on dry coating weight.

It is believed that some further improved oxygen and water barrier properties may result from an esterification reaction between the PVOH and the EAA at an increased drying temperature, whereby the PVOH is crosslinked by hydrophobic EAA polymer chains, which thereby are built into the structure of the PVOH. Crosslinking can alternatively be induced by the presence of polyvalent compounds, e.g. metal compounds such as metal-oxides. Such mixtures are, however, more expensive because of the cost of the additives and may be less preferred from a recyclability point of view. Accordingly, while it is more preferable to use a barrier dispersion coating from a pure PVOH or EVOH composition, advantageous gas barrier results may be obtainable also with oxygen barrier dispersion coatings comprising further additives as described above.

The barrier dispersion coating may thus be applied at a total amount of from 0.2 to 5 g/m², such as from 0.2 to 4 g/m², more preferably from 0.5 to 4 g/m², such as from 0.5 to 3.5 g/m², such as from 1 to 3 g/m², dry weight. Below 0.2 g/m², there will be no gas barrier properties achieved at all, while above 3.5 g/m², the coating may bring less cost-efficiency to the packaging laminate, due to high cost of barrier polymers in general and due to high energy cost for evaporating off the liquid. A recognisable level of oxygen barrier is achieved by PVOH at 0.5 g/m², and above, and a good balance between barrier properties and costs is normally achieved between 0.5 and 3.5 g/m².

In an embodiment, the gas barrier dispersion coating may be applied in two, three or even four consecutive steps with intermediate drying, as part-layers. When applied as two part-layers or “part-coatings”, each layer may suitably be applied in amounts from 0.2 to 2.5 g/m², preferably from 0.5 to 1.5 g/m², and allows a higher quality total layer from a lower amount of liquid oxygen gas barrier composition. More preferably, the two part-layers may be applied at an amount of from 0.5 to 1.5 g/m² each.

For the unexpected improvement of the invention, the gas barrier dispersion coating shall thus not be coated directly onto the paper or cellulose-based substrate but shall be preceded by a first steam-resistant base coating of a different polymer and material composition than the gas barrier material composition, to prepare the substrate surface for the further, direct application of the thin gas barrier coating onto the first steam-resistant base coating. It is believed that the properties of the aqueous steam-resistant base coating composition enable a dense and even base layer top surface for the further gas barrier coating and a compatible adhesion chemistry and wettability for the subsequent application of for example a polyvinyl alcohol-based gas barrier coating. It seems also that the steam-resistant base coating has the capability to absorb stress and strain on the barrier-coated cellulose-based fibrous substrate as it is folded and abused, when used in a laminated packaging material. The gas barrier coating is thus applied directly onto, to be in contact with, the steam-resistant base coating.

The base-coated and gas barrier dispersion coated cellulose-based fibrous substrate may have on the surface of its first, gas-barrier coated side, a vapour deposition coating of a gas barrier material selected from metals, metal oxides, inorganic oxides and amorphous diamond-like carbon coatings, as a further gas barrier coating. The vapour deposition coating may be applied by means of physical vapour deposition (PVD) or chemical vapour deposition (CVD), for example by plasma enhanced chemical vapour deposition (PECVD). It may more specifically be selected from the group consisting of an aluminium metallisation coating and aluminium oxide, AlOx. Preferably it is an aluminium metallisation coating.

The barrier-coated cellulose-based fibrous substrate may thus be coated with a gas barrier material by means of vapour deposition coating onto its top-side surface to a thickness of from 2 to 100 nm, such as from 2 to 80 nm, such as from 2 to 50 nm, such as from 2 to 45 nm.

The vapour deposited barrier coating to finally be coated onto the top-side surface of the cellulose-based substrate, is applied by means of physical vapour deposition (PVD) or chemical vapour deposition (CVD), for example by plasma enhanced chemical vapour deposition (PECVD).

Generally, below 5 nm the barrier properties may be too low to be useful and above 200 nm, such as above 100 nm, such as above 50 nm, depending on the type of vapour deposition coating, the barrier coating may be less flexible and, thus, more prone to cracking when applied onto a flexible substrate and would also cost more.

Other examples of vapour deposition coatings are aluminium oxide (AlOx, Al₂O₃) and silicon oxide (SiOx) coatings. Generally, PVD-coatings of such oxides are more brittle and less suitable for incorporation into packaging materials by lamination, while metallised layers as an exception do have suitable mechanical properties for lamination material despite being made by PVD.

Normally, an aluminium metallised layer inherently has a thin surface portion consisting of an aluminium oxide due to the nature of the metallisation coating process used.

In an embodiment, such an aluminium metallised layer has been applied to an optical density (OD) of from 1.8 to 4, preferably from 1.9 to 3.5. At an optical density lower than 1.8, the barrier properties of the metallised film may be too low. At above 4, on the other hand, the metallisation process may take longer time, and the thermostability during the metallisation process may be lower due to higher heat load when metallising the substrate during a longer time.

The optical density is measured in production by means of a densitometer, i.e. an instrument (such as from Macbeth, Tobias or similar), which uses the principle of diffuse light transmission. The instrument is suitable for measuring the optical density values of films coated with aluminium metallization. The accuracy and precision of the measurements is high and about +/−0.2 OD and about +/−0.01 OD, respectively, within a measuring range from 0 to 6.60 OD. In lab measurements, a spectrophotometer may alternatively measure the light transmission over the full visible spectrum (380-800 nm). The optical density is calculated from the light transmission (T) value at 560 nm, according to a formula OD=−log 10 (I1/I0) and the values obtained are equally accurate (+/−0.2 OD) and comparable to light transmission densitometer values.

Other coatings may be applied by means of a plasma enhanced chemical vapour deposition method (PECVD), wherein a vapour of a compound is deposited onto the substrate under more or less oxidising circumstances. Silicon oxide coatings (SiOx) may, for example, also be applied by a PECVD process, and may then obtain very good barrier properties under certain coating conditions and gas recipes.

DLC defines a class of amorphous carbon material (diamond-like carbon) that displays some of the typical properties of diamond. Preferably, a hydrocarbon gas, such as e.g. acetylene or methane, is used as process gas in a plasma for producing a coating of amorphous hydrogenated carbon barrier layer applied by a PECVD vacuum process, i.e. a DLC. DLC coatings applied by PECVD under vacuum provide good adhesion to subsequently laminated, adjacent polymer or adhesive layers in a laminated packaging material. Particularly good adhesion to adjacent polymer layers, are obtained with polyolefins and in particular polyethylene and polyethylene-based co-polymers.

The barrier coatings may thus comprise a first oxygen gas barrier dispersion coating, first applied by means of dispersion or solution coating onto the steam-resistant base coating, and a further barrier deposition coating, subsequently applied by means of a vapour deposition method, onto the first gas barrier dispersion coating.

The gas barrier coated cellulose-based fibrous substrate obtained by the above method, provides low oxygen transmission and low water vapour transmission also after lamination into a heat sealable laminated packaging material and further after fold-forming and heat sealing of the laminated material into packaging containers.

A carton-based laminated packaging material for packaging of oxygen-sensitive products may comprise a bulk layer of paper or paperboard, a first outermost, liquid tight material layer, a second innermost liquid tight, material layer and, arranged on the inner side of the bulk layer of paper or paperboard, towards the inside of a packaging container made from the packaging material, between the bulk layer and the second innermost layer, the barrier-coated cellulose-based fibrous substrate of the invention.

A paper or paperboard bulk layer may have a thickness of from about 70 μm up to about 600 μm, and a surface weight of approximately 70-500 g/m², preferably about 200-300 g/m², and may be a conventional paper or paperboard of suitable packaging quality.

For low-cost aseptic, long-term packaging of liquid food, a thinner packaging laminate may be used, having a thinner paper core layer. The packaging containers made from such packaging laminates are not fold-formed and more similar to pillow-shaped flexible pouches. A suitable paper for such pouch-packages usually has a surface weight of from about 50 to about 140 g/m², preferably from about 70 to about 120 g/m², more preferably from 70 to about 110 g/m². As the barrier-coated substrate in this invention in itself may contribute with some stability to the laminated material, the paper layer corresponding to a “bulk” layer may be even thinner and interact with the barrier cellulose-based substrate in a sandwich interaction to still produce a laminated packaging material having the desired mechanical properties altogether.

The barrier-coated paper or cellulose-based substrate may be bonded to the bulk layer by an intermediate adhesive, or thermoplastic polymer bonding layer, thus binding the un-coated surface of the barrier-coated cellulose fibrous substrate to the bulk layer. The bonding layer may be a polyolefin layer, such as in particular a layer of a polyolefin copolymer or blend, such as including in the majority ethylene monomer units. The bonding layer may bond the bulk layer to the barrier-coated cellulose-based fibrous substrate by melt extruding the molten bonding polymer as a melt layer between the webs and simultaneously pressing the three layers together, while being forwarded through a lamination roller nip under simultaneous cooling, thus providing a laminated structure by extrusion lamination. Melt extrusion lamination requires a sufficient amount of molten polymer, in this case typically a polyolefin, such as low density polyethylene, to bind the two colder surfaces together A sufficient amount is typically from 12 to 20 g/m², possibly from 12 to 15 g/m².

Other suitable bonding or tie layers in the interior of the laminated material, such as for example between the bulk or core layer and the barrier-coated cellulose-based fibrous substrate, or between the innermost, liquid tight and heat sealable layer and the barrier-coated paper substrate, may also be so-called adhesive thermoplastic polymers, such as modified polyolefins, which are mostly based on LDPE or LLDPE co-polymers or, graft co-polymers with functional-group containing monomer units, such as carboxylic or glycidyl functional groups, e.g. (meth)acrylic acid monomers or maleic anhydride (MAH) monomers, (i.e. ethylene acrylic acid copolymer (EAA) or ethylene methacrylic acid copolymer (EMAA)), ethylene-glycidyl (meth)acrylate copolymer (EG(M)A) or maleic anhydride (MAH) grafted polyethylene (MAH-g-PE). Another example of such modified polymers or adhesive polymers are so called ionomers or ionomer polymers. Preferably, the modified polyolefin is an ethylene acrylic acid copolymer (EAA) or an ethylene methacrylic acid copolymer (EMAA).

The barrier-coated cellulose-based fibrous substrate may alternatively be bonded to the bulk layer by wet application of a dispersion of an aqueous adhesive composition comprising an adhesive polymer binder onto one of the web surfaces to be laminated and pressing the two paper webs together while they are forwarded through a lamination roller nip, thus providing a laminated structure by wet lamination. The moisture of the aqueous adhesive composition is absorbed into the fibrous cellulose network of the two paper layers, and partly evaporating with time, during the subsequent lamination processes. There would thus be no need for a forced drying step. The barrier-coated cellulose-based fibrous substrate may thus be laminated to the bulk layer by from 0.5 to 6 g/m², such as from 1 to 5 g/m², such as from 1 to 4 g/m², dry weight, of an interjacent bonding composition comprising a binder selected from the group consisting of acrylic polymers and copolymers, starch, starch derivatives, cellulose derivatives, polymers and copolymers of vinyl acetate, polymers and copolymers of vinyl alcohol, copolymers of styrene-acrylic latex or styrene-butadiene latex or adhesive bio-latexes. For best possible environmental and sustainability profile, adhesive binders originating from plants or non-fossil sources are preferred.

Such a low amount of an interjacent bonding composition is only possible to apply by aqueous dispersion or solution coating of a polymer binder and is not possible to apply by extrusion coating or extrusion lamination of a single-layer polymer melt due to the nature of the molten-layer extrusion process. Since the surfaces of the layers to be bonded together are both made of cellulose, such wet lamination is made by the absorption of the aqueous medium into the respective cellulose layers, and thus a thin and dry bonding layer at the interface between the two layers may be formed.

Suitable materials for the outermost and innermost liquid-tight layers may be thermoplastic polymers, such as polyolefins such as polyethylene and polypropylene homo- or co-polymers, preferably polyethylenes and more preferably polyethylenes selected from the group consisting of low density polyethylene (LDPE), linear LDPE (LLDPE), single site catalyst metallocene polyethylenes (m-LLDPE) and blends or copolymers thereof. Such thermoplastic polymers also have the advantage of being readily weldable, i.e. heat sealable, to the same or similar polymers and to other materials with thermoplastic behaviour. According to an embodiment, the outermost heat sealable and liquid-tight layer may be an LDPE, while the innermost heat sealable, liquid-tight layer may be a blend composition of m-LLDPE and LDPE for optimal lamination and heat sealing properties.

The outermost layer may be merely protective towards liquid and dirt, such that any sealing of the outside surface to another surface or item, such as an opening device or the like, will be carried out by an additional glue or hot melt. For packaging of products having lower requirements regarding strength of seals and tightness, this is also valid regarding the second innermost layer. For packaging of liquid, semi-liquid, viscous flowing products and wet food, the packaging container qualities are more dependent on that the second innermost layer is also heat-sealable to produce strong and tight packages that can carry the filled product under all circumstance in handling and distribution, and thus it may be required that the second innermost layer is liquid-tight as well as heat sealable.

The same thermoplastic materials, as listed regarding the outermost and innermost layers, such as polyolefins and in particular polyethylene-based materials, may also be suitable in bonding layers in the interior of the laminated material, i.e. between a bulk or core layer, such as paper or paperboard, and the barrier-coated cellulose substrate. The thermoplastic bonding layer may thus be a polyethylene layer, such as a low density polyethylene (LDPE) layer.

The second innermost liquid tight, heat sealable polyolefin layer may be a pre-manufactured film comprising the same or similar polyolefins, as described above, for improved robustness of the mechanical properties of the packaging material. Due to the manufacturing process in film blowing and film casting operations, and optional subsequent film orientation operation steps, the polymers of such films acquire different properties from what is possible from merely (co-) extrusion coated polyolefin layers. Such a pre-manufactured polymer film may thus contribute to the mechanical robustness of a laminated packaging material and to mechanical strength, package integrity and further reduced loss of barrier properties of formed and filled packaging containers from the laminate packaging material.

A laminated packaging material may have a pre-manufactured polymer film laminated between the barrier-coated cellulose-based fibrous substrate and the second innermost liquid tight material layer, for improved robustness of the mechanical properties of the laminated packaging material. A pre-manufactured film has a higher degree of orientation of the polymer of which it is made, and thus has different mechanical properties to a merely extrusion coated, or extrusion laminated, layer of the same or corresponding polymer. Thus, by incorporating such a film in the structure, the laminated material altogether may be made stronger and better resistant to downstream tough treatment of the material. Such pre-manufactured films may be avoided in the material, as they add costs both from sourcing of materials point of view and from the lamination operation point of view. Pre-manufactured films may have different mechanical properties and may be ranging from biaxally oriented, tough films obtained by mere extrusion cast films to films manufactured by film blowing and inherent polymer orientation occuring in that process, or with additional subsequent orientation. Alternatively, polymer materials that are merely extrusion coated or extrusion laminated may be used.

The second innermost layer of a liquid tight, heat sealable material may be a polyolefin, preferably a blend of low density polyethylene, LDPE, and metallocene-catalysed (using a single-site or constrained-geometry catalyst), linear low density polyethylene, m-LLDPE. This is the type of polymer most used today for the innermost layer, for best balanced liquid tightness and heat sealability properties, and which generates best possible package integrity of heat sealed packaging containers. By choosing the composition of this layer carefully, the amount of polymer in this layer may be optimised to be as low as possible while still producing strong and reliable packages filled with product. The polymer composition of the innermost, liquid tight, heat sealable material layer may have a melting temperature from 88 to 110° C.

The second innermost liquid tight, heat sealable material layer may thus be, or comprise, a pre-manufactured polymer film, the film comprising a heat-sealable thermoplastic polymer material and, optionally, a further layer of a material for providing improved robustness of the mechanical properties of the laminated packaging material.

In a further, preferred embodiment, the heat-sealable laminated packaging material has an inside polymer multilayer portion on the inside of the barrier-coated cellulose-based, fibrous substrate, comprising at least a second innermost liquid tight, heat sealable material layer to be in direct contact with a product to be filled into a packaging container made from the packaging material,
the second innermost liquid tight, heat sealable material layer comprising a polyethylene polymer having a low density,
such as selected from the group consisting of low density polyethylene, LDPE, linear low density polyethylene, LLDPE, and blends thereof,
and further comprising an interjacent load-bearing layer comprising a high-density polyethylene, HDPE, a medium-density polyethylene, MDPE, a linear low-density polyethylene, LLDPE, having a melt flow ratio, MFR, from 4 to 20 g/10 min (190° C./2.16 kg) and a melting temperature above 115° C., or blends of two or more thereof,
wherein the layers of the inside polymer multilayer portion are applied by means of extrusion coating onto the inner side of the barrier-coated cellulose-based, fibrous substrate.

The interjacent load-bearing layer may be adjacent and in direct contact with the second innermost liquid tight, heat sealable material layer, which may have a major melting temperature, Tm, from 88 to 110° C.

The second innermost liquid tight, heat sealable material layer may comprise a blend of from 50 to 90 weight-% of a linear low density polyethylene obtained by a single-site or constrained-geometry catalyst, i.e. a so-called metallocene catalyst, m-LLDPE, with from 10 to 50 weight-% of a low density polyethylene, LDPE.

The inside polymer multilayer portion may further comprise a tie layer comprising an adhesive polymer adjacent and in contact with the barrier-coated, inner side of the cellulose-based, fibrous substrate.

Such an inside polymer multilayer configuration is advantageous in comparison to the incorporation of a pre-manufactured film into the laminated packaging material, because it adds sufficient and reliable load-bearing and robustness properties to the inside polymer multilayer portion, at a lower resistance to opening, tearing and penetration forces and furthermore, at lower cost. The finding that sufficient load-bearing properties can be obtained, to properly protect both the barrier-coated paper substrate, such that its gas barrier properties may be maintained, and the food product filled in packaging containers from the material, has been important. It is important and a breakthrough innovation, as it has hitherto seemed best to use costly, pre-manufactured films, which instead entailed problems regarding consumer opening of the filled and sealed packaging containers made from the laminated materials.

The barrier-coated paper substrate in this invention is not a high-density, high-cost, impregnated paper substrate. It is instead, a rather porous, i.e. fibrous, low-density paper substrate, of which the fibre material may easily break and deteriorate upon folding, such that cracks may be generated in its barrier coatings and in adjacent layers.

Barrier-coated cellulose-based substrates, or so-called “paper-barriers” generally pose special challenges. Unlike aluminium foil or barrier-coated polymer films, the barrier substrate of a paper or cellulose sheet in its interior may essentially comprise organic material from virgin cellulose fibres. Even if the cellulose fibres are as clean as possible, being cooked and chemically treated during paper manufacturing and thus thoroughly treated, they are not as clean as the interior of polymer material layers or inorganic foils or deposition coatings. The barrier coatings that are applied on the inside of the cellulose sheet will be heated as they are applied, in drying and deposition processes, respectively, and will thus be clean materials in the laminated material. The barrier coatings will thus, insofar as they are of good quality, protect the inside of the package from the interior cellulose sheet fibres, as long as the coatings are unbroken. The coatings are thin and sensitive, however, relative to an aluminium foil, which has a thickness from 5-10 μm.

This in turn poses challenges on the inside polymer layers, which are thermoplastic polymers coated or laminated onto the barrier coatings of the paper barrier, to protect them, as well as the filled food product, in a packaging container fold formed from a laminated material comprising the paper barrier. The polymer inside layers need to be applied as homogenous coatings or as pre-manufactured films and they have multiple purposes. The inside polymer multilayer portion needs to be heat sealable, i.e. thermo-weldable, at high-speed in filling and packaging machines, and needs to keep the formed packaging containers liquid tight both towards the inside of the package and towards the outside. Furthermore, the inside polymer layers need to help protect the barrier coatings from being destroyed during fold-forming and filling processes, as well as maintaining good integrity towards migration of microbes through the package and the materials into the filled food product, should it still happen that the barrier coatings would be destroyed. Adding thicker and stronger such polymer layers may help to some extent, but such measures weigh against the requirements that we for environmental sustainability must reduce the use of polymer materials in carton liquid packaging materials, and that the packaging materials need to be reasonably easy to open for the end-consumer.

From working with improved cellulose-based barrier materials and barrier substrates, it is understood that it is important to minimize the “loss” of oxygen barrier properties upon fold forming the laminated materials comprising the barrier materials. The oxygen barrier loss is an indication that the thin and sensitive barrier coatings are to some extent damaged upon fold-forming and re-shaping into filled packaging containers. Therefore, it is especially regarding paper barrier materials relevant to measure and understand the resulting Package-OTR rather than the OTR on flat material. The Package-OTR has by recent developments been well improved, based on improvements in the cellulose-based substrate as such.

From the development of packaging laminates comprising barrier-coated cellulose-based substrates, it has thus sometimes been seen that the configuration of the conventional coextrusion-coated inside polymer multilayer portion resulted in occasional bad packages, thus being insufficient in terms of integrity under severe circumstances, while the oxygen barrier of the packages in general was mostly good. The laminated materials were therefore improved further by including also a thermo-sealable, pre-manufactured film as the innermost layer. Pre-manufactured films may have good homogeneity and reliability regarding thickness and quality, and significantly fewer defects (pinholes, un-evenness etc) than melt extrusion coated layers. A laminate having a pre-manufactured, cast film of LLDPE polymers, was thus recently developed, which adds toughness and good integrity to the laminate, while it does at least not detrimentally prevent openability of the full material. Such a film is, however, expensive and requires a more difficult lamination operation in the laminate production, while the openability is unfortunately significantly reduced, even if not to an impossible extent. Using such a film, has in view of recent developments regarding co-extrusion coated inside polymer layer configurations become the second best version of high-integrity, heat-sealable laminated packaging materials involving barrier-coated cellulose-based substrates.

The purpose of any one of the previously listed specific examples of laminates, is to add complementary properties to the laminated packaging material, when using merely the barrier-coated cellulose-based fibrous substrate as such, as a gas barrier material in the laminate structure, or wherein the applied coating provides only some gas barrier properties, or when the coating has only moisture-sensitive gas barrier materials. By laminating the barrier-coated cellulose-based substrate to a further polymer film, which may add further moisture-resistance or water vapour barrier properties, the at least two different barrier materials may interact to provide further enhanced total barrier properties to the total laminate structure. Typical examples of such a pre-manufactured films, adding at least barrier properties towards water vapour, may be metallised films and polymer films including filler materials, such as flake-shaped mineral fillers or other small particles, which help to delay diffusion of water vapour through the laminated structure. The necessary bonding layer between the barrier-coated cellulose-based fibrous substrate and the further barrier film may ensure such enhanced barrier properties, since the interjacent bonding layer acts as a “cushion” and further “gas or vapour migration interface” in the laminated structure.

The outer- and innermost, liquid-tight layers and the lamination layers in the interior of the laminate structure, do not normally and inherently add high barrier properties to migrating gas molecules or small molecules. Their purpose is to provide a direct barrier to water in liquid form from penetrating through to the cellulose-based bulk material and other paper layers. The liquid barrier layers also prevent water vapour from migrating to the cellulose to the extent that it gets wet but are not capable of keeping the moisture content of the laminated structure at zero or at the low level of “dry” paper (which is at about 7-8% in an environment at ambient temperature, i.e. at 23 degrees Celsius, and 50% relative humidity, RH). The moisture content in the laminated carton material of a packaging container filled with liquid is usually rather high and migration through the material occurs, unless there is a further water vapour barrier included, such as an aluminium foil, a vapour deposited metallisation layer, other vapour deposition coating, inorganic material layer or other polymer material layer.

A laminated packaging material as described above may provide good integrity when transformed into filled packaging containers, by good adhesion between the adjacent layers within the laminated construction and by providing good quality of the barrier coatings and the steam-resistant base coating, each and in combination. Especially, for the packaging of liquids, and wet food, it is important that the inter-layer adhesion within the laminated packaging material, as well as the oxygen gas barrier properties, is maintained also under wet packaging conditions.

A packaging container formed from a described laminated packaging material may be partly sealed, filled with liquid or semi-liquid food and subsequently sealed, by sealing of the packaging material to itself, optionally in combination with a plastic opening or top part of the package.

To conclude, robust and reliable heat sealed packages for liquid food packaging for long term shelf-life and storage may be obtained from heat sealable laminates comprising the barrier-coated cellulose-based fibrous substrate, as defined by the claims, thanks to the oxygen barrier properties being well maintained during folding of the packaging material and thanks to the material allowing heat sealing operations without risk for formation of steam blisters.

### EXAMPLES AND DESCRIPTION OF PREFERRED EMBODIMENTS

In the following, preferred embodiments of the invention will be described with reference to the drawings, of which:

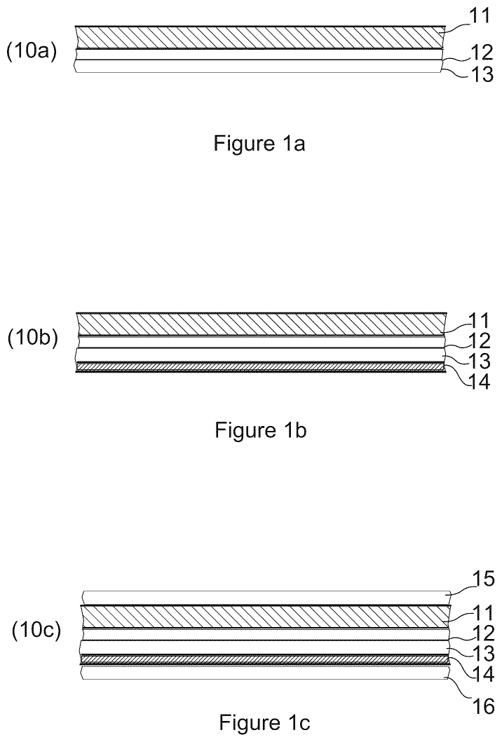

FIGS. 1a and 1b schematically show in cross-section embodiments of barrier-coated cellulose-based fibrous substrates according to the invention,

FIG. 1c shows schematically in cross-section a simple packaging laminate comprising the barrier-coated cellulose-based fibrous substrate of FIG. 1b,

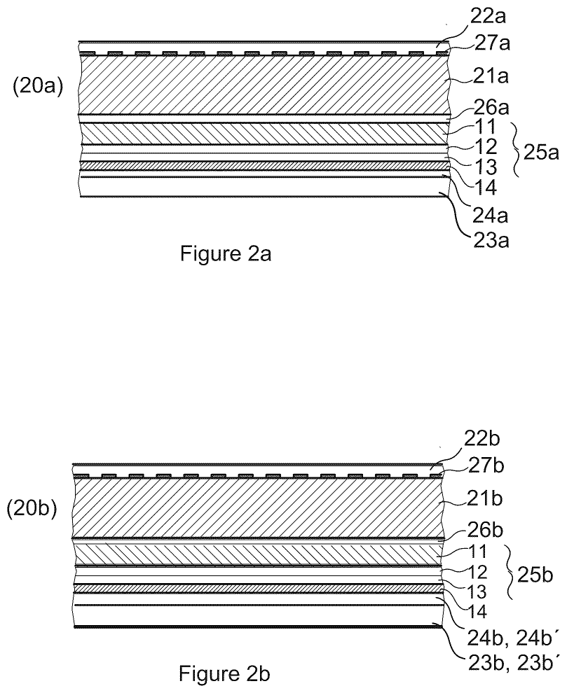

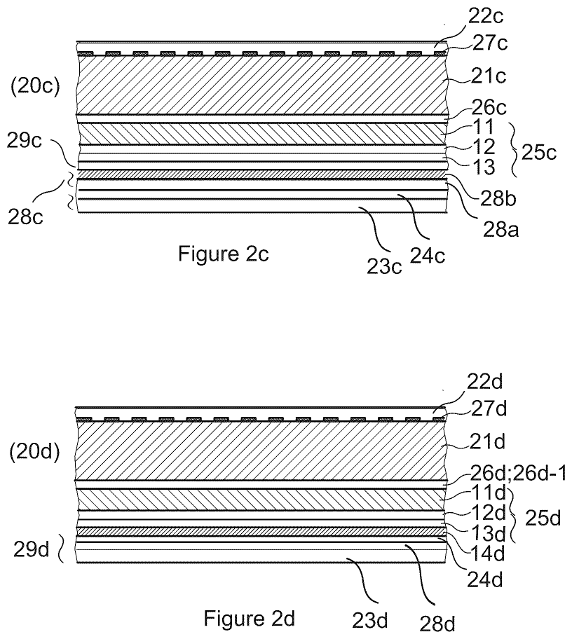

FIG. 2a shows a schematic, cross-sectional view of an example of a heat sealable laminated packaging material exhibiting significant bending stiffness, comprising the barrier-coated cellulose-based fibrous substrate of FIG. 1b,

FIG. 2b is showing a schematic, cross-sectional view of a further example of such a heat sealable laminated packaging material comprising a barrier-coated cellulose-based fibrous substrate as of FIG. 1b,

FIG. 2c shows a schematic, cross-sectional view of an alternative embodiment of a heat sealable laminated packaging material comprising a barrier-coated cellulose-based fibrous substrate as of FIG. 1a,

FIG. 2d shows a further embodiment of a heat sealable laminated packaging material comprising a barrier-coated cellulose-based fibrous substrate as of FIG. 1b,

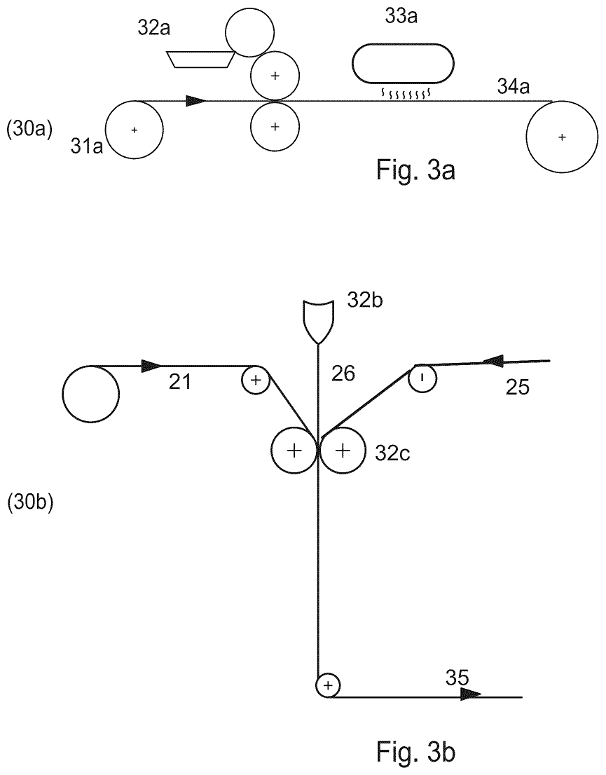

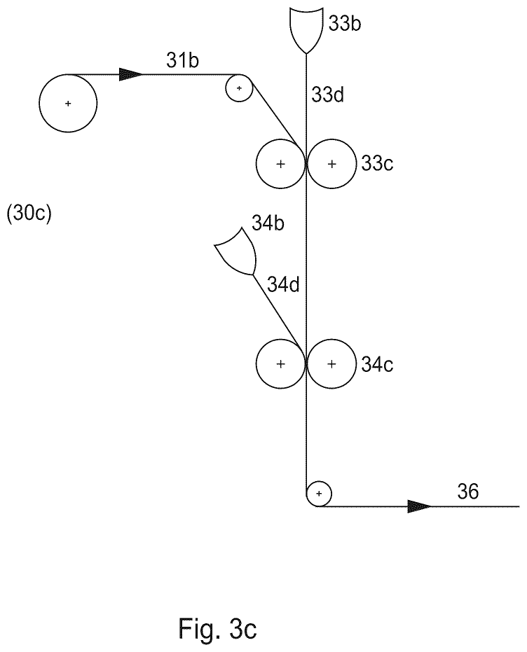

FIG. 3a shows schematically a principal method, for dispersion coating a steam-resistant base coating composition or a gas barrier dispersion coating onto a cellulose-based substrate,

FIG. 3b shows schematically a method for melt extrusion laminating two webs of material to each other in a lamination roller nip,

FIG. 3c shows schematically a method, for melt (co-) extrusion coating layer(s) of a thermoplastic heat sealable and liquid-tight polymer onto a web substrate, to form inside polymer layers (including at least an innermost layer) and outermost layers of a packaging laminate of the invention,

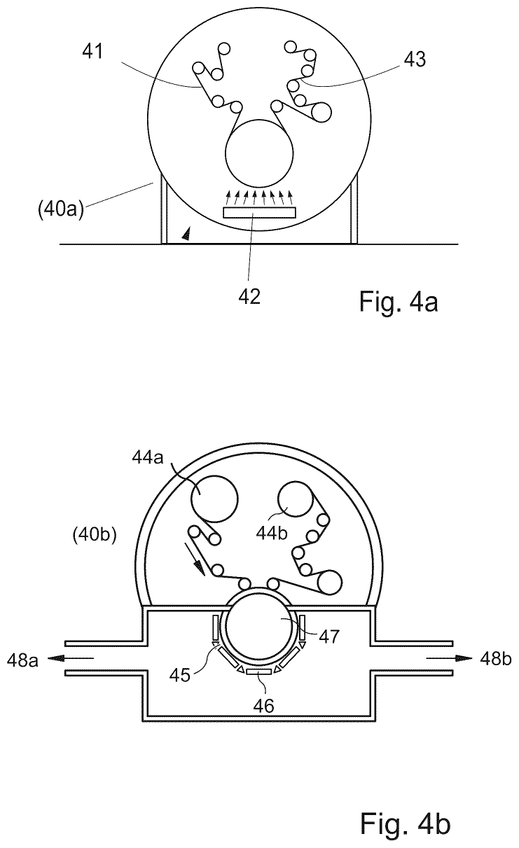

FIG. 4a is showing a diagrammatic view of a plant for physical vapour deposition (PVD) coating, by using a solid metal evaporation piece, onto a substrate, such as the barrier-coated paper substrate of FIG. 1a or 1b,

FIG. 4b is showing a diagrammatic view of a plant for plasma enhanced chemical vapour deposition (PECVD) coating, by means of a magnetron plasma, onto a substrate, such as the barrier-coated paper substrate of FIG. 1a or 1b,

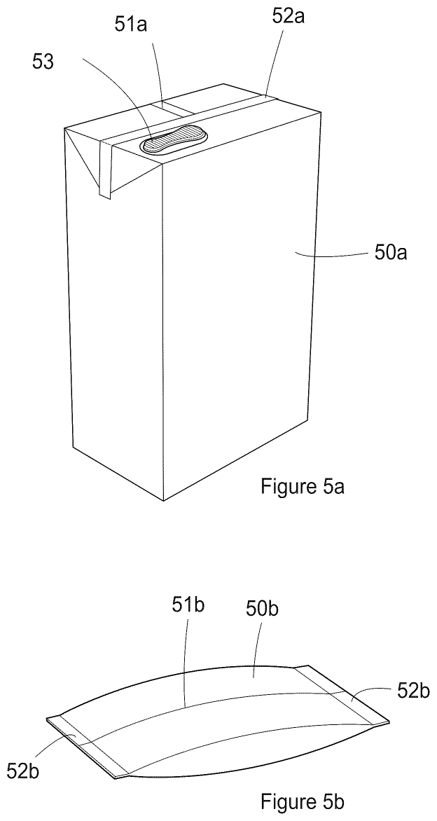

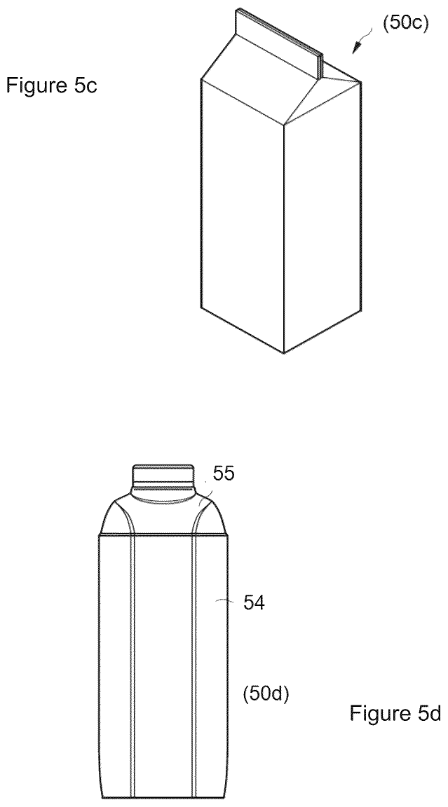

FIGS. 5a, 5b, 5c and 5d are showing typical examples of packaging containers produced from a laminated packaging material comprising a barrier-coated cellulose-based fibrous substrate according to the invention,

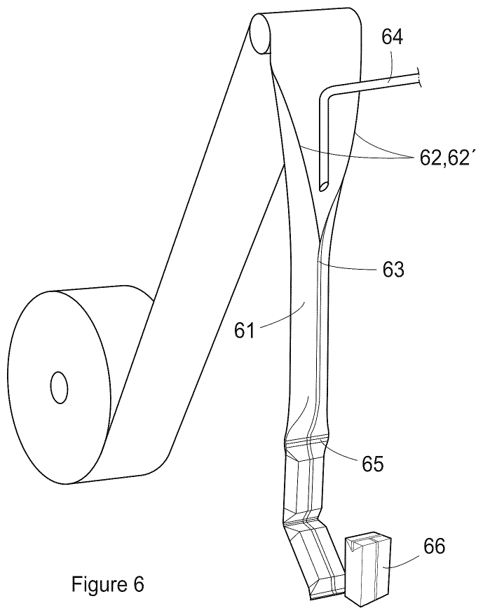

FIG. 6 is showing the principle of how such packaging containers may be manufactured from the packaging laminate in a continuous, roll-fed, form, fill and seal process,

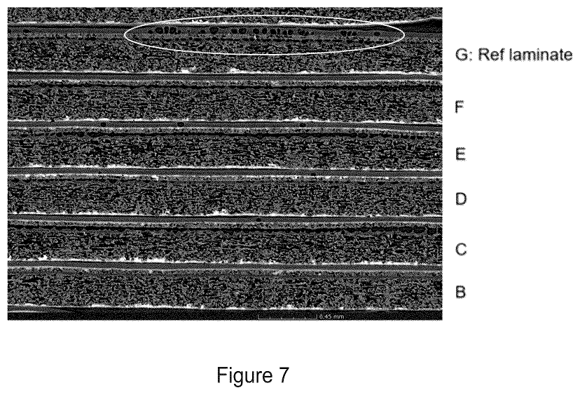

FIG. 7 shows an image taken by X-ray tomography of the cross-section of a stack of laminated packaging materials, comprising a reference material as well as a series of inventive laminated packaging materials,

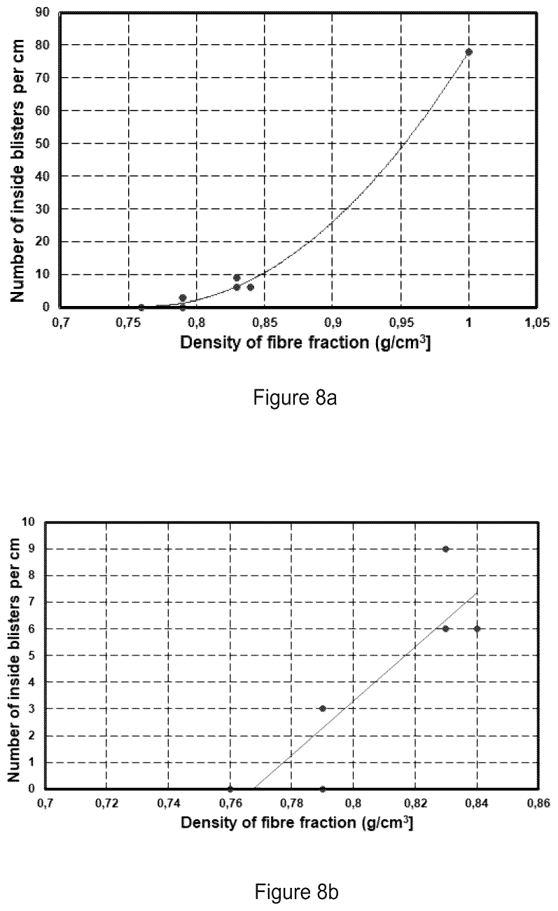

FIG. 8a is a diagram showing the effect of a lower density and inherently higher interior porosity of the fibrous, cellulose-based part of a barrier-coated paper substrate on the number of defects after heat sealing of the laminated packaging material comprising the barrier-coated paper,

FIG. 8b shows the same effect as in FIG. 8a, by zooming in on the most effective part of the range of low densities,

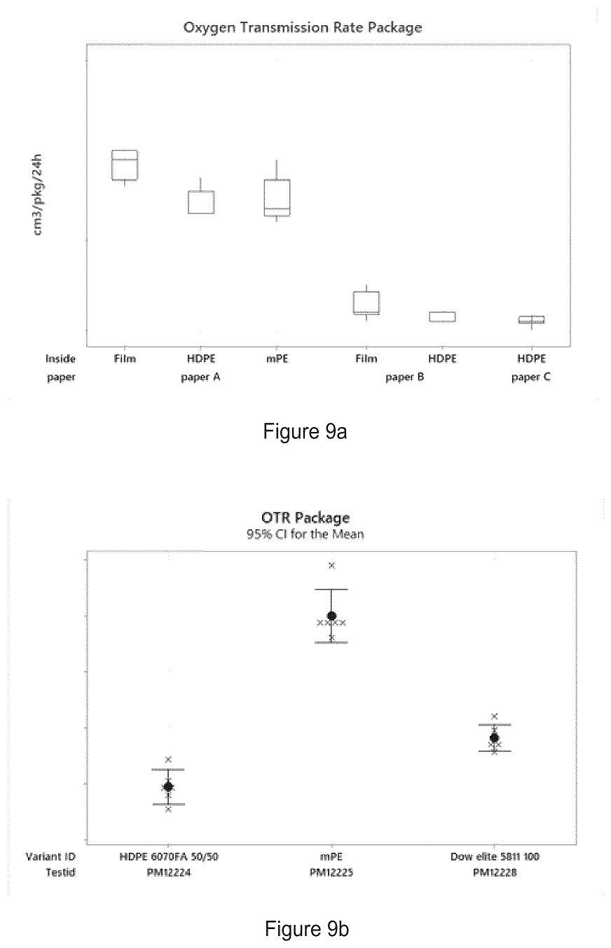

FIGS. 9a and 9b show results in a respective diagram from measurements of oxygen transmission, OTR, into a packaging container (“OTR Package”) made from laminated materials, according to embodiments having different inside polymer layer configurations,

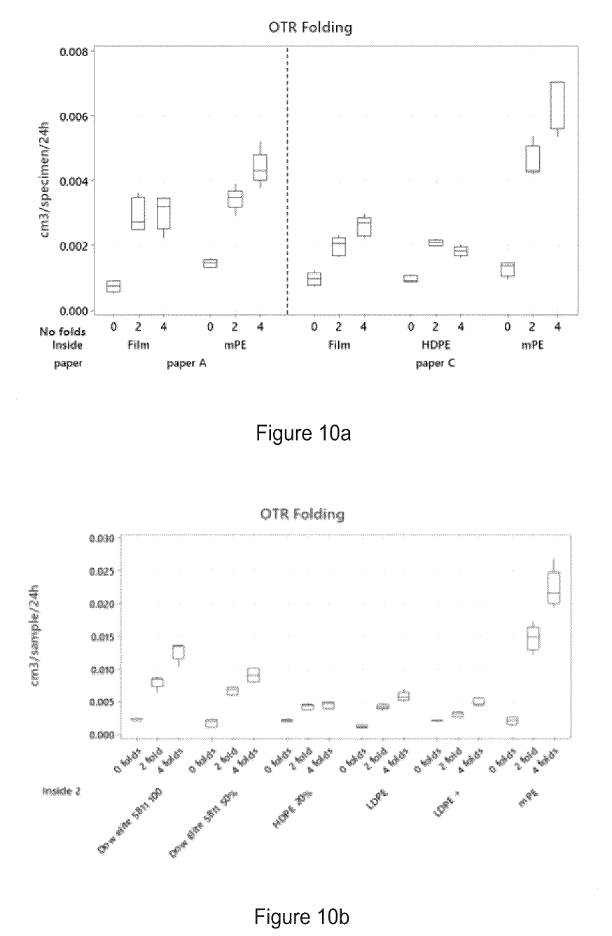

FIGS. 10a and 10b show results in a respective diagram from measurements of OTR after mono-axial folding of laminated materials according to further embodiments having different inside polymer layer configurations,

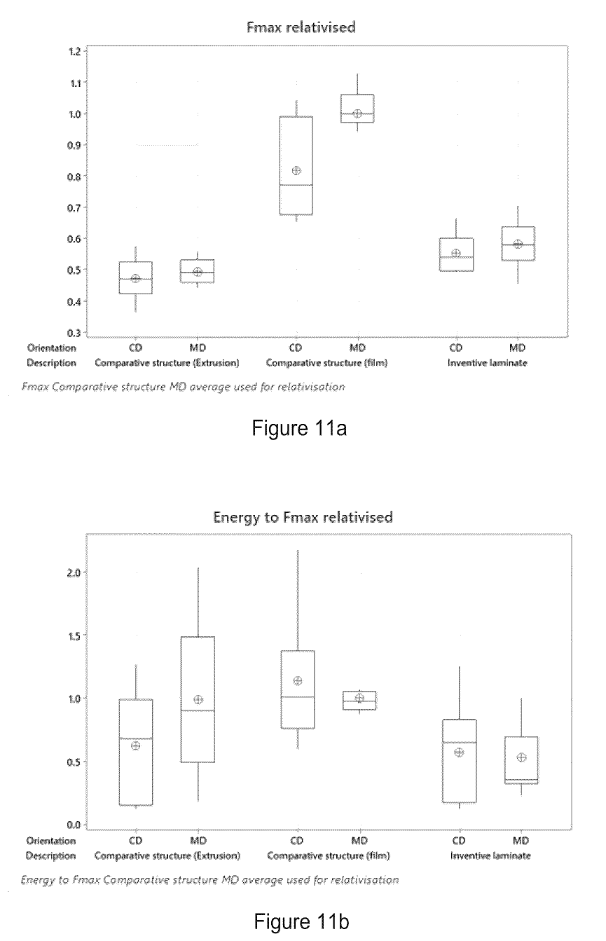

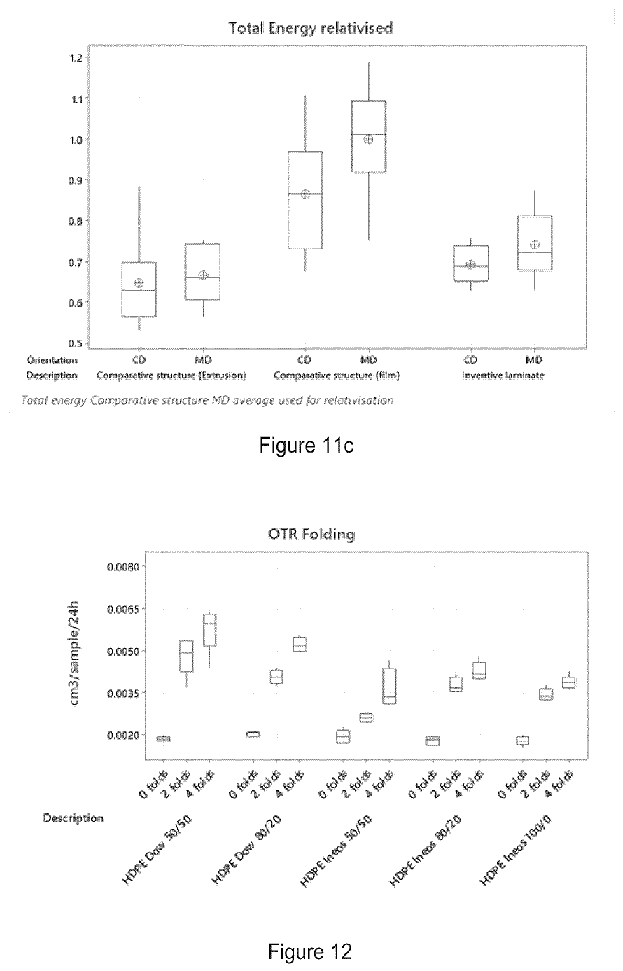

FIGS. 11a, 11b and 11c show results from respectively maximum openability force, maximum energy and total energy, required for penetration with a paper straw through a pre-cut, laminated straw hole on laminated materials according to a preferred embodiment having a specific inside polymer layer configuration and on comparative embodiments of laminated materials having other inside polymer layer configurations,

FIG. 12 shows the impact on OTR of different, preferred, coated configurations of the inside polymer multilayer portion on planar unfolded, as well as multiply monoaxially folded, creased panels of embodiments of laminated packaging materials,

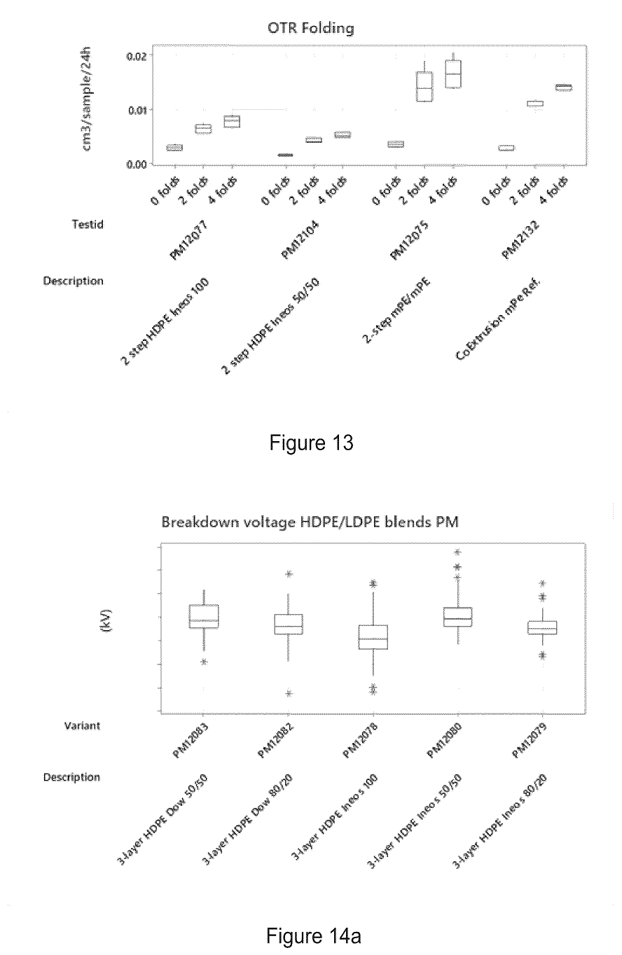

FIG. 13 shows further results of the impact on OTR of different coated configurations of the inside polymer multilayer portion on flat, unfolded, as well as multiply monoaxially folded, panels of embodiments of laminated packaging materials,

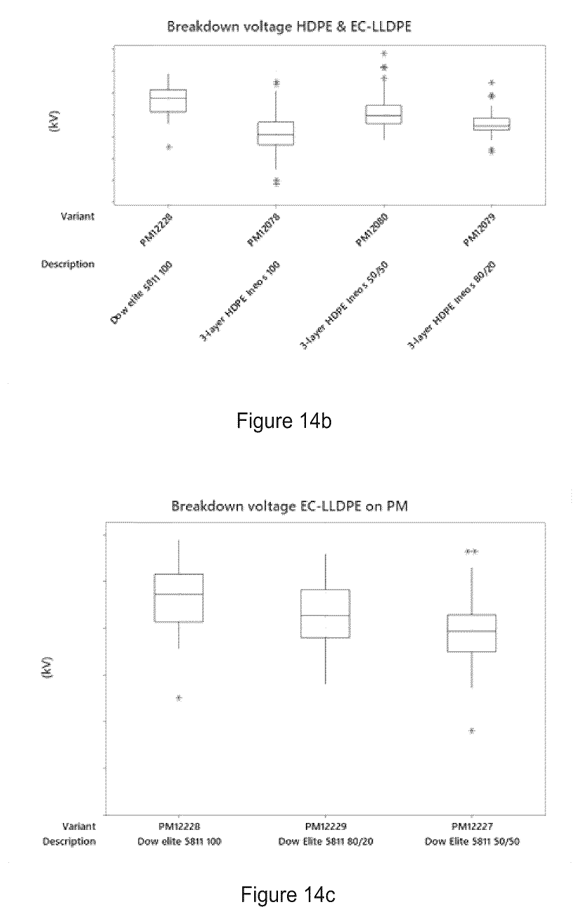

FIG. 14a shows results from studying the quality and thickness of the inside polymer multilayer portion after biaxial folding on the same samples of laminated materials as tested in FIG. 12,

FIGS. 14b and 14c show results from studying the quality and thickness of the inside polymer multilayer portion after biaxial folding on samples of laminated materials having different inside, interjacent, load-bearing, polymer layers comprising HDPE or an LLDPE having a melt flow rate from 4 to 20 g/10 min (190° C./2.16 kg) and a melting temperature above 115° C.,

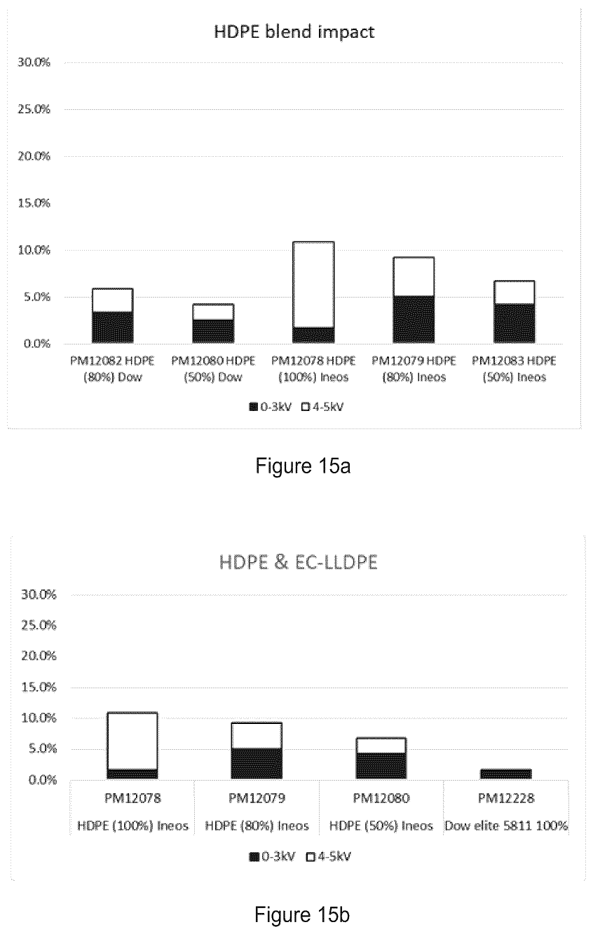

FIG. 15a shows the quality of the inside polymer multilayer portion on flat, uncreased and unfolded panels of the same laminated sample materials as in FIGS. 12 and 14a, as assessed by a Fischer HV5 Poroscope,

FIG. 15b shows the quality of the inside polymer multilayer portion on further flat, uncreased and unfolded panels of the laminated sample materials of FIG. 14b, as assessed by the Fischer HV5 Poroscope,

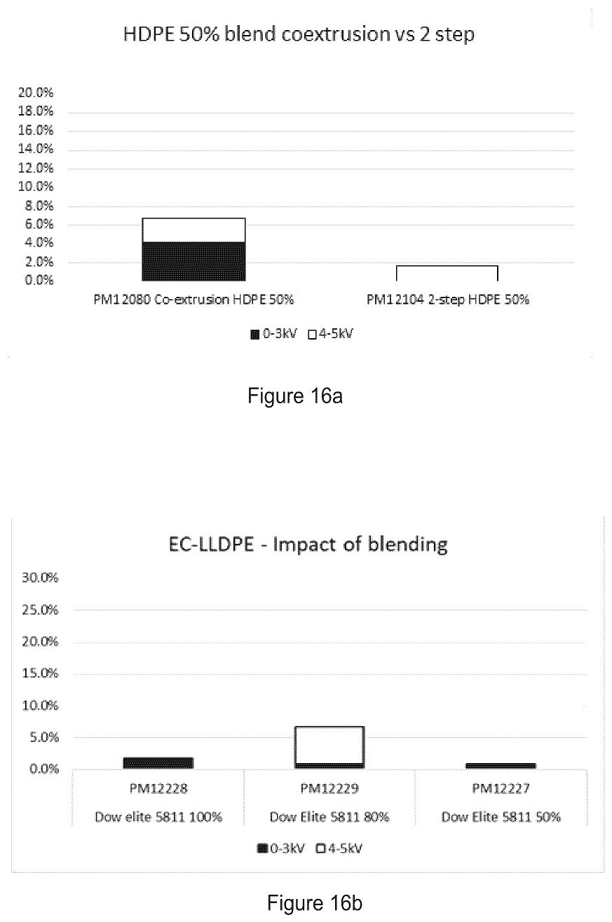

FIGS. 16a and 16b show the quality of the inside polymer multilayer portion on flat, uncreased and unfolded panels of further laminated material samples, as assessed by the Fischer HV5 Poroscope,

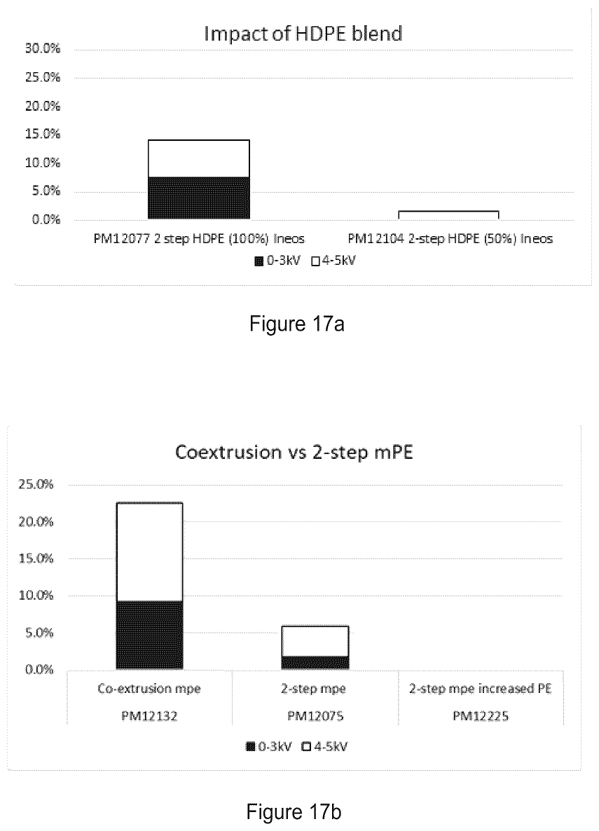

FIGS. 17a and 17b show the quality of the inside polymer multilayer portion on flat, uncreased and unfolded panels of further laminated material samples, including comparative material samples, as assessed by the Fischer HV5 Poroscope, and

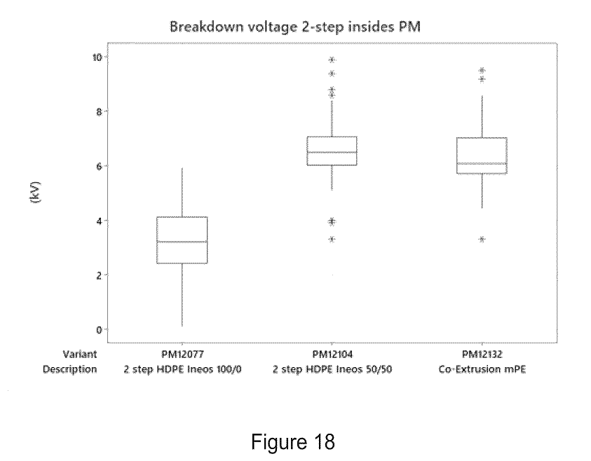

FIG. 18 shows results from studying the quality of the inside polymer multilayer portion after biaxial folding on the same samples as tested in FIG. 13.

### MEASUREMENT METHODS

### OTR Package

The Oxygen transmission rate of packages (filled, emptied and dried) was measured according to ASTM F1307-14, at 0.2 atm (surrounding air containing 21% oxygen). The measurement unit is cm³/package/24h.

The package is mounted on a special holder; inside the package nitrogen is purged; the outside of the package is exposed to the environment surrounding the instrument. When oxygen permeates through the package into the nitrogen carrier gas, it is transported to the coulometric sensor. The sensor reads how much oxygen leaks into the nitrogen gas inside the package.

### OTR on Folding Robustness

OTR on folding robustness is determined herein by cutting the laminated materials to round standardized area samples having a diameter of 104 mm for testing in a PreSens (from Germany) OTR permeation cell, equipped with the sensor type PSt9. The accumulated concentration of permeated oxygen into nitrogen gas was measured by fluorescence over time and plotted as oxygen transmission rate provided in the unit cm³ per sample and 24 hours, after normal conditioning of the samples. Folding of the samples was made in a folding rig, along a machine direction (MD) crease line, outside to outside, to an angle of 165 degrees, for inducing maximal stress, at a determined speed and by mechanized, high-precision repeatable folding, to resemble conditions in a filling machine. Each folding operation stresses the material in exactly the same way, which makes folding experiments and subsequent OTR determinations repeatable and comparable.

All samples were thus measured at 23° C., 50% RH on the test gas side and dry nitrogen on the barrier side. Values were calculated from the slope of an increase in oxygen concentration. The unit for calculated OTR is expressed in cm³/sample and 24 h with 21% Oxygen.

### Straw Puncture Test for Openability

The following test method is used to determine the maximum force needed to puncture or first penetrate the membrane of a laminated straw hole (also referred to as “PPH”, pre-punched hole in the paperboard).

The tested laminated materials were provided during manufacturing and converting operations with pre-cut, laminated straw holes, one per package unit. Thus, the bulk layer of paper or paperboard was pre-cut at intervals to obtain one small hole per package unit, having a diameter of 6 mm, suitable for an opening for a drinking straw. In the subsequent lamination operations, to form the laminates that were tested herein, these straw holes were over-laminated, i.e. covered by all the other layers of the laminate. Within the paperboard hole area, the outermost LDPE layer was adhered to the LDPE intermediate bonding layer to form a laminated membrane together with the barrier layer and innermost layer. A standard compression testing machine (Zwick Roell) was used to evaluate the maximum force required for opening the membrane by penetration with a slant-cut paper straw of diameter about 5 mm.

The test was performed with the tip orientation in both MD and CD, close to the paper board edge of the PPH. MD means that the direction of the inclination of the slant is perpendicular to the machine direction and CD means that the direction of the inclination of the slant is in alignment with the machine direction of the laminated material.

The test was executed on flat laminated material. A pre-load of 0.1 N was used. Speed: 200 mm/min. The PM and the straws were pre-conditioned in 23° C. and 50% RH prior to testing. The paper straws, which had a diameter of 5 mm, were cut to a length of 70 mm.

### “Holiday” Testing on Biaxially Folded Material

The negative effects from further folding was studied and tested based on the principles of ASTM D5162-21. Such testing is generally referred to as “holiday testing”.

The described method in part B of ASTM D5162-21 was adapted for testing on a flexible packaging material composed of thin polymer layers applied on a conductive layer. By exposing the material to increased high voltages from 0 to 20 kV, spots or areas with thinner material or defective polymer coating are indicated as voltage breakthroughs at lower voltage than the surrounding, thicker and fault-free polymer coating material.

The lowest voltage level at which a “breakthrough or “contact” occurred was thus noted and reported for each sample.

Samples of laminated packaging materials were flat folded in a standardised manner (folding rig) first in one direction by 180 degrees, inside towards inside, and then a second time across and in a perpendicular direction to the first fold by 180 degrees, with a consistent geometry. The double-folded area of the packaging material was subsequently studied regarding “thinning” of the polymer layers inside of the metallisation layer, i.e to see whether the polymer inside layers had been weakened, normally by becoming thinner, at potential, sensitive points of the folded area, by the biaxial folding operation.

The method may be used for detecting weaknesses in the inside polymer layers at any area of the packaging material, and in the present method thus at areas where the laminated packaging material has been double-folded.

Thus, to evaluate the remaining thickness of the inside polymer layers, this test method was used, and the voltage at break-through of the polymer layers was related to the polymer thickness that was remaining after bi-axial folding, before the high voltage was applied.

### Flat Panel Polymer Layer Defects

The quality of the polymer layers on the inside of the barrier-coated cellulose-based substrate, i.e. covering the metallization layer, was tested on planar, unfolded material corresponding to wall panels of a fold-formed packaging container, by an instrument referred to as a “poroscope” of the type “Fischer HV5” from Helmut Fischer GmbH, Germany, which is a portable pore test instrument with a roller electrode and continuously adjustable test voltage from 0.8 to 5 kV. The instrument tests the electrical breakthrough resistance of the polymer layers applied onto a metallic barrier layer or coating in a laminated packaging material, at exposure to high voltages between 0.8 and 5 kV, to predict package integrity concerning polymer layer quality. Such polymer layers are positioned on the inside of the metallic layer in a packaging laminate, i.e. towards the direction of the interior of a packaging container formed from the laminated material. At this position, it is important that the layers are of good quality, i.e. have even thickness over the full area of the laminated material at all positions and fulfil a specified minimal thickness. A small defect initiation, in the polymer layers, such as a thinner coated area or point, or a pinhole, may be seen as a potential risk at later stress at exposure to severe conditions, and may be detected according to this method as a voltage breakthrough occuring earlier at the position of the initiation than elsewhere on the laminate. This test is also a modification of the official standard ASTM D5162-21, thus adapted for testing on a planar flexible packaging material. Such testing is may generally be referred to as “holiday testing”. By using the Fischer HV5 instrument and increasing the voltage applied in steps, it will be seen at what lowest voltage level, i.e. earliest “stress level”, the laminated packaging material will show a “breakthrough” or “contact”. The material should be kept at climate conditions holding 0-40° C. and 0-60% RH, to be free from any condensate on the metal surface. The results are reported as the percentage of tested package samples exhibiting a contact at different voltage levels.

Grammages of paper substrates were determined according to the official test method of ISO 536:2019 by the unit g/m², while thickness and density were determined according to ISO 534:2011, by the units μm (m) and kg/m³, respectively.

Thickness measurements of coated polymer layers on paper and in laminate structures may be measured and estimated by taking sliced section samples of the structure and studying them in a SEM microscope. The slicing may be done using e.g. a cryo microtome.

Optical density of a metallization coating is measured in production by means of a densitometer, i.e. an instrument (such as from Macbeth, Tobias or similar), which uses the principle of diffuse light transmission. The instrument is suitable for measuring the optical density values of films coated with aluminium metallization. The accuracy and precision of the measurements is high and about +/−0.2 OD and about +/−0.01 OD, respectively, within a measuring range from 0 to 6.60 OD. In lab measurements, a spectrophotometer may alternatively measure the light transmission over the full visible spectrum (380-800 nm). The optical density is calculated from the light transmission (T, also referred to as I₁/I₀ i.e. ratio of incident light to transmitted light) value at 560 nm, according to a formula OD=−log₁₀ (I₁/I₀) and the values obtained are equally accurate (+/−0.2 OD) and comparable to light transmission densitometer values.

Surface roughness is measured according to ISO 8791-4.

Gurley porosity is measured according to Tappi T460 om-02.

### Experiments

### 1. Heat Resistance

### 1.1 Base-Coated Fibrous Cellulose Substrates (Papers)

The tested base-coated papers were commercial machine-glazed (MG) or machine-finished (MF) papers of similar types, based on, or essentially being made from, bleached Kraft cellulose fibres, further provided with smooth and steam resistant base coatings on the top side.

TABLE 1

| | | | | | | Surface | |
|---|---|---|---|---|---|---|---|
| | | | | | | rough- | |
| Base- | | | | | Density | ness | |
| coated | | | Total | Base | of | ISO | Porosity |
| paper | | Total | thick- | coat | fibrous | 8791-4 | (Gurley |
| sub- | Type of base- | Weight | ness | weight | paper | (μm) | average) |
| strate | coated paper | (g/m2) | (μm) | (g/m²) | (g/cm³) | (PPS) | (s/100 ml) |
| A | Calendered, | 50.2 | 47 | 18.8 | 0.83 | 0.9 | 7348 |
| | one-side | | | | | | |
| | coated, MG | | | | | | |
| | Bleached Kraft | | | | | | |
| | gloss/print | | | | | | |
| | paper | | | | | | |
| B | Calendered, | 50.0 | 48 | 18.7 | 0.79 | 1.0 | 3192 |
| | one-side | | | | | | |
| | coated, MG | | | | | | |
| | Bleached Kraft | | | | | | |
| | print paper | | | | | | |
| C | Calendered, | 48.7 | 47 | 18.2 | 0.79 | 1.2 | 1740 |
| | one-side | | | | | | |
| | coated, MF | | | | | | |
| | gloss paper | | | | | | |
| D | Calendered, | 51.6 | 44 | 21.0 | 0.84 | 0.7 | 11218 |
| | one-side | | | | | | |
| | coated, MG | | | | | | |
| | Bleached Kraft | | | | | | |
| | print paper | | | | | | |
| E | Double one- | 50.9 | 48 | 17.9 | 0.83 | 0.7 | 6778 |
| | side coated, | | | | | | |
| | MG Bleached | | | | | | |
| | Kraft high | | | | | | |
| | gloss paper | | | | | | |
| F | Calendered, | 49.4 | 49 | 18.5 | 0.76 | 1.0 | 6626 |
| | one-side | | | | | | |
| | coated, MG | | | | | | |
| | Bleached Kraft | | | | | | |
| | print paper | | | | | | |
| G (ref.) | Calendered, | 39 | 40 | 0 | 0.98 | 2.5 | 2580 |
| | uncoated, | | | | | | |
| | coatable, high | | | | | | |
| | density paper | | | | | | |

### 1.2 Barrier-Coated, Base-Coated Paper Substrates

Each of the base-coated paper substrates in Table 1, including the un-coated, high-density, reference paper, were coated with barrier coatings according to the following.

Two subsequent coating steps with the same aqueous PVOH dispersion (of Poval™ 6-98 from Kuraray at 10 weight-% of solid matter), were applied onto the top side of the base-coated paper substrates and onto the reference paper substrate, by means of rod coating, each with a subsequent evaporation drying operation at a substrate surface temperature held below 90° C., to provide in each coating step about 2 g/m² of dry weight coating, thus altogether 4 g/m² of PVOH, dry weight.

### 1.3 Laminated Packaging Materials

Each of the PVOH-coated and base-coated paper substrates A-F above were thereafter further laminated to the uncoated, back side of an 80 mN (bending stiffness) clay-coated paperboard of a standard liquid paperboard quality, by means of melt extrusion lamination at 310° C., with about 20 g/m² of an interjacent bonding layer of a conventional low-density polyethylene, LDPE. Both surfaces to be joined were corona-treated just before the lamination. The gas-barrier coated paper substrates were further corona treated and melt extrusion coated on their opposite, barrier-coated, non-laminated side with a conventional LDPE at a grammage of about 35 g/m².

Thus, paperboard-based packaging material laminates were produced to have the following generic structure:

//Outside LDPE 12 g/m² (Ineos 19N730)/Duplex CLC 80 mN, 200 g/m², paperboard bulk layer/LDPE 20 g/m² (Ineos 19N730) bonding layer/paper substrate/steam resistant base-coating/PVOH-coating 2×2 g/m²/LDPE 35 g/m² (Ineos 19N730)//

Lamination of the materials was carried out in a lab-scale laminator. The lamination speed was about 100 m/min.

The Duplex CLC paperboard was a clay-coated paperboard of a conventional type. The barrier-coated side of the paper substrate was directed in the laminated structure towards the inside (corresponding to the inside of a packaging container to be manufactured from the laminated material.

The reference sample was an identically laminated sample, however comprising a PVOH-coated reference paper substrate G, the laminate thus having the following comparable layer structure:

//Outside 12 g/m² LDPE (Ineos 19N730)/Duplex CLC 80 mN, 200 g/m², paperboard bulk/LDPE 20 g/m² (Ineos 19N730) bonding layer/reference paper substrate of high density: 0.98 g/cm³/PVOH-coating 2×2 g/m²/LDPE 35 g/m² (Ineos 19N730)//

The reference paper G has a high density of 980 kg/m³, and has been measured to exhibit an oxygen transmission rate of about 30 cm³/m², 24 h, at 23° C., 0.2 atm, 50% RH, with an Oxtran 2/21 (Mocon) equipment based on coulometric sensors, according to ASTM D3985 and ASTM F1927-14. Reference paper G, as such, thus had some inherent oxygen barrier.

### 1.4 Evaluation Regarding Resistance to Heat Exposure and Steam Expansion.

The obtained laminated packaging material samples comprising the various barrier-coated paper substrates were evaluated regarding steam resistance by exposure to heat in a test rig by application of hot air (temperature setting 350° C.) on the coated inside of the laminate, i.e. towards the layer with 35 g/m² of LDPE, thus representing the inside of the packaging material. The heat applied in a filling machine in the operations of sterilization and/or heat sealing of this innermost LDPE layer is what may cause blistering defects to occur under circumstances with a high humidity in the general climate and environment.

The applied flow of hot air was maintained at 125 l/min, the distance from the nozzle aperture to the surface of the packaging material was 4 mm, and the speed of web of packaging material passing the hot air flow was 425 mm/s. The resulting surface temperature of the heated surfaces was held between 10° and 160° C. Such test conditions ensure that a thermal load is reached, which corresponds to at least the conditions that apply in a filling machine under severe climate conditions.

The results were reported in Table 2 below, as the number of blister defects occurring in the layer representing the inside (35 g/m² LDPE), per cm (i.e. 10 mm, i.e. 0.01 m) length of laminate cross-section, as identified by studying images of the laminate cross-section, taken by X-ray tomography.

TABLE 2

| | | | | Surface | | |
|---|---|---|---|---|---|---|
| | | | | rough- | | No. of |
| | | | Density | ness | | blisters |
| Laminated | | Total | of | ISO | Porosity | per cm, |
| base- | Total | thick- | fibrous | 8791-4 | (Gurley | upon |
| coated | Weight | ness | paper | (PPS) | average) | exposure |
| substrate | (g/m2) | (μm) | (g/cm³) | (μm) | (s/100 ml) | to hot air |
| A | 50.2 | 47 | 0.83 | 0.9 | 7348 | 6 |
| B | 50.0 | 48 | 0.79 | 1.0 | 3192 | 0 |
| C | 48.7 | 47 | 0.79 | 1.2 | 1740 | 3 |
| D | 51.6 | 44 | 0.84 | 0.7 | 11218 | 6 |
| E | 50.9 | 48 | 0.83 | 0.7 | 6778 | 9 |
| F | 49.4 | 49 | 0.76 | 1.0 | 6626 | 0 |
| G | 39.0 | 40 | 0.98 | 2.5 | 2580 | 78 |
| (reference) | | | | | | |

The image taken by X-ray tomography in FIG. 7, shows how the different laminated materials reacted (or not) by blister formation to the hot air exposure. The width/length of the laminate cross-section seen in the image was 3 mm (0.003 m).

The image shows the different sample laminates tested, laid on top of each other. The thicker horizontal white lines are the printable clay-coated surfaces of the bulk paperboard layers, i.e. of the 80 mN Duplex paperboards of the various samples. The thick layers with mixed colours (grey and black) represent the fibrous part of the bulk layer, i.e. the fibrous paperboard, of the various samples. The thinner paper substrate in each laminate sample is seen as a thin layer of a similar mixed colour constitution as the bulk paperboard, i.e. with grey and black granular areas. The two papers are laminated to each other by a rather thin homogeneous grey LDPE layer. The innermost 35 g/m² LDPE layers are seen as relatively thicker homogeneous grey lines turned towards the clay-coat of the bulk paperboard of each next, adjacent sample above.

Counted from above, we see first the reference laminate G from Table 2, after exposure to hot air. Within the drawn circle there are clearly shown many round, blisters of different sizes (counted to 26 in this sample of 3 mm length), formed as dark bubbles within the otherwise homogenous grey, horizontal, innermost layer of 35 g/m² of LDPE.

Next, adjacent and beneath in the image, are seen the sample laminates F, E, D, C and B, in this order. As listed in Table 2, there were no blisters in the grey innermost LDPE layer of samples F and B, and only one blister in sample C per the 3 mm, while there were two blisters in sample laminates A and D, per the 3 mm measurement sample. There were three blisters in sample laminate E, per the 3 mm.

Some blister pockets within the fibrous bulk paperboard layer, or between it and the fibrous paper substrate layer, were seen in sample laminates F, E, and C, while less in sample laminates B and D. The innermost layer of LDPE (uppermost in each laminate) was however not severely damaged in any of the samples of the invention.

As may be seen from Table 2, the number of blisters formed in the respective inside layer per length of studied laminate cross-section, correlates very well to the density of the respective fibrous paper substrate used.

Thus, at a fibrous paper density of above 800 up to 900 kg/m³, there will be on average 7 blisters per cm length of laminate cross-section. At below a density of 800 kg/m³, there will be on average 1 blister per cm length of laminate cross-section. To conclude from plotting the density of the fibrous paper substrate vs the number of blisters formed in a laminate, there is a clear relationship, and it seems that at above the density of 0.80 or 0.85 g/cm³, the numbers of blisters may even increase exponentially with increasing density, as shown in FIGS. 8a and 8b. The correlation coefficient, r², of the plotted curve in FIG. 8a is 0.99, while r² of the plotted curve in FIG. 8b is 0.77.

These results conform well to our theory that any air pockets within the fibrous parts of a laminate need to have an “in-the-plane” escape route upon severe heating, such as in heat sealing operations or sterilization operations in a filling machine, to not violently expand out-of-plane through solid and homogenous material layers of polymers or other non-fibrous materials. In laminates intended to encapsulate oxygen-sensitive goods, or goods sensitive to moisture transport out of or into a package container, it is very important that functional layers of the laminate, i.e. layers providing integrity and barrier properties, can be kept intact throughout the entire, in-the-plane extension of the layers. The fibrous paper substrate layer, which is present in the laminate to provide a substrate to carry barrier coatings, may on the other hand provide an in-the-plane escape route for steam and gas, to a necessary extent. To promote and confine such in-the-plane permeation of steam through and within the boundaries of a thin fibrous layer, such as a paper having relatively low density, it is also necessary to provide a steam resistant base coating or layer directly adjacent the fibrous layer, which is resistant to sudden expansion of air or steam bubbles outside of the fibrous layer, i.e. not allowing air or steam to move into a more sensitive and critical functional layer.

### 2. Oxygen Transmission of Laminated Packaging Materials

A base-coated Kraft-paper, i.e. a Kraft paper coated with a mineral-filled latex (so-called clay-coat) composition, denoted base-coated paper substrate F in Tables 1 and 2 above, (Innerliner Classic 50 g/m² from Sappi) was further coated on its clay-coated side with an aqueous dispersion of PVOH at 0.7 g/m² dry weight (Poval™ 6/98 from Kuraray) in four subsequent coating operations with intermediate drying by forced evaporation of each applied coating layer. The total coated dry weight of PVOH was thus 2.8 g/m². In a subsequent physical vapour deposition (PVD) coating operation, the PVOH-coated substrate was further metallized onto the PVOH surface to an optical density (OD) of about 3.5.

The coated paper was then laminated to the backside of an 80 mN clay-coated Duplex conventional liquid paperboard by melt extrusion lamination with an interjacent layer of 15 g/m² LDPE.

The paperboard was extrusion coated on its opposite, outer side with 12 g/m² LDPE. Finally, the barrier-coated side of the paper laminate was further laminated on the inside to a pre-manufactured film of LLDPE by means of melt co-extrusion lamination with interjacent bonding layers of an ethylene acrylic acid copolymer, EAA (6 g/m²) and LDPE (15 g/m²). The final structure of the formed laminate was thus:

//Outside 12 g/m² LDPE/Duplex CLC paperboard bulk 80 mN, 200 g/m², layer/LDPE 15 g/m²/low-density fibrous paper substrate/steam resistant base coat of about 18.5 g/m² clay-coat/PVOH gas barrier coatings 4×0.7 g/m²/metallization coating having OD 3.5/EAA 6 g/m²/LDPE 15 g/m²/LLDPE pre-manufactured film 18 μm//

The thus obtained laminated packaging material was tested for oxygen transmission rate (OTR) before and after folding and was compared to a reference laminate, i.e. having an identical laminate structure except by the paper substrate instead being the reference paper G, which has a density of 0.98 g/cm³ and is without a steam resistant base coating. Furthermore, the total coat weight of PVOH and the metallization optical density of the reference laminate was slightly lower, i.e. having about 1.6 g/m² of PVOH and a metallization coating OD of about 2. The inherent OTR capability of the reference paper G has previously been determined to about 30 cm³/m²*24 h*0.2 atm 23° C., 50% RH (with Oxtran 2/21 (Mocon) according to ASTM F1927-14), when laminated to a layer of LDPE. Thus, the reference laminated structure was:

//Outside 12 g/m² LDPE/Duplex CLC paperboard bulk 80 mN, 200 g/m², layer/LDPE 15 g/m²/reference paper (G)/PVOH gas barrier coatings 2×0.8 g/m²/metallization OD~2.0/EAA 6 g/m²/LDPE 15 g/m²/LLDPE pre-manufactured film 18 μm//

The sample laminates were cut to round standardized area samples having a diameter of 104 mm for testing in a PreSens (from Germany) OTR permeation cell, equipped with the sensor type PSt9. The accumulated concentration of permeated oxygen into nitrogen gas was measured by fluorescence over time and plotted as oxygen transmission rate provided in the unit cm³ per sample and 24 hours, without the need for extensive conditioning of the samples. Folding of the samples was made in a folding rig, along a machine direction (MD) crease line, outside to outside, to an angle of 165 degrees, for inducing maximal stress, at a determined speed and by mechanized, high-precision repeatable folding, to resemble conditions in a filling machine. Each folding operation stresses the material in exact the same way, which makes folding experiments and subsequent OTR measurements repeatable and comparable.

All samples were thus determined at 23° C., 50% RH on the test gas side and dry nitrogen on the barrier side.

Values were calculated from the slope of an increase in oxygen concentration.

The unit for calculated OTR is expressed as cm³/sample, 24 h, 21% Oxygen.

| | OTR through the planar laminate | | | |
|---|---|---|---|---|
| | samples were measured as cm³/ specimen | | | |
| | sample, 24 h, at 0.2 atm oxygen, at 23° C. and | | | |
| | 50% relative humidity | | | |
| Laminate sample | Unfolded | 1 × folded | 2 × folded | 4 × folded |
| Reference barrier | 0.00072 | 0.00193 | 0.00292 | 0.00302 |
| laminate having the | | | | |
| reference high- | | | | |
| density paper | | | | |
| substrate G | | | | |
| Inventive barrier | 0.00096 | 0.00123 | 0.00198 | 0.00259 |
| laminate having the | | | | |
| low-density paper | | | | |
| substrate F with a | | | | |
| steam resistant base | | | | |
| coating | | | | |

From the thus comparable OTR measurements, it can be concluded that the inventive and reference laminate structures provided similar oxygen barrier properties, both in the planar un-folded state and in laminated samples having been folded one or a few times and thus exerted to mechanical stress. The oxygen barrier materials (PVOH dispersion coating and PVD metallization coatings) were applied in slightly lower amounts in the reference sample, while on the other hand its high-density paper substrate (0.97 g/cm³) contributed with some inherent oxygen barrier property. The generally lower OTR values of the inventive barrier laminate may thus partly be conferred to the higher amounts of applied barrier materials. The results from folding the inventive barrier laminate example show, however, that even if a low-density paper substrate (0.76 g/cm³) is used, the oxygen transmission rate does not dramatically increase upon folding several times. Thus, it seems that the inventive barrier laminate can reach the same level of oxygen barrier if compensated with somewhat more barrier coating and has at least a similar capability of maintaining gas barrier properties to at least the same level of gas barrier after fold forming, in comparison to the reference barrier laminate.

The reference barrier laminate had previously been developed to maintain barrier properties upon fold-forming thanks to it using a high-density paper substrate for the barrier coatings.

Further, relating to the attached figures:

In FIG. 1a, there is shown, in cross-section, an embodiment of a barrier-coated cellulose-based fibrous substrate 10a, of the invention. The fibrous cellulose substrate 11 is a paper made from a major proportion of cellulose fibers from Kraft pulp, having a grammage of 35 g/m², and a density below 800 g/m², first provided with a steam-resistant base coating 12 on its top side, by applying a fine pigment coating by means of a relatively high-viscosity aqueous dispersion coating and subsequent drying to evaporate the water. The dry weight of the applied steam-resistant base coating is about 18 g/m². In a subsequent step, the applied and dried pigment coating was smoothened in a soft calendering operation.

Further, the base-coated paper substrate has a gas barrier coating 13 made from a barrier dispersion or solution coating of PVOH, Poval® 6-98 from Kuraray, applied onto the surface of the steam-resistant base coating 12. The gas barrier coating 13 is thus applied by means of a low solid-content and relatively low-viscosity aqueous dispersion coating, and subsequently dried to evaporate the water, preferably as two consecutive part-coating steps with drying in between the wet coating steps and after the second coating step. The total dry weight of the PVOH barrier dispersion coating is about 3 g/m².

FIG. 1b shows, in cross-section, a further embodiment of a barrier-coated cellulose-based fibrous substrate 10b, of the invention. The same paper is used as the cellulose-based substrate 11, which is coated with a same steam-resistant base coating 12 of the same composition as used in FIG. 1a, at a dry weight amount of about 18 g/m². Further, the base-coated paper substrate has a same first gas barrier coating 13 made from a barrier dispersion or solution coating of PVOH, Poval® 6-98 from Kuraray, applied onto the surface of the steam-resistant base coating 12. The first gas barrier coating 13 is thus applied by means of aqueous dispersion coating and subsequently dried to evaporate the water, preferably as two consecutive part-coating steps with drying in between coatings and after the second coating. The total dry weight of the PVOH barrier dispersion coating is about 3 g/m².

The thus barrier dispersion-coated paper substrate has a further barrier coating aluminium barrier deposition coating 14, i.e. an aluminium-metallised layer, applied by physical vapour deposition to an OD of about 2, onto the dried surface of the first gas barrier dispersion coating 13.

FIG. 1c shows in cross-section an embodiment in which the barrier-coated paper substrate of FIG. 1b is further made into a simple laminated packaging material, by firstly coating the uncoated side of the paper substrate with a first, outermost protective coating 15, preferably a thermoplastic polymer, such as a polyolefin to provide also liquid-tightness and heat sealability properties, the coating 15 thus to form the outside of a packaging container made from the simple laminated packaging material. Secondly, a second innermost heat sealable material layer 16 is laminated to the free, uncoated side of the vapour deposited metallization layer 14 to form the layer covering the inside of a packaging container made from the laminated material. The outermost and innermost layers 15, 16 may be of the same material, preferably they are polyolefins and most preferably thin layers of polyethylene. Advantageously, the first outermost layer may be a single layer of LDPE, while the second, innermost layer may be a blend of LDPE with mLLDPE to provide strong and tight seals of a heat sealed packaging container, wherein the second innermost layer has been heat sealed to itself.

In FIG. 2a, a laminated packaging material 20a for liquid carton packages of portion pack format (such as to contain from 200 to 300 ml) is shown, in which the laminated material comprises a paperboard bulk layer 21a of paperboard, having a bending force of 80 mN and a grammage weight of about 200 g/m², and further comprising an outer liquid tight and heat sealable layer 22a of low density polyethylene applied on the outside of the bulk layer 21a, which side is to be directed towards the outside of a packaging container produced from the packaging laminate. The layer 22a is transparent to show the printed décor pattern 27a, applied onto the bulk layer of paper or paperboard, to the outside, thus informing about the contents of the package, the packaging brand and other information targeting consumers in retail facilities and food shops. The polyethylene of the outer layer 22a is a conventional low density polyethylene (LDPE) of a heat sealable quality, but could also include further similar polymers, including LLDPEs. It is applied at an amount of about 12 g/m². An innermost liquid tight and heat sealable layer 23a is arranged on the opposite side of the bulk layer 21a, which is to be directed towards the inside of a packaging container produced from the packaging laminate, i.e. the layer 23a will be in direct contact with the packaged product. The thus innermost heat sealable layer 23a, which is to form strong transversal heat seals of a liquid packaging container made from the laminated packaging material, comprises one or more in combination of polyethylenes selected from the groups consisting of LDPE, linear low density polyethylene (LLDPE), and LLDPE produced by polymerising an ethylene monomer with a C4-C8, more preferably a C6-C8, alpha-olefin alkylene monomer in the presence of a metallocene catalyst, i.e. a so called metallocene-LLDPE (m-LLDPE). This innermost layer of polyethylenes is applied at an amount of about 29 g/m². Alternatively, the innermost liquid tight and heat sealable layer 23a′ may be a pre-manufactured LLDPE-based film.

The bulk layer 21a is laminated to the uncoated side (i.e. having no gas barrier coating applied) of the barrier-coated paper substrate 10b, from FIG. 1b, i.e. 25a, having also an aluminium barrier deposition coating 14, i.e. an aluminium-metallised layer, applied onto the dried surface of the barrier dispersion coating 13, by physical vapour deposition to an OD of about 2, by an intermediate bonding layer 26a of a low density polyethylene (LDPE). The intermediate bonding layer 26a is formed by means of melt extruding it as a thin polymer melt curtain between the two paper webs and thus laminating the bulk layer and the barrier-coated paper substrate to each other, as all three layers pass through a cooled press roller nip. The amount applied of the intermediate bonding layer 26a may be from 15 to 20 g/m².

The innermost heat sealable layer 23a may consist of one layer or alternatively of two or more part-layers of the same or different kinds of LDPE or LLDPE or blends thereof, and is well adhered to the metallised barrier deposition coating surface 14 of the barrier-coated paper substrate 10b, by an intermediate coextruded tie layer 24a at an amount of about 6 g/m², e.g. of ethylene acrylic acid copolymer (EAA), which thus bonds the innermost heat sealable layer(s) to the barrier coated paper substrate 10b, by applying the layers together in one single melt coextrusion coating step of layers 24a and 23a.

In FIG. 2b, a different laminated packaging material 20b, for liquid carton packaging, is shown, in which the laminated material comprises a same paperboard core layer 21b as used in FIG. 2a (21a), having a bending force of 80 mN and a grammage weight of about 200 g/m², and further comprises an outer liquid tight and heat sealable layer 22b of LDPE applied on the outside of the bulk layer 21b, as described in FIG. 2a. Furthermore, a similar innermost liquid tight and heat sealable layer 23b is arranged on the opposite side of the bulk layer 21b, as described above in FIG. 2a, together with an intermediate coextruded tie layer 24a at an amount of about 6 g/m², e.g. of ethylene acrylic acid copolymer (EAA).

The bulk layer 21b is laminated to the barrier-coated paper substrate 10b described in FIG. 1b; 25b (same as 25a in FIG. 2a) by means of wet lamination with an intermediate bonding layer 26b of a thin layer of adhesive polymer, obtained by applying an aqueous dispersion of a polyvinyl acetate adhesive, or a starch adhesive, onto one of the surfaces to be adhered to each other and subsequently pressing together in a roller nip. This lamination step is thus performed in an efficient cold or ambient lamination step at industrial speed without any energy-consuming drying operation needed to accelerate the evaporation of the water. The dry amount applied of the intermediate bonding layer 26b is from 3 to 5 g/m² only, which entails that there is no need for drying and evaporation of the bonding layer. Accordingly it is possible to reduce the amount of the thermoplastic polymer fraction in recycling processes, such as relatively thicker extrusion laminated polyethylene polymers, and to improve repulpability of the packaging material in recycling processes. The lamination layer 26b, which is bonding the barrier-coated cellulose-based fibrous substrate 25b to the bulk layer 21b, may thus instead be a thin layer of a wet laminated polymer binder, obtained from drying of a dispersion-coated aqueous adhesive composition. Such a bonding layer would be made from a polymer which is readily re-dispersible in water such that it is repulpable into the fraction of cellulose fibres in a carton fibre recycling process.

Thus, the amount of thermoplastic polymer can be significantly reduced in this lamination layer, in comparison to the conventional melt extrusion laminated bonding layer of LDPE, described in FIG. 2a.

In yet further embodiments of either the laminated structure of FIG. 2a (not shown), or the laminated structure of FIG. 2b (shown), the innermost liquid-tight layer 23a′ or 23b′ may consist of a pre-manufactured polyolefin film, comprising LDPE or LLDPE polymers in any blends thereof, and it may be laminated to the barrier-coated paper substrate, to the surface of its barrier deposition coating, i.e. the aluminium metallisation, by means of an intermediate, melt extrusion laminated bonding layer 24a′ or 24b′, comprising a thicker tie layer of EAA than used in FIG. 2a or 2b, and/or a more simple bonding layer of LDPE, which is from 12 to 20 g/m², such as from 12 to 18 g/m², thick.

FIG. 2c shows how, alternatively, a bulk layer 21c may be laminated to the uncoated side (i.e. having no gas barrier coating applied) of a barrier-coated paper substrate 10a, from FIG. 1a, i.e. 25c, which does not have a further vapour deposited barrier coating 14 of aluminium metallisation, by the same methods as described above in FIGS. 2a and 2b. Such a gas-barrier-coated paper, not further coated with a vapour deposited water-vapour barrier layer, may in a laminated packaging material instead be complemented by laminating the barrier-coated paper on its inner side to a pre-manufactured polymer film 28c, comprising a substrate layer 28a and vapour deposited gas barrier coating 28b. Thus, the laminated packaging material 20c has the same layers, being of the same type as the corresponding layers of FIG. 2a or FIG. 2b described above, regarding a bulk layer 21c of paperboard, an outermost, protective polymer layer 22c and an interior lamination layer 26c, which may be either a wet, aqueous dispersion applied adhesive layer or a melt extrusion laminated bonding layer of a thermoplastic polymer.

The pre-manufactured polymer film 28c comprises a polymer film substrate 28a and a vapour deposition coating of aluminium metallisation and/or aluminium oxide 28b. The thus pre-manufactured vapour deposition coated film 28c is laminated to the gas-barrier-coated cellulose-based substrate 25c by means of an intermediate bonding layer 29c, such as a melt extrusion laminated layer. The pre-manufactured polymer film may further comprise heat sealable layers 23c, 24c for the innermost side of the laminated material 20c. Alternatively, after laminating a pre-manufactured film 28c to the paperboard, further inside layers 23c, 24c may be melt co-extrusion coated onto the inside of the pre-manufactured film 28c.

This is thus an alternative way of providing a metallized coating or a vapour deposition coating on the inside of the first gas barrier coating, to protect the latter from moisture and the migration of water vapour from a liquid or wet filled food product.

FIG. 2d shows shows a further laminated packaging material 20d for liquid carton packages of portion pack format (such as to contain from 200 to 400 ml), in which the laminated material comprises a bulk layer 21d of paperboard, having a bending force of 80 mN and a grammage weight of about 200 g/m², and further comprising an outer liquid tight and heat sealable layer 22d of low density polyethylene applied on the outside of the bulk layer 21d, which side is to be directed towards the outside of a packaging container produced from the packaging laminate. The layer 22d is transparent to show the printed décor pattern 27d, applied onto the bulk layer of paper or paperboard, to the outside, thus informing about the contents of the package, the packaging brand and other information targeting consumers in retail facilities and food shops. The polyethylene of the outer layer 22d is a conventional low-density polyethylene (LDPE) of a heat sealable quality, but could also include further similar polymers, including LLDPE polymers. It is applied at an amount of about 12 g/m².

An innermost liquid tight and heat sealable layer 23d is arranged on the opposite side of the bulk layer 21d, which is to be directed towards the inside of a packaging container produced from the packaging laminate, i.e. the layer 23d will be in direct contact with the packaged product. The thus innermost heat sealable layer 23d, which is to form strong transversal heat seals of a liquid packaging container made from the laminated packaging material, comprises one or more in combination of polyethylenes selected from LDPE, and LLDPE produced by polymerising an ethylene monomer with a C4-C8, more preferably a C6-C8, alpha-olefin alkylene monomer in the presence of a metallocene catalyst, i.e. a so called metallocene-LLDPE (m-LLDPE).

The bulk layer 21d is laminated to the uncoated side (i.e. having no gas barrier coating applied) of a thin, barrier-coated, fibrous paper substrate 25d being the same as the paper substrates of FIG. 1b, by an intermediate bonding layer 26d of a low density polyethylene (LDPE). The barrier-coated paper substrate has a dispersion-coated, first oxygen barrier layer 13d of PVOH of about 2.0 g/m² applied onto the opposite, inner side of the paper substrate 11d, and an aluminium barrier deposition coating 14d, i.e. an aluminium-metallized layer, applied onto the dried surface the oxygen barrier layer 13d, by physical vapour deposition to an OD of about 2. The paper substrate has a first steam-resistant base coating 12d applied by means of dispersion coating before and to be positioned beneath the first gas barrier layer or coating. The steam-resistant base coating is a smoothening coating of a clay-coat, i.e. a thick aqueous composition of a latex binder and rather high content of filler mineral particles, typically CaCO3 and/or kaolin clay. The intermediate bonding layer 26d of LDPE is formed by means of melt extruding it in the form of a thin polymer melt curtain between the two paper webs and thus laminating the bulk layer and the barrier-coated paper substrate to each other, as all three layers pass through a cooled press roller nip. The amount applied of the intermediate bonding layer 26d may be from 10 to 20 g/m², such as from 10 to 15 g/m².

The thus barrier-coated, fibrous paper substrate is covered on its inner, coated side with an inside polymer multilayer portion 29d.

The inside polymer multilayer portion has three layers of different polymers, i.e. an innermost heat sealable layer 23d comprising in this example a blend of 70 weight-% mLLDPE and 30 weight-% LDPE, a tie layer 24d, applied onto the metallized surface of the barrier-coated paper at an amount of about 6 g/m², e.g. of ethylene acrylic acid copolymer (EAA), to promote adhesion of the inside multilayer layer portion to the barrier-coated paper substrate, and an interjacent load-bearing layer 28d of HDPE or MDPE, a blend of HDPE or MDPE with LDPE, or an LLDPE having a melt flow ratio, MFR, from 4 to 20 g/10 min (190° C./2.16 kg) and a melting temperature above 115° C., applied between the tie layer 24d and the innermost heat sealable layer 23d. The three layers 24d, 28d and 23d, are applied together in one single, melt coextrusion coating operation.

In a preferred embodiment, the three layers 24d, 28d and 23d are applied in two melt extrusion coating operations, i.e. a first step involving melt coextrusion of layers 24d and 28d, such that the applied layers are solidified in the pressure lamination roller nip, and a second step involving melt extrusion coating of the innermost layer 23d onto the solidified layers 24d and 28d.

In a preferred embodiment of this laminate structure, the intermediate load-bearing layer 28d is a blend of HDPE and LDPE at a weight ratio of 50:50. Such configuration of the inside polymer multilayer portion 29d provides a surprising improvement of a strong load-bearing effect and high durability and robustness upon fold forming of the laminated packaging material.

In a further, preferred embodiment, the bulk layer 21d is laminated to the uncoated side of the thin, barrier-coated, fibrous paper substrate 25d, by an intermediate bonding layer 26d-1 of an aqueous adhesive composition of a starch-based adhesive at from 2-7 g/m², solid, dry matter.

In yet a further embodiment, combinable with any one of the previous embodiments, the outer liquid tight and heat sealable layer 22a;22b;22c;22d is applied in the form of an aqueous dispersion coating of an acrylic-functional or acrylic acid-functional, polyolefin-based polymer, at a dry matter content from 6 to 8 g/m².

In FIG. 3a, an embodiment of a principal process of aqueous dispersion coating 30a is shown, which may be used for applying a first gas barrier coating 13 from an aqueous oxygen gas barrier composition onto a paper substrate, or for applying a steam-resistant base coating 12 (however requiring different equipment and settings). Alternatively, it may be used for applying an aqueous adhesive composition for wet laminating two webs together, of which at least one web has a fibrous cellulose surface.

A web of paper substrate 31a (e.g. the paper 11 from FIG. 1a, 1b, 1c, is thus forwarded to a dispersion coating station 32a, where an aqueous dispersion composition is applied by means of rollers onto the top surface of the substrate. The aqueous dispersion composition may have an aqueous content of from 80 to 99 weight-%, in the case of gas barrier compositions, thus there may be a lot of water on the wet coated substrate that needs to be dried by heat, and evaporated off, to form a continuous coating, which is homogenous and has an even quality with respect to barrier properties and surface properties, i.e. evenness and wettability. The drying is carried out by a hot air dryer 33a, which also allows the moisture to evaporate and be removed from the surface of the substrate. The substrate temperature as it travels through the dryer, may be kept constant at a temperature of below 100° C., such as below 90° C., such as from 70 to 90° C., in order to avoid defects in the coating. Drying may be partly assisted by irradiation heat from infrared IR-lamps, in combination with hot air convection drying.

For the coating of the steam-resistant base coating, however, the aqueous content is much lower and then also the extent of drying will be different. A resulting web of a steam-resistant, base-coated paper substrate 34a may be smoothened by passing through a soft calender nip and is then forwarded to cool off and further wound onto a reel for intermediate storage and later further subjected to gas barrier coating operations. Further coating operations may thus be further dispersion coating operations of a gas barrier composition to provide a barrier-coated cellulose-based fibrous substrate, and/or vapour deposition coating of a barrier deposition coating 14 as described above.

FIG. 3b shows a principal process for laminating two pre-made material webs to each other by means of melt extrusion lamination, e.g. for laminating the respective bulk layer 21(a, c, d) to the respective barrier-coated cellulose-based, fibrous substrate 25(a, c, d) of FIGS. 2a, 2c and 2d, respectively.

In a first step, the bulk layer 21 is laminated to the barrier-coated paper substrate 25 by an intermediate bonding layer 26 of LDPE. The intermediate bonding layer 26 is formed by melt extrusion of a thin polymer melt curtain 26 from a die 32b between the webs comprising the bulk layer 11 and the barrier-coated paper substrate 25, respectively, and thus laminating these three layers to each other, as they pass through a nip 32c between a press roller and a chilled roller, cooling the laminated material 24 to properly solidify the extruded intermediate bonding layer 26 of LDPE. The lamination temperature is about 300° C.

The resulting pre-laminate 35 is forwarded to be wound up on a reel for intermediate storage, or directly to subsequent lamination operations.

FIG. 3c shows a process 30c for the final lamination steps in the manufacturing of the packaging laminate 20a, 20b, 20c or 20d, of FIGS. 2a, 2b, 2c and 2d, respectively, after that the respective bulk layer 21a, 21b, 21c, 21d has first been laminated to the barrier-coated cellulose-based fibrous substrate 10a or 10b of FIG. 1a or FIG. 1b, (i.e. 25a, 25b, 25c or 25d of FIGS. 2a, 2b, 2c and 2d respectively).

As explained in connection to FIGS. 2b, 2c and 2d, the bulk layer paperboard 21b; 21c; 21d may be laminated to the barrier-coated paper substrate 10a; 10b; 25b; 25c; 25d by means of wet, cold dispersion adhesive lamination, or by means of melt extrusion lamination. The wet, dispersion-coated adhesive 26b; 26c; 26d-1 may be applied by means of a same or similar method as described in connection to FIG. 3a, however not requiring drying, or very little heating.

Lamination of the bulk layer 21d to the barrier-coated cellulose-based, fibrous substrate 25d in FIG. 2d, may thus be performed, either by extrusion lamination of an intermediate thermoplastic bonding layer being LDPE, as shown in FIG. 3b, or by wet dispersion lamination of an aqueous adhesive composition 26d-1, as shown in FIG. 3a, however to be absorbed into the adjacent cellulose surfaces, i.e. without the drying step 33a, during lamination in a pressure roller lamination nip as shown in FIG. 3b, however without the melt extrusion operation 32b.

FIG. 3c shows how the resulting paperboard pre-laminated web 35; 31b is then forwarded from an intermediate storage reel, or directly from the lamination station for laminating the paper pre-laminate. The non-laminated side of the bulk layer 21a; 21b; 21c; 21d, i.e. its print side, is joined at a cooled roller nip 33c to a molten polymer curtain 33d of the LDPE, which is to form the outermost layer 22a; 22b; 22c; 22d of the laminated material, the LDPE being extruded from an extruder feedblock and die 33b. Subsequently, the paperboard pre-laminated web, now having the outermost layer 22a;22b;22c; 22d coated on its outer or printed side, i.e. the outside, passes a second extruder feedblock and die 34b and a lamination nip 34c, where a molten polymer curtain 34d is joined and coated onto the other side of the pre-laminate, i.e. on the inner side, i.e. the barrier-coated side of the paper substrate 10a; 10b; 25a;25b;25c; 25d. Thus, the innermost heat sealable layer(s) 23a; 23b; 23c; 24c are coextrusion coated together with further inside polymer layers (e.g. adhesive layers 24a; 24b; 24b′; 24c; 24d) onto the inner side of the paperboard pre-laminate web, to form the finished laminated packaging material 36, which is finally wound onto a storage reel, not shown. Similar extrusion-coating operations are performed to provide the laminated packaging material as described in FIG. 2d.

In a preferred embodiment, as described in FIG. 2d, the three layers 24d, 28d and 23d, are applied in two steps of melt extrusion coating, i.e. the first step comprising the tie layer 24d and the load-bearing layer 28d applied by co-extrusion coating in a first extrusion coating lamination station, and the second step comprising extrusion coating the innermost heat sealable layer 23d in a second extrusion coating lamination station. This means that the molten extrusion-coated polymer film solidifies by the contact with the substrate web on one side and with the cooling roller on the other side, in a lamination roller nip, after each extrusion-coating step, such that at least the inner surface of the intermediate, load-bearing layer 28d is solidified at the surface and interface towards and before the innermost layer 23d is applied.

The two coextrusion steps at lamination roller nips 33c and 34c, may alternatively be performed as two consecutive steps in the opposite order.

According to another embodiment, one or both of the outermost layers may instead be applied in a pre-lamination station, where the extrusion coated layer(s) is first applied to the outside of the (printed) bulk paperboard layer or onto the metallisation coating of the barrier-coated paper substrate, and thereafter the two pre-laminated paper webs may be joined to each other, as described above.

According to a further embodiment, the innermost layers of the heat sealable and liquid-tight thermoplastic layers are applied in the form of a pre-manufactured film, which is laminated to the coated side of the barrier-coated paper substrate 10a; 10b; 10c.

FIG. 4a is a diagrammatic view of an example of a plant 40a for physical vapour deposition, PVD, of e.g. an aluminium metal coating, onto a web substrate of the invention. The base-coated and first gas-barrier coated, i.e. dispersion-coated paper substrate 41 is subjected, on its coated side, to continuous evaporation deposition 40, of evaporated aluminium, to form a metallised layer of aluminium or, alternatively to a mixture of oxygen with aluminium vapour, to form a deposited coating of aluminium oxide. The coating is provided at a thickness from 5 to 100 nm, preferably from 10 to 50 nm, to form the barrier-coated paper 43 of the invention (or a barrier-coated polymer film substrate 28a, as employed in the laminated packaging material of FIG. 2c. The aluminium vapour is formed from ion bombardment of an evaporation source of a solid piece of aluminium 42. For the coating of Aluminium oxide, also some oxygen gas may be injected into the plasma chamber via inlet ports.

FIG. 4b is a diagrammatic view of an example of a plant 40b for plasma enhanced chemical vapour deposition coating, PECVD, of e.g. hydrogenated amorphous diamond-like carbon coatings onto a web substrate of the invention. The web substrate 44a is subjected, on one of its surfaces, to continuous PECVD, of a plasma, in a plasma reaction zone 45 created in the space between magnetron electrodes 46, and a chilled web-transporting drum 47, which is also acting as an electrode, while the substrate is forwarded by the rotating drum, through the plasma reaction zone along the circumferential surface of the drum, and subsequently wound onto a roller as a barrier-coated web substrate 44b. The plasma for deposition coating of an amorphous DLC coating layer may for example be created from injecting a gas precursor composition comprising an organic hydrocarbon gas, such as acetylene or methane, into the plasma reaction chamber. Other gas barrier coatings may be applied by the same principal PECVD method, such as silicon oxide coatings, SiOx, then starting from a precursor gas of an organosilicon compound. The PECVD plasma chamber is kept at vacuum conditions by continuously evacuating the chamber at outlet ports 48a and 48b.

FIG. 5a shows an example of a packaging container 50a produced from the packaging laminate of the present invention. The packaging container is particularly suitable for beverages, sauces, soups or the like. Typically, such a package has a volume of about 100 to 1000 ml. It may be of any configuration, but is preferably brick-shaped, having longitudinal and transversal seals 51a and 52a, respectively, and optionally an opening device 53. In another embodiment, not shown, the packaging container may be shaped as a wedge. In order to obtain such a “wedge-shape”, only the bottom part of the package is fold formed such that the transversal heat seal of the bottom is hidden under the triangular corner flaps, which are folded and sealed against the bottom of the package. The top section transversal seal is left unfolded. In this way the only partly folded packaging container is still easy to handle and dimensionally stable enough to put on a shelf in the food store or on any flat surface.

FIG. 5b shows an alternative example of a packaging container 50b produced from an alternative packaging laminate of the invention. The alternative packaging laminate is thinner by having a thinner paper bulk layer, and thus it is not dimensionally stable enough to form a parallelepipedal or wedge-shaped packaging container and is not fold formed after transversal sealing 52b. The packaging container will remain a pillow-shaped pouch-like container and be distributed and sold in this form.

FIG. 5c shows a gable top package 50c, which is fold-formed from a pre-cut sheet or blank, from the laminated packaging material comprising a bulk layer of paperboard and the barrier-coated paper substrate of the invention. Also flat top packages may be formed from similar blanks of material.

FIG. 5d shows a bottle-like package 50d, which is a combination of a sleeve 54 formed from a pre-cut blank of the laminated packaging material, and a top 55, which is formed by injection moulding plastics in combination with an opening device such as a screw cork or the like. This type of packages is for example marketed under the trade names of Tetra Top® and Tetra Evero®. Those particular packages are formed by attaching the moulded top 55 with an opening device attached in a closed position, to a tubular sleeve 54 of the laminated packaging material, sterilizing the thus formed bottle-top capsule, filling it with the food product and finally fold-forming the bottom of the package and sealing it.

FIG. 6 shows the principle as described in the introduction of the present application, i.e. a web of packaging material is formed into a tube 61 by overlapping the longitudinal edges 62, 62′ of the web and heat sealing them to one another, to thus form an overlap joint 63. The tube is continuously filled 64 with the liquid food product to be filled and is divided into individual, filled packages by repeated, double transversal seals 65 of the tube at a pre-determined distance from one another below the level of the filled contents in the tube. The packages 66 are separated by cutting between the double transversal seals (top seal and bottom seal) and are finally shaped into the desired geometric configuration by fold formation along prepared crease lines in the material.

FIG. 7 shows an image taken by X-ray tomography of the cross-section of a stack of laminated packaging materials, comprising a reference material, G, and a series of inventive laminated packaging materials. The number of steam blisters in the inside polymer layers of a laminated packaging material dramatically increases with the density of the paper substrate layer. The outer side of the respective laminates are seen for the white clay-coat, while the adjacently stacked layers (to the white clay-coat layers), being homogeneously grey, are the inside polyethylene-based layers taken together. As can be seen, there are several, big blisters in the reference material G, which is a laminate sample having a high-density paper with a density of the fibrous cellulose fraction of about 980 kg/m³.

FIG. 8a shows how the number of blisters formed by moisture-containing air in the fibrous paper substrate relates in an exponentially increasing manner to the increasing density of the fibrous part of the paper substrate, over the full range from 700 to 1000 kg/m³, when tested under the same conditions.

FIG. 8b shows how the number of blisters formed by moisture-containing air in the fibrous paper substrate relates to the density of the fibrous part of the paper substrate, over the lower part of the range of densities, i.e. from 700 to 850 kg/m³. This relationship may be more linearly increasing.

The following advantages can accordingly be achieved by employing the barrier-coated cellulose-based fibrous substrates of the present disclosure in a laminated packaging material:

A fibrous, and thereby also porous, part of the cellulose-based fibrous substrate, enables proper transport of sudden bursts of steam or humid air away from heated zones of the fibrous part within the plane of the fibrous substrate.

A steam-resistant base coating, being a base coating filled with inorganic particles or fillers ensures that any sudden bursts of steam or humid air may be confined to the fibrous part of the substrate layer and will thus not erupt through the steam-resistant base coating. In this way, the steam-resistant base coating ensures that so-called “blistering” will not destroy the further polymer layers on the inside of the steam-resistant base coating. Such further gas barrier and polymer inside layers and coatings must remain intact to ensure the integrity and food safety of a packaging container, formed and heat sealed from the laminated packaging material.

The use of a fibrous and thereby porous part of a cellulose-based substrate may be combined with such a steam-resistant base coating to provide a good foundation and substrate for further thin and sensitive gas barrier coatings, such that they will be able to maintain their gas barrier properties also upon fold forming, as measured by comparative folding robustness OTR measurements. This was unexpected, because a higher density of the fibrous part of the substrate has previously been concluded to be necessary for an improved performance in fold-formed packaging containers. Thus, more expensive high-density paper substrates, which inherently provide oxygen barrier properties to significant level when laminated, may not be necessary for this purpose.

The initial oxygen barrier properties provided by such gas barrier coatings, i.e. the oxygen barrier as measured by OTR test methods on flat samples of laminated packaging materials comprising the barrier-coated cellulose-based fibrous substrate, may be improved thanks to the ability of the flexible and steam-resistant base coating comprising the inorganic particles, of being smoothened and densified, to provide a substrate surface with low porosity and low surface roughness, thus enabling efficient gas barrier coatings, although thinly applied and despite being inherently sensitive to mechanical abuse.

Further experiments regarding a preferred embodiment of the heat-sealable laminated packaging material:

### Experiment 3a

In FIG. 9a, the OTR of three comparable packaging laminates, differing only by comprising different paper barriers A, B and C, are shown. Each of these laminates further had different inside polymer layer configurations as shown. The barrier-coated papers of B and C had better total oxygen barrier materials than the one of barrier-coated paper A and provide thus altogether a better performance, i.e. a lower level of Package-OTR.

The principal layer structure of the laminated packaging materials was:
//LDPE (12 g/m²)/paperboard 80 mN CLC Duplex BKG/LDPE (15 g/m²)/paper substrate/2×1.0 g/m² PVOH (total 2.0 g/m²)/metallization (OD~2.0)/inside//
(regarding the paper C laminate, the dry coating weight of PVOH was 2.8 g/m²)
wherein
“Inside” is either of:
“Film”:/EAA (6 g/m²)/LDPE (13 g/m²)/cast LLDPE film//“HDPE”:/EAA (6 g/m²)//HDPE (15 g/m²)/blend of mLLDPE 70 wt %+
LDPE 30 wt % (14 g/m²)//“mPE”:/EAA (6 g/m²)/blend of mLLDPE 70 wt %+LDPE 30 wt % (29 g/m²)//The

LDPE grade 19N730 from Ineos was used in all layers.

The “mPE” layer was made from a blend grade Elite 5800 from Dow, corresponding to a blend of about 70 wt-% mLLDPE and about 30 wt-% LDPE.

The EAA grade used was Primacor 3540 from Dow.

The LLDPE film was a cast bi-oriented LLDPE film of 18 μm thickness and had a surface weight of 17 g/m².

The HDPE grade was Dowlex 2006G from DOW.

Each of the barrier-coated paper substrates A and B in FIG. 9a, were coated with barrier coatings according to the following.

Two subsequent coating steps with aqueous PVOH dispersion (of Poval™ 6-98 from Kuraray at about 10 weight-% of solids content), were applied onto the top side of the base-coated paper substrates, by means of roller coating, each with a subsequent evaporation drying operation at a substrate surface temperature kept below 90° C., to provide in each coating step about 1.0 g/m² of dry weight coating, thus altogether about 2.0 g/m² of PVOH, dry weight. The thus PVOH-coated paper substrates were subsequently PVD coated with a thin metallisation coating to an optical density of about 2.0.

The barrier-coated paper substrate C was instead 4 times consecutively coated with 0.7 g/m² of the same PVOH (Poval™ 6-98 from Kuraray at about 10 weight-% of solid matter) with intermediate and final drying steps at a substrate surface maintained below 90° C. The thus PVOH-coated paper substrates were subsequently PVD coated with a thin metallisation coating to an optical density of about 3.5.

Lamination of the materials was carried out in a pilot-scale lamination line. The lamination speed was about 100 m/min.

The Duplex CLC paperboard was a clay-coated paperboard of a conventional type. The barrier-coated side of the paper substrate was directed in the laminated structure towards the inside, i.e. corresponding to the inside of a packaging container to be manufactured from the laminated material.

Laminated packaging materials were produced by means of melt extrusion lamination at 310° C., with about 15 g/m² of an interjacent bonding layer of a conventional low-density polyethylene, LDPE, thus laminating the paperboard to the back side of the respective barrier-coated paper. The outside of the paperboard was melt extrusion coated with about 12 g/m² of LDPE. The gas-barrier coated paper substrates were thus melt extrusion coated or laminated on their opposite, barrier-coated, inner side with the different inside polymer multilayer configurations.

Packaging containers were made from the respective laminated materials in a Filling Machine of the type Tetra Brik® A3/CF and the package size was 200 ml “Slim” (200S).

The filled packages were emptied, purged with nitrogen and the transmission rate of oxygen entering into the individual packages was measured according to ASTM F1307-14, at 0.2 atm.

The results were as shown by the diagram in FIG. 9a.

The OTR of packaging containers made from comparable laminates having a same barrier-coated paper is thus well maintained at a similar low and good level, regardless whether using inside a pre-manufactured cast LLDPE film, or a coextrusion-coated inside comprising a blend of metallocene-catalysed m-LLDPE and LDPE, as the heat sealable innermost layer. When including an interior load-bearing layer comprising an HDPE or MDPE in the inside polymer layer structure, instead of the pre-manufactured film, together with an innermost layer of the same mLLDPE and LDPE blend, the OTR of the packages remains very good or may even be further improved.

It has been found that a load-bearing and resistant inside polymer multilayer portion is needed in particular concerning less advanced paper substrates, which are less flexible and more prone to cause cracks in the thin barrier coatings, as the cellulose material is breaking upon folding of the paper. The use of a specific, expensive, pre-manufactured, cast LLDPE film has been the first solution to produce folding-resistant packages. The structure of the laminated packaging material according to the first aspect has proven, however, to be an excellent, cost-effective solution that maintains OTR properties well also after fold-forming the material into a package. Moreover, the inside polymer multilayer portion can also stay intact per se, without creation of thinnings or other defects of the polymer layers.

It has, also been found in connection to the above development, that a selected type of extrusion-grade, linear low-density polyethylene, “EC-LLDPE”, having a melting temperature, Tm, of 124° C., works even better from some aspects, although by different mechanisms and by means of slightly different sub-properties. Such improvements have, however, not been observed earlier when testing conventional LLDPE grades for (co-) extrusion coating, having lower melting temperatures, Tm, such as 110 degrees C. or lower, as conventionally used for an inside, or innermost, heat sealable layer.

### Experiment 3b

In this experiment, similar laminated packaging materials were made by the same methods and materials having the barrier-coated paper substrate A, and filled packaging containers of the same type were made in the same way. The principal layer structure of the laminated packaging materials was thus:
//LDPE (12 g/m²)/paperboard 80 mN CLC Duplex BKG/LDPE (15 g/m²)/paper substrate A/2×1.0 g/m² PVOH (total 2.0 g/m²)/metallization (OD~2.0)/inside//
wherein
“Inside” is either of:
“HDPE”:/EAA (6 g/m²)//HDPE 50 wt % blend with 50 wt % LDPE (15 g/m²)/blend of mLLDPE 70 wt %+LDPE 30 wt % (14 g/m²)//
“mPE”:/EAA (6 g/m²)/blend of mLLDPE 70 wt %+LDPE 30 wt % (29 g/m²)//
“EC-LLDPE”:/EAA (6 g/m²)/Elite 5811 from Dow 100 wt % (15 g/m²)/blend of mLLDPE 70 wt %+LDPE 30 wt % (14 g/m²)//

The LDPE grade 19N730 from Ineos was used in all layers.

The “mPE” innermost, heat seal layer was made from a blend grade Elite 5800 from Dow, corresponding to a blend of about 70 wt-% mLLDPE and about 30 wt-% LDPE.

The EAA grade used was Primacor 3540 from Dow.

The HDPE grade was Rigidex 6070FA from Ineos.

The filled packages were emptied, purged with nitrogen and the transmission rate of oxygen entering into the individual packages was measured according to ASTM F1307-14, at 0.2 atm, in the same manner. The results are presented in the diagram of FIG. 9b.

The results in FIG. 9b show that the laminated materials having an inside polymer multilayer portion with an intermediate, load-bearing layer of a blend of HDPE and LDPE at 50:50 weight ratio provides a better, i.e. lower,

OTR of a fold-formed, emptied packaging container than a corresponding laminate having a conventional inside polymer multilayer portion. The inventive laminate sample instead including an intermediate, load-bearing and load-distributing layer of the EC-LLDPE, i.e. comprising 100 wt % of Dow Elite 5811, also provides significantly better OTR than the laminate having a conventional inside polymer multilayer portion, however slightly worse OTR than the laminate with a load-bearing HDPE blend layer. Altogether, thus, the special EC-LLDPE load-bearing and load-distributing layer provides for good packaging containers, that promote a well kept oxygen barrier property of the barrier-coated paper-based material.

### Experiment 4a

To further test the ability of a laminated material to endure fold-forming in a filling machine, the laminated materials of Experiment 3 were exposed to mono-axial folding, unfolding and re-folding multiple times in a folding rig, after which the OTR is measured over the planar, material having one such unfolded fold. The folding operation is repeated several times to test the robustness of the material to induce “folding exhaustion”. This is a very important aspect of folding robustness of a non-foil (i.e. no aluminium foil) laminated liquid carton material comprising a barrier-coated paper substrate, and the method is measuring to what degree the inside polymer layers can protect the paper barrier materials.

The ability of the inside polymer multilayer portion to prevent cracks from forming in the paper substrate upon folding, or at least to reduce the size of any formed cracks, may also be studied by optical microscopy or by a magnifying glass on the metallic barrier coating.

For studying the appearance of “thinning defects” in the inside polymer multilayer portion, X-ray tomography and microtome section-cutting and light microscopy may be needed.

It seems that an inside polymer multilayer portion having a higher and appropriate tensile modulus can better withstand tension such that its thickness remains unchanged when stretched over a fold. Such polymer layers can counter any appearing cracks in the folded paper to prevent them from opening up further, which also prevents cracks in the barrier coatings and thus contributes to better oxygen barrier properties. Altogether, it seems the structure becomes more robust and load-bearing towards folding forces.

In FIG. 10a, the results of so-called “OTR folding robustness” tests are shown, regarding a laminate having paper A as the barrier-coated paper substrate and an inside cast film of LLDPE, as well as one of the improved paper barriers C, which is in accordance with claims 1-12 of the present invention, with each one of the discussed configurations of inside polymer layers in Experiment 3a. The laminated materials were folded and unfolded multiple times and the OTR was measured after two and four folding repetitions.

Surprisingly, the folding robustness of the laminated paper C material seems to become even better when applying a coextrusion coated HDPE layer adjacent the innermost m-LLDPE blend layer, than when using the cast premanufactured LLDPE film as the innermost layer.

From the results with paper barrier A, it may be concluded that when using the cast premanufactured LLDPE film as the innermost layer, there is a significant improvement in comparison to when merely using an inside polymer multilayer portion having a single layer of a blend of 70 wt % mLLDPE and 30 wt % LDPE.

The results show that both the film inside and the HDPE coextruded layer improved such folding exhaustion significantly, thus reducing the OTR loss in fold-shaped packaging containers.

This altogether indicates that an extrusion-coated inside polymer multilayer configuration comprising a merely extrusion-coated layer of HDPE is a very good material to form part of the inside polymer layers for paper barrier laminates, providing an improved OTR folding robustness compared to inside polymers comprising a pre-manufactured LLDPE film, in particular in combination with the barrier-coated, fibrous cellulose-based substrate of the invention. At the same time, in comparison to inside polymers with a pre-manufactured LLDPE film, the openability of the total packaging material will be improved by using only extrusion coated polymer layers in the inside polymer multilayer portion.

The configurations of the inside polymer multilayer portions tested in FIG. 10a all had a total polymer surface weight of about 35 g/m², having an innermost layer of a blend of 70 wt % mLLDPE and 30 wt % LDPE at 15 g/m² and an adhesion promoting layer of EAA polymer towards the barrier coatings of 6 g/m².

The three-layer co-extrusion coated inside polymer multilayer configuration having an intermediate layer comprising HDPE has thus proven to be a viable alternative to a pre-manufactured cast and oriented LLDPE film regarding inside polymer and paper barrier integrity of fold-formed packages.

### Experiment 4b

To understand the impact of inclusion of the selected EC-LLDPE layer (as defined in claim 1) instead of an HDPE layer, in the inside polymer multilayer portion, comparative measurements were also made on similar structures with the only difference of having the inside polymer multilayer portion comprising a load-bearing and load-distributing layer of an extrusion-coating grade of an LLDPE having a high melting point, above 115° C., such as above 120° C., specifically in this experiment with a Tm of 124° C.

Thus, the comparable and inventive laminates were like in Experiment 2a, with an inside polymer multilayer configuration of three layers, i.e./EAA 6 g/m²/“X” 15 g/m²/blend of 70 wt % mLLDPE and 30 wt % LDPE 14 g/m²//
Where “X” was:
An extrusion-coatable, load-bearing and load-distributing and high-melting LLDPE, “EC-LLDPE” (Extrusion-coating type LLDPE) being Elite 5811 from Dow,
“EC-LLDPE 50%” (the same EC-LLDPE in blend with 50 wt-% LDPE),
“HDPE 20%” (HDPE in blend with 80 wt-% LDPE),
“LDPE”,
“LDPE+” (meaning that the grammages of the three layers including a layer of LDPE were Jun. 20, 2018/) and
“mPE” (meaning a blend of 70 wt % mLLDPE and 30 wt % LDPE).

The LDPE used was Ineos 19N730, the EAA was Primacor 3540 from DOW, the HDPE was Dowlex 2006G from DOW and the EC-LLDPE was thus Elite 5811 from DOW.

From FIG. 10b, it can be seen regarding mono-axial and repeated folding over a crease line in the paperboard, that a conventional inside with only EAA and “mPE” heat sealing blend does not perform very well, which is part of the problem underlying the invention, whereas the substitution of the middle mPE layer with a conventional extrusion grade LDPE, improves the folding resistance of the total inside. When increasing the polymer surface weights to 6+20+18 g/m² (the sample called “LDPE+”), the monoaxial folding resistance or property is only slightly improved, why it may be concluded that merely increasing the amount of polymer in the coating layers is not very efficient. When substituting the middle layer to instead comprise 20 wt-% HDPE, i.e. a rather low amount, the improvement is similar. When substituting the middle layer with the selected “EC-LLDPE” instead, the results get worse again, which generally discourages to use such a linear low density polyethylene in comparison to using a middle inside layer of HDPE or LDPE polymer.

It was, however, further seen that when blending the EC-LLDPE with 50 wt % LDPE, the load-bearing property to mono-axial folding could be slightly improved.

### Experiment 5

FIG. 11a-11c show how the openability of packaging containers manufactured from the laminated materials is secured by the laminated packaging material of the invention.

For the diagrams of FIGS. 11a-11c, laminated materials of the paper barrier A as described above in conjunction with FIG. 9a were made, and laminated to different configurations of the inside polymer multilayer portion. The three types of laminates were tested regarding the maximum opening force, the maximum energy and the total energy needed, respectively, for penetrating a pre-cut, laminated hole for a drinking straw, with a paper straw having the same dimensions and stiffness properties in all tests, and the three variants were compared to each other.

Thus, for FIGS. 11a-11c the following applies:
Comparative structure extrusion=conventional co-extrusion coated two-layer inside (as used with aluminium-foil based carton materials) (adhesive polymer+innermost heat-sealable layer), i.e./EAA (6 g/m²)/blend of mLLDPE 70 wt %+LDPE 30 wt % (29 g/m²)//
Comparative structure film=film inside=/EAA (6 g/m²)/LDPE (13 g/m²)/cast LLDPE film 17 g/m²//
Inventive laminate=co-extrusion coated three-layer inside with a load-bearing layer, i.e./EAA (6 g/m²)//HDPE (15 g/m²)/blend of mLLDPE 70 wt %+LDPE 30 wt % (14 g/m²)//
The polymers used were as above in connection to FIG. 9a.

FIG. 11a thus shows the relative maximum force needed for the paper straw to penetrate the laminated polymer membrane in the opening hole, which is pre-cut in the paperboard of the laminated packaging material. As the pre-cut hole is laminated to the outside and inside polymer layers, the outside and inside polymer layers become laminated to each other within the hole region to thus form a membrane of only polymer layers and optionally the thin barrier layers (if not also pre-cut, together with the bulk layer). Measurements were in N. As expected, the force needed for the comparative material having the pre-manufactured cast LLDPE film as described above, was the highest, and when penetrating the material in the machine direction, MD, of the material. All values are represented as relative values in comparison to this value in the diagram in FIG. 11a. The inventive laminate thus brings the required force down to the normal level, only slightly higher than for a conventional two-layer inside laminate, as described above.

FIG. 11b shows the corresponding relative maximum energy required for the penetration of the paper straw, for the same three laminated materials. The energy required for the inventive laminate is the lowest in the machine direction, MD, and at the same level as the conventional laminate in the cross direction, CD. Measurements were in Nm.

FIG. 11c shows the corresponding relative maximum energy required for the penetration of the paper straw, for the same three laminated materials. The total energy required for the inventive laminate is at the normal and accepted level, only slightly higher than for a conventional two-layer inside laminate, as described above. Measurements were in Nm.

In both FIGS. 11b and 11c the results of the measurements are represented as relative to the value measured of the Comparative structure with a film, in the MD.

To conclude, the openability is significantly improved by the inventive laminate having a load-bearing extrusion-coated layer, in comparison to using a load-bearing, pre-manufactured LLDPE film, in the case of a straw opening or a pre-cut hole-membrane penetration opening mechanism. This is the thus case, while also the folding robustness is greatly improved by the extrusion-coated, load-bearing layer in comparison to the coextrusion-coated inside polymer multilayer portion having no such load-bearing layer.

To conclude, a corresponding laminate having an inside layer configuration comprising a pre-manufactured film may still perform better concerning other integrity aspects of the inside polymer multilayer portion, but since such pre-manufactured films have the significant drawback of providing laminated materials and packages that are more difficult to open, they are altogether a less desirable alternative to a conventional m-LLDPE blend inside configuration. Suitable pre-manufactured films are in addition not only significantly more expensive as such, but also add more costs to the lamination process which further adds to their disadvantages.

By the mere addition of an interior extrusion-coated, load-bearing layer comprising HDPE to the inside polymer multilayer portion, a cost-effective and better alternative has been found to the lamination of pre-manufactured films, because it is also better from openability point of view.

It is similarly expected that the inclusion of an extrusion-coated layer of the selected, load-bearing and load-distributing EC-LLDPE having a Tm of 124 degrees C. in the inside polymer multilayer configuration will provide good openability properties, only maybe with slightly higher resistance to openability due to the more load-distributing property, but anyway significantly lower resistance than the comparative sample which includes an inside layer of a pre-manufactured, cast and biaxially oriented LLDPE polymer film. To conclude, an inside polymer multilayer, i.e. three-layer, configuration having a middle layer of the EC-LLDPE instead of the HDPE, will certainly also work better than the materials comprising a pre-manufactured film in the inside polymer multilayer portion.

### Experiment 6

Further comparative tests regarding OTR folding robustness were made, wherein the layer of HDPE was substituted with a layer of a blend of HDPE with 20 or 50 wt % LDPE of a conventional extrusion coating grade, respectively. The total surface weight of the inside polymer multilayer portion was about 35 g/m² in this example and the principal laminate layer structure was:
//LDPE (12 g/m²)/paperboard 80 mN CLC Duplex BKG/LDPE (15 g/m²)/thin paper substrate A/2×PVOH (total g/m²)/metallization (OD~2.0)//EAA (6 g/m²)//HDPE (or HDPE blend) (15 g/m²)/blend of mLLDPE 70 wt %+LDPE 30 wt % (14 g/m²)//

Two grades of HDPE polymer was tested, i.e. Dowlex 2006G from Dow and RigidexFA from Ineos. The LDPE blending polymer was Ineos 19N730.

As shown in FIG. 12, it seems that from further experiments with blending the HDPE polymer of the load-bearing “HDPE” intermediate layer with up to 50 wt % LDPE, the OTR folding robustness test provided similar, good OTR results at low level values.

Consequently, the oxygen transmission after repeated monoaxial folding was maintained at a rather low level also when the amount of the HDPE polymer in the load-bearing layer was reduced, i.e. the blends within the range shown exhibit rather the behaviour of a three-layer HDPE-containing inside polymer multilayer portion, than the behaviour of a conventional, corresponding configuration with an mLLDPE-blend inside layer. This can be further seen in FIG. 13 (Experiment 7).

### Experiment 7

In a different test series, with results shown by the diagram of FIG. 13, similar laminates but having thinner inside polymer layer configurations were folded and tested in the same way as in the previous experiments, but the laminates were in total having a grammage of only about 26 g/m². In this test, the inside layers were applied by extrusion coating in two consecutive steps. For comparison, also the inside having only the m-LLDPE blended layer was tested to be extrusion coated in two consecutive steps.

The principal layer structure of the laminated packaging materials was:
//LDPE (12 g/m²)/paperboard 80 mN CLC Duplex BKG/LDPE (15 g/m²)/paper substrate A/2×PVOH (total 2 g/m²)/metallization (OD~2.0)/inside//
wherein
“Inside” is either of:
“HDPE”:/EAA (6 g/m²)//HDPE (10 g/m²)/blend of mLLDPE 70 wt %+LDPE 30 wt % (10 g/m²)//
“mPE”:/EAA (6 g/m²)/blend of mLLDPE 70 wt %+LDPE 30 wt % (20 g/m²)//

The polymer grades used were as in the previous Experiment 6, and as indicated in the diagram, the HDPE grade was in this case the RigidexFA from Ineos.

The results in FIG. 13 show, that a two-step extrusion coating of the m-LLDPE blend inside layers would merely provide a similar result to the reference, single-step co-extrusion coating (i.e. same layer amount applied in one extrusion coating step only) of the mLLDPE blend inside of the same thickness, thus a two-step extrusion coating was not improving the OTR folding robustness of this inside layer configuration.

The laminates with the load-bearing, intermediate layer comprising HDPE on the other hand, when extrusion coated separately from the innermost mLLDPE blended layer, i.e. when extrusion coating of the inside polymer layers was performed as two consecutive coating steps with solidification of the applied layers at each step, did provide a better OTR folding robustness than both the single-step and two-step extrusion-coated configurations of the mLLDPE blend inside.

It was thus seen that the use of an HDPE load-bearing layer improved significantly the OTR folding robustness at 2 and 4 times folding, respectively, in comparison to a reference inside sample having the conventional mLLDPE blend innermost layer alone.

It is also seen that the OTR folding robustness when the HDPE was blended with 50 wt % LDPE, and extrusion coated in two steps, would be even further improved, even if applied in thin layers.

Generally, a packaging laminate having a 3-layer inside with an intermediate layer of 100% HDPE seems to provide packages having better Package-OTR as well as improved OTR folding robustness.

However, it has also been seen that the packaging laminate occasionally results in defective packages (formed in a filling machine), having low integrity robustness (including folding robustness), and in such single cases also the OTR for such failed packages will be too high. This is believed to occur due to the anisotropic properties of an extrusion-coated HDPE. It has thus been seen that a load-bearing layer comprising HDPE in a blend with LDPE can provide better overall folding robustness and less defective packages from this point of view, since the anisotropic behaviour is reduced when including a fraction of LDPE in the load bearing layer.

### Experiment 8a

A further sensitive area for defects which may cause occasional bad packages with high Package-OTR as well as bad integrity of the inside polymer layers, in addition to the mono-axial folding exhaustion along crease-lines in the paperboard, are package laminate areas of biaxial folding for the shaping into a cuboid packaging container.

A further important aspect of package integrity thus concerns to what extent the inside polymer layers are able to resist damage in bi-axial, double folding in the fold-forming of carton laminates. In order to specifically test this integrity property, the same laminated material samples having 35 g/m² inside polymers as tested in connection to FIG. 12, were folded 180 degrees first once and then a second time 180 degrees, further and perpendicular to the first fold, in a folding rig such that a constant geometry was applied to the double folds. A second fold upon and perpendicular to the first fold was thus formed, such that severe strain and stress acted on the inside polymer layers. After unfolding again, the planar material was tested to detect thinnings of the polymer layers on the inside of the barrier-coated paper by applying a lowest level of a high voltage to detect whether such thinnings or defects would allow breakthrough of the voltage applied. If not, the testing was continued by applying further increased voltages, until finally a dielectric break-through occurred. The voltage at breakthrough was noted. This is thus a test to evaluate the risk for thinning of material layers during stressed conditions, i.e. a stress-test of the material.

The results are presented in FIG. 14a, which shows that an inside polymer multilayer portion with a load-bearing layer which is a blended layer of HDPE with from 20 to 50 wt % LDPE, does not allow voltage breakthrough until reaching a several kVolt higher applied voltage than what a pure corresponding HDPE layer of the same thickness did. This effect is seen regardless of which grade of HDPE is used.

Thus, to optimize folding robustness properties altogether, i.e. both from mono-axial crease-folding point of view and from biaxial folding point of view, it is advantageous to blend HDPE with LDPE, with an LDPE fraction from 20 to 80 wt-% LDPE, such as from 20 to 70 wt-%, such as from 20 to 60 wt-%, such as from 20 to 50 wt-%.

### Experiment 8b

A comparison was made between the laminates of Experiment 6a with a similar packaging laminate having a 3-layer inside, but instead with an intermediate layer of 100% of the EC-LLDPE (Elite 5811 from Dow) to the laminated materials listed under Experiment b above, and the result is shown in FIG. 14b.

As shown in FIG. 14b, the laminate configuration having an inside middle layer of the non-blended EC-LLDPE performs better than any of the HDPE laminate configuration samples, regarding biaxial folding. As bi-axial folding may cause damages both in the thin barrier coatings as well as in the inside polymer multilayer portion, this is an important property. The improved performance of a laminate having the load-bearing and load-distributing EC-LLDPE inside configuration during bi-axial folding may balance the lower performance regarding mono-axial folding OTR robustness thereof. When blending the EC-LLDPE with some LDPE, the mono-axial folding load-bearing and load-distributing effects are slightly improved, while regarding biaxial folding such blending is not favourable. This is further shown by the comparative test results as shown in FIG. 14c, i.e. clearly reducing the load-bearing and load-distributing effect of the inside polymer multilayer portion as the proportion of LDPE increases in the layer comprising the EC-LLDPE.

### Experiment 9a

A yet further important aspect of package integrity is to what extent the layers of the inside polymer multilayer portion, as such, are of a good quality, without defects and thinnings, such as pinholes, formed i.a. in the extrusion coating and lamination processes. This property is equally tested for breakthrough of a voltage applied at increased steps towards higher values. The testing is performed by a so-called “Poroscope” of the type “Fischer HV5” on laminate samples having an inside polymer multilayer configuration thickness of about 26 g/m² surface weight. This test thus shows the integrity of the inside layers on areas of formed packaging containers, where the laminated material merely forms flat, uncreased and unfolded panels, i.e. corresponding to unfolded package walls on a packaging container.

FIG. 15a shows the results for the same laminated material samples as in FIG. 14a and FIG. 12, thus with a surface weight of the inside polymer multilayer portion of about 35 g/m². The same trend is seen, i.e. the blended HDPE appears to provide better quality and total resilience of the inside polymer multilayer portion. A layer of 100% HDPE seems to resist lower applied voltages better but would anyway risk breakthrough at higher voltages applied, and moreover in a higher number of packages. When blending the HDPE with 20 weight-% LDPE, the total number of weaknesses decreased and they decreased even further as about 50 weight-% of LDPE was part of the blend.

### Experiment 9b

As seen in FIG. 15b, the same laminated material, however having a similar inside polymer multilayer configuration with an inside middle layer of the EC-LLDPE, performs surprisingly well in the same Poroscope test. This result also balances further the lower performance in mono-axial folding robustness, such that a holistically further improved laminated material is obtained, exhibiting a load-bearing and load-distributing effect, as well as an improved layer quality, in its inside polymer multilayer configuration, to provide an overall improved package integrity relating to the inside polymer multilayer portion.

### Experiment 10a

Further, the laminated materials having inside polymer multilayer portions applied by two-step extrusion coating were tested by the poroscope on planar, unfolded materials for the same reason. In FIG. 16a it can be seen, at 50% HDPE RigidexFA from Ineos in the inside intermediate layer, that two-step extrusion coating is better than a comparable coextrusion of all three layers in one single step. In addition, the two-step extrusion coated layers have a lower thickness (around 26 g/m² as compared to 36 g/m² of the single-step coextrusion coating sample), and would for this reason normally have been more sensitive to the applied voltage, but they proved on the contrary, and rather surprisingly, to be of better quality and more robust. In the two-step extrusion coating, the adhesive polymer, EAA, and the load-bearing, HDPE-containing layer were co-extrusion coated together onto the barrier-coated paper, and allowed to solidify, before the innermost, heat sealable layer was subsequently, separately extrusion-coated onto the solidified, previously applied coating layers.

### Experiment 10b

When in a corresponding manner blending the EC-LLDPE with LDPE and studying this planar coating layer quality, it resulted that blending with LDPE hardly made any difference, possibly only slightly if blending at 50 wt %. To obtain a best possible performance from the EC-LLDPE polymer, it is thus suggested not to blend it with LDPE, also from this point of view, as deducible from FIG. 16b.

### Experiment 11

FIG. 17a shows further test results from poroscope measurements on flat, uncreased and unfolded laminated materials having an inside polymer multilayer portion of a total surface weight of 26 g/m² instead. The sample PM 12077 with two-step extrusion coated polymer inside, having an intermediate layer of 100% HDPE RigidexFA from Ineos resulted in a higher number of voltage breakthrough occurences than the sample PM12104 with two-step extrusion coated layers and using an intermediate layer of 50 wt-% HDPE in a blend with 50 wt-% LDPE.

A similar test was not performed of a method of extrusion coating the inside polymer three-layer configuration in two steps, having an intermediate layer of the selected EC-LLDPE, and it could thus not be verified whether even further improvements would be achieved by using the load-bearing and load-distributing EC-LLDPE, but it is believed very likely in view of the learnings from two-step extrusion coating of corresponding insides with intermediate, inside HDPE-comprising layers, as well as from two-step co-extrusion coating of corresponding conventional insides (i.e. having only EAA adhesion promoting layer and “mPE” heat-sealing blend layers). From the layer-integrity test results on flat, unfolded inside polymer layers of different types, in laminated materials as shown in FIG. 17b, it was thus seen that a two-step extrusion coating method was clearly advantageous in comparison to a single-step co-extrusion coating method. The surface coat weight of the inside polymer multilayer portions in FIG. 17b were about 26 g/m², except from the third sample (PM12225) wherein the surface weight was 35 g/m².

### Experiment 12

FIG. 18 shows that in the case of two-step extrusion coating of the inside polymer layers, an intermediate layer comprising HDPE RigidexFA from Ineos will perform better also upon biaxial folding and unfolding, in high voltage “holiday” testing as described in Experiment 6, when the HDPE polymer is blended with 50 wt-% LDPE, compared to a layer comprising 100 wt-% HDPE.

This means, that on average, a sample with 100 wt-% HDPE was broken through at half the total thickness of the polymer inside layers, compared to when the HDPE is 50 wt-% blended with LDPE. By blending HDPE and LDPE the result was thus surprisingly about 100% better.

The laminate samples have in this comparative measurement a thinner inside polymer layer configuration, i.e. about 26 g/m², which more easily induces voltage breakthrough. The two-step extrusion-coated laminates would naturally be further improved at a higher total thickness of about 35 g/m².

The comparison to a reference laminate sample having an inside configuration with a blended inside layer with m-LLDPE and LDPE shows that blending the HDPE brings the inside integrity performance to be slightly better than reference level, regarding biaxial folding.

The performance regarding packaging laminate simple folding integrity is thus surprisingly improved by an extrusion-coated polymer inside configuration of layers having an intermediate layer comprising HDPE, in comparison to a layer configuration having only mLLDPE polymer at the same grammage. Upon biaxial folding, the HDPE-comprising inside polymer layer configuration performs better when the HDPE is blended with LDPE. The number of weaknesses or defects on the flat material polymer layers is further decreased, and thereby the integrity of the layers improved, when the inside layers comprising a load-bearing layer with HDPE are applied in a two-step extrusion coating operation.

This altogether indicates that HDPE or MDPE is a particularly good material to form part of the inside polymer layers for paper barrier laminates, also providing an even better OTR folding robustness than inside polymers comprising a pre-manufactured cast LLDPE film and further improving folding integrity when blending the HDPE with LDPE. At the same time, in comparison to inside polymers with a pre-manufactured LLDPE film, the openability of the total packaging material will be much improved by using only extrusion coated polymer layers in the inside polymer multilayer portion. Thus, a more load bearing inside polymer multilayer portion provides robustness in laminated carton-based packaging materials having barrier-coated cellulose-based sheets or films as substrates. A more robust inside multilayer portion is in particular needed when using less advanced paper substrates, which are less flexible and more prone to cause cracks in the thin barrier coatings, as cellulose fibre material is breaking upon folding of the paper.

The structure of the laminated packaging material according to the invention has proven to be a good, cost-effective solution that maintains OTR properties well also after fold-forming the material into a package. Moreover, the inside polymer multilayer portion as such can remain intact, without the formation of thinnings or other defects of the polymer layers, thus resisting the folding forces such that they better protect the sensitive contents in a filled packaging container. As the inside multilayer portion remains intact, the thin barrier coatings may also stay unimpaired to perform to their intended purpose.

In this way, the improved laminated packaging material can resist fold-forming into packaging containers to better protect oxygen-sensitive, liquid, semi-liquid and viscous food products during long term storage with maintained asepticity.

In addition, such a laminated packaging material, comprising a cellulose-based barrier coating structure instead of an aluminium foil or thick polymer barrier materials, also exhibits better repulpability and recyclability after use, to fulfil the needs of future environmentally sustainable laminated packaging materials.

Furthermore, improved heat sealable such laminated packaging materials are provided, while not containing aluminium foil but still providing for good gas barrier and other barrier properties, and being suitable for long-term, aseptic packaging at reasonable cost and complexity of source materials and manufacturing processes.

In the preferred embodiments of extrusion-coating the insider polymer multilayer portion in two steps, the integrity of the inside polymer multilayer portion is also generally further enhanced, within the full, in-the plane extension of the laminated packaging material.

### Conclusions from Invention Experiments 3b, 4b, 8b, 9b and 10b

A further embodiment of the invention has been realized, beyond the subject-matter resulting from the above Experiments 3a, 4a, 5, 6, 7, 8a, 9a, 10a, 11 and 12, i.e. as proven from the above Experiments 3b, 4b, 8b, 9b and 10b.

From Experiment 3b, it can be concluded that good packaging containers may be obtained from a laminated material of the invention, exhibiting OTR package values on par with those for packages from corresponding laminates comprising a load-bearing layer comprising HDPE in their inside polymer multilayer configuration, and equally improved over corresponding laminated materials having the conventional inside polymer configuration.

As seen from Experiment 4b, the results of OTR on folding robustness from using a middle inside layer of the selected EC-LLDPE are significantly better than regarding a convention inside polymer configuration comprising only adhesive polymer and lower-temperature heat-sealable polymer layers, even if not quite as good as the comparative inside polymer multilayer configurations comprising a load-bearing layer of HDPE in Experiment 4a. A further slight improvement is seen when blending the load-bearing as well as load-distributing EC-LLDPE with LDPE.

From Experiment 8b it can be concluded that the inventive laminate performs significantly better upon biaxial folding, than the similar laminates having a load-bearing layer comprising any proportion of HDPE, as the middle layer in the inside polymer multilayer configuration. From FIG. 14c it may be concluded that blending of the EC-LLDPE with an LDPE is not helpful from this point of view. It is believed that the extrusion coated layer of the EC-LLDPE having a high melting temperature is less load-bearing than an HDPE polymer, while still performing better thanks to better load-distributing properties as the polymer is strained without being weakened during biaxial folding operations.

From Experiments 9b and 10b it can be seen that also the flat, unfolded laminate of the load-bearing and load-distributing inside portion comprising the EC-LLDPE layer of the invention are excellent in quality in comparison to the corresponding laminates with an HDPE layer. Also for this property, there may be a slight advantage in blending the LLDPE with LDPE, but not high enough to outweigh the advantages from not blending as seen regarding the biaxial folding performance in Experiment 8b. Furthermore, from the research resulting in better properties seen i.a. for the co-pending subject-matter, it is conceived that further separate extrusion of the inside layers in at least two extrusion coating steps, with solidification of the prior layer before the application of the next layer, will further improve also the inventive laminated materials comprising the EC-LLDPE inside middle layer.

Because the inventive laminate has only extrusion coated polymer layers in its inside polymer multilayer configuration, the openability will be good, and significantly better than when instead laminating a pre-manufactured film to the laminate inside multilayer portion. Thus, a well-functioning alternative configuration, or an even better functioning, configuration is provided, of the inside polymer multilayer portion for a heat-sealable and liquid-tight, laminated carton-based packaging material having a non-aluminium-foil, paper-based, barrier structure. The inside polymer multilayer portion as described in this invention improves the laminated layer integrity, as well as the fold-forming load-bearing and load-distributing properties in a better way, to protect and integrate such paper-based barrier materials in a laminated carton-based packaging material in an excellent manner.

As a final remark, the invention is not limited by the embodiments shown and described above but may be varied within the scope of the claims.

1. Barrier-coated cellulose-based fibrous substrate, for use as oxygen barrier in a heat sealable laminated packaging material for oxygen-sensitive food products, comprising a fibrous cellulose substrate having a grammage from 30 to 80 g/m², and a density from 700 to below 900 kg/m³, a first gas barrier coating, applied on a first side of the fibrous cellulose substrate by dispersion or solution coating of an aqueous oxygen barrier composition followed by drying by evaporation, wherein the barrier-coated cellulose-based fibrous substrate further has a steam-resistant base coating, comprising from 25 to 96 weight-% of inorganic particles and from 4 to 75 wt-% of a polymer binder, per dry weight, positioned beneath the first gas barrier coating and applied by aqueous dispersion coating onto, directly adjacent and contacting the first side of the fibrous cellulose substrate, the thus barrier-coated fibrous cellulose substrate providing gas barrier properties in the heat sealable laminated packaging material.

2. Barrier-coated cellulose-based fibrous substrate as claimed in claim 1, wherein the fibrous cellulose substrate has a density from 700 to 850 kg/m³.

3. Barrier-coated cellulose-based fibrous substrate as claimed in claim 1, wherein the fibrous cellulose substrate is made essentially from Kraft pulp fibres.

4. Barrier-coated cellulose-based fibrous substrate as claimed in claim 1, wherein the steam-resistant base coating comprises from 30 to 96 weight %, of the inorganic particles and from 4 to 70 weight %, of a polymer binder and further additives, based on dry weight.

5. Barrier-coated cellulose-based fibrous substrate as claimed in claim 1, wherein the steam-resistant base coating is applied by aqueous dispersion coating at an amount of from 5 to 25 g/m², dry weight.

6. Barrier-coated cellulose-based fibrous substrate as claimed in claim 1, wherein the polymer binder of the steam-resistant coating is an aqueous emulsion binder, such as selected from the group consisting of aqueous emulsions of acrylic or methacrylic homo- or co-polymers, such as styrene-acrylate latex, vinyl acrylic copolymer latex or vinyl acetate acrylate copolymer latex, and of styrene-butadiene copolymers, such as styrene-butadiene latex, and of biobased emulsion binders, such as modified starch latex, and of vinyl alcohol polymers, such as polyvinyl alcohol, PVOH, or ethylene vinyl alcohol, EVOH, and of other modified starches or starch derivatives.

7. Barrier-coated cellulose-based fibrous substrate as claimed in claim 1, wherein the free, dried but uncoated surface of the steam-resistant base coating, was measured to have a surface roughness below 150 ml/min Bendtsen.

8. Barrier-coated cellulose-based fibrous substrate as claimed in claim 1, wherein the aqueous oxygen barrier composition of the first gas barrier coating comprises a polymer selected from the group consisting of starch and vinyl alcohol polymers and copolymers.

9. Barrier-coated cellulose-based fibrous substrate as claimed in claim 1, wherein the first gas barrier coating is applied by aqueous dispersion or solution coating at a grammage from 0.5 to 4 g/m² dry weight.

10. Barrier-coated cellulose-based fibrous substrate as claimed in claim 1, further comprising at least one further gas barrier coating, applied onto the first gas barrier coating, the at least one further gas barrier coating including at least one barrier deposition coating, applied by a vapour deposition method, and the thus barrier-coated fibrous cellulose substrate providing gas barrier properties and water vapour barrier properties in the heat sealable laminated packaging material.

11. Barrier-coated cellulose-based fibrous substrate as claimed in claim 10, wherein the barrier deposition coating is a vapour deposition coating of a material selected from metals, metal oxides, inorganic oxides and carbon coatings.

12. Barrier-coated cellulose-based fibrous substrate as claimed in claim 10, wherein the barrier deposition coating is a vapour deposition coating selected from the group consisting of an aluminium metallisation coating and aluminium oxide, AlOx.

13. Heat sealable laminated packaging material comprising the barrier-coated cellulose-based fibrous substrate as claimed in claim 1, and further comprising a first outermost protective material layer and a second innermost liquid tight, heat sealable material layer.

14. Heat sealable laminated packaging material as claimed in claim 13, wherein the second innermost liquid tight, heat sealable material layer portion comprises a polyolefin polymer.

15. Heat sealable laminated packaging material according to claim 13, further comprising a bulk layer of paper or paperboard or other cellulose-based material and having said barrier-coated cellulose-based fibrous substrate arranged on the inner side of the bulk layer of paper or paperboard, between the bulk layer and the second innermost liquid tight, heat sealable material layer portion.

16. Heat sealable laminated packaging material according to claim 15, wherein the barrier-coated cellulose-based fibrous is bonded to the bulk layer by an intermediate bonding layer comprising a composition comprising a binder selected from the group consisting of acrylic polymers and copolymers, starch, cellulose and polysaccharide derivatives, polymers and copolymers of vinyl acetate and/or vinyl alcohol.

17. Heat sealable laminated packaging material according to claim 13, wherein the second innermost liquid tight, heat sealable material layer portion is, or is included in a pre-manufactured film comprising a polyolefin for improved robustness of the mechanical properties of the packaging material.

18. Heat sealable laminated packaging material according to claim 13, having an inside polymer multilayer portion, which corresponds to all polymer layers applied on the inside of the barrier-coated cellulose-based, fibrous substrate, comprising a second innermost liquid tight, heat sealable material layer to be in direct contact with a product to be filled into a packaging container made from the packaging material, and an interjacent, load-bearing layer comprising high-density polyethylene, HDPE, medium-density polyethylene, MDPE, or a linear low-density polyethylene, LLDPE, having a melt flow ratio, MFR, from 4 to 20 g/10 min and a melting temperature above 115° C., wherein all the layers of the inside polymer multilayer portion are applied by extrusion coating onto the inner side of the barrier-coated cellulose-based, fibrous substrate, the second innermost liquid tight, heat sealable material layer comprising a polyethylene polymer having a low density.

19. Heat sealable laminated packaging material according to claim 13, wherein the second innermost liquid tight, heat sealable material layer has a major melting point peak, Tm, from 88 to 110° C.

20. Heat sealable laminated packaging material according to claim 18, wherein the interjacent, load-bearing layer may comprise a polymer blend composition including from 30 to 90 weight-% of HDPE or MDPE and from 10 to 70 weight-% of LDPE.

21. Heat sealable laminated packaging material according to claim 18, wherein the interjacent, load-bearing layer may alternatively comprise a polymer blend including from 50 to 95 weight-% of the LLDPE having a melt flow ratio from 4 to 20 g/10 min and a melting temperature above 115° C. and from 5 to 50 weight-% of an HDPE or MDPE.

22. Heat sealable laminated packaging material according to claim 18, wherein the interjacent, load-bearing layer has a surface weight from 8 to 25 g/m².

23. Heat sealable laminated packaging material according to claim 18, wherein the inside polymer multilayer portion further comprises a tie layer comprising an adhesive polymer adjacent and in contact with the barrier-coated, inner side of the cellulose-based, fibrous substrate.

24. Packaging container comprising the heat sealable laminated packaging material as defined in claim 13.

25. Method of manufacturing a barrier-coated cellulose-based fibrous substrate as claimed in claim 1, which comprises
a first step of providing the fibrous cellulose substrate having a machine-glazed or machine-finished top side surface, as a moving web in a roll-to-roll system,
a second step of dispersion coating a dispersion composition for a steam-resistant base coating comprising from 25 to 96 weight-% of inorganic particles and from 4 to 75 wt-% of a polymer binder, per dry weight, onto the moving fibrous cellulose substrate, and subsequently drying the applied base coating by forced evaporation,
a third step of smoothening the surface of the base-coated fibrous cellulose substrate obtained from the second step,
a fourth step of dispersion coating an aqueous second dispersion or solution of a first gas barrier coating composition, onto the moving, smoothened base-coated fibrous cellulose substrate, and subsequently drying the applied first gas barrier coating by forced evaporation,
optionally repeating the fourth step, and
optionally a fifth step of depositing a further barrier coating by vapour deposition onto the free surface of the first gas barrier coating of the moving gas-barrier coated fibrous cellulose substrate.

26. Method as claimed in claim 25, wherein the steam-resistant base coating composition is an aqueous composition comprising from 10 to 20 weight-% of a polymer binder and from 80 to 90 weight-% of inorganic particles, dry weight.

27. Method as claimed in claim 25, wherein the free, uncoated surface of the steam-resistant base coating on the base-coated fibrous cellulose substrate obtained from the third step, has a surface roughness below 3 μm as measured according to ISO 8791-4 (PPS).

28. Method as claimed in claim 25, wherein the free, uncoated surface of the steam-resistant base coating on the base-coated fibrous cellulose substrate obtained from the second or third step has a Gurley air resistance above 1500 s/100 ml.

29. Method as in claim 25, wherein an initial method step is instead a step of providing the base-coated and smoothened fibrous cellulose substrate resulting from the first, second and third steps, as a moving web in a roll-to-roll system, and wherein a following, next step is the same as the fourth step and, optionally, a next, following step is the same as the fifth step, in that order.

30. Method for manufacturing of a heat-sealable laminated packaging material as claimed in claim 18, comprising the steps of
laminating the barrier-coated cellulose-based, fibrous substrate to the bulk layer of paper or paperboard or other cellulose-based material,
melt extrusion coating the first outermost protective material layer or coating, to be directed towards the outside of a packaging container formed from the laminated packaging material, onto the outer side of the bulk layer, and
extrusion coating the inside polymer multilayer portion, comprising
a second innermost liquid tight, heat sealable material layer to be in direct contact with a product to be filled into a packaging container made from the packaging material, an interjacent load-bearing layer comprising an HDPE, MDPE or linear low-density polyethylene, LLDPE, having a melt flow rate from 4 to 20 g/10 min and a melting temperature above 115° C., and the second innermost liquid tight, heat sealable material layer comprising a polyethylene polymer having a low low density,
onto the inner side of the barrier-coated cellulose-based substrate.

31. Method as defined in claim 30, wherein the inside polymer multilayer portion is applied in at least two consecutive steps as separate layers, by melt extrusion coating, with at least partial solidification of the prior, melt-extrusion applied layer(s) before the next melt-extrusion layer is applied onto the prior layer.
